(19) United States
(12) Patent Application Publication
(10) Pub. No.: US 2016/0062000 A1
(43) Pub. Date: Mar. 3, 2016

(54) OPTICAL REFLECTIVE FILM, METHOD FOR MANUFACTURING THE SAME, AND OPTICAL REFLECTOR USING THE SAME

(71) Applicant: KONICA MINOLTA, INC., Tokyo (JP)

(72) Inventors: Akiyoshi KIMURA, Hino-shi, Tokyo (JP); Hiroaki OBATA, Hino-shi, Tokyo (JP)

(21) Appl. No.: 14/784,530

(22) PCT Filed: Apr. 16, 2014
(86) PCT No.: PCT/JP2014/060845

§ 371 Date: Oct. 14, 2015

(30) Foreign Application Priority Data
Apr. 17, 2013 (JP) 2013-086753
Apr. 17, 2013 (JP) 2013-086951
Sep. 12, 2013 (JP) 2013-189858

(51) Int. Cl. G02B 5/08; G02B 1/04

(52) U.S. Cl. CPC G02B 5/085; G02B 1/04

(57) ABSTRACT

To provide an optical reflective film capable of suppressing formation of a defect known as color bleeding, an optical reflective film which suppresses occurrence of curling and has excellent folding resistance, and an optical reflective film having excellent interlayer adhesion and external appearance after exposure to high humidity conditions. In an optical reflective film including at least one unit in which a low refractive index layer and a high refractive index layer are laminated on a substrate, at least one of the low refractive index layer and the high refractive index layer includes an ethylene-modified polyvinyl alcohol having a degree of ethylene modification of 1 to 10 mol % and inorganic oxide particles. Alternately, the high refractive index layer includes an ethylene-modified polyvinyl alcohol having a saponification degree of 95.0 to 99.9 mol % and titanium oxide particle as inorganic oxide particles, and a content of the inorganic oxide particles in the high refractive index layer is 40 to 60% by volume. Alternately, at least one of the low refractive index layer and the high refractive index layer includes two or more kinds of alkylene-modified polyvinyl alcohols and inorganic oxide particles.

### TECHNICAL FIELD

A first aspect of the present invention relates to an optical reflective film, a method for manufacturing the same, and an optical reflector using the same. More specifically, the first aspect of the present invention relates to an optical reflective film capable of suppressing formation of a defect known as color bleeding, and a method for manufacturing the same.

A second aspect of the present invention relates to an optical reflective film, a method for manufacturing the same, and an optical reflector using the same. More specifically, the second aspect of the present invention relates to an optical reflective film which has excellent folding resistance and suppresses occurrence of curling, and a method for manufacturing the same.

A third aspect of the present invention relates to an optical reflective film, a method for manufacturing the same, and an optical reflector using the same. More specifically, the third aspect of the present invention relates to an optical reflective film having improved interlayer adhesion and external appearance after exposure to high humidity conditions, and a method for manufacturing the same.

### BACKGROUND ART

In recent years, interest in energy-saving measures has been increased. In architectural glass and glass for vehicles, insulating glass shielding an infrared ray has been employed in order to shield solar radiation energy entering a room or a car and to reduce temperature rise and a cooling load. Meanwhile, it is theoretically supported that a laminated film obtained by laminating a high refractive index layer and a low refractive index layer while each optical film thickness is adjusted, selectively reflects light with a specific wavelength. An optical reflective film having such a laminated structure is used, for example, as a heat ray-shielding film disposed in a building window, a vehicle member, or the like. A (near) infrared ray reflective film obtained by laminating layers having different reflective indices is known in the related art. A method for shielding transmission of a heat ray of sunlight by sticking the (near) infrared ray reflective film to glass, is attracting attention as an easier method. Such an optical reflective film transmits a visible ray and shields a near infrared ray selectively. The optical reflective film can control a reflective wavelength and can reflect an ultraviolet ray or a visible ray only by adjusting a film thickness or a refractive index of each layer.

There is a method for manufacturing an optical reflective film, in which a laminated film is manufactured by laminating a high refractive index layer and a low refractive index layer alternatively using a vapor phase film formation method such as a vapor deposition method or a sputtering method. However, the vapor phase film formation method has such problems as high manufacturing cost, difficulty in increase in an area, and limitation to a heat resistant material.

Therefore, when the optical reflective film is manufactured, use of a liquid phase film formation method (wet) is more advantageous from viewpoints of low manufacturing cost, possibility of increase in an area, and a wide selection of materials. (e.g., refer to Patent Literature 1). Particularly, not solvent coating but aqueous coating is excellent in view of an environmental aptitude and cost. As the high refractive index layer or the low refractive index layer, for example, a resin layer including a binder resin and inorganic oxide particles is used.

When a coating method in the liquid phase film formation method is used, a method for manufacturing a laminated film including two or more layers on a substrate by coating, includes sequential coating and simultaneous multilayer coating. In the sequential coating, each layer is coated and dried to be laminated. In the simultaneous multilayer coating, multi layers are coated simultaneously. Examples of the sequential coating include a spin coating method, a bar coating method, a blade coating method, and a gravure coating method. When a multilayer film such as an optical reflective film is manufactured, productivity in the sequential coating is low due to the large number of times of coating and drying. On the other hand, examples of the simultaneous multilayer coating include methods using curtain coating and slide bead coating. Productivity in the simultaneous multilayer coating is high because multi layers can be formed simultaneously.

### CITATION LIST

### Patent Literature

Patent Literature 1: JP 2009-86659 A

### SUMMARY OF INVENTION

In the related art, an optical reflective film is manufactured by wet coating using a coating liquid in which a polymer as a binder is dissolved and inorganic oxide particles are dispersed to adjust a refractive index. However, when such a coating liquid is used, there are such problems as follows. That is, a fine gel is generated with time in the coating liquid, many defects known as color bleeding are formed in a coating film, and an external appearance is largely deteriorated. In view of the above-described circumstances, an object of a first aspect of the present invention is to provide an optical reflective film capable of suppressing formation of the defect known as color bleeding. The present inventors have made intensive studies in view of the above-described object of the first aspect of the present invention. As a result, the present inventors have found that formation of the color bleeding (defect) can be suppressed or prevented by using an ethylene-modified polyvinyl alcohol having a degree of ethylene modification of 1 to 10 mol % as a binder in a low refractive index layer and/or a high refractive index layer.

In recent years, according to a fact that an optical reflective film having a higher refractive index has been demanded, the number of lamination of a high refractive index layer and a low refractive index layer tends to increase, and the film thickness tends to increase. However, when the film thickness increases, an amount of inorganic oxide particles included in the laminated film increases. Therefore, there are problems that the film is hard and folding resistance is reduced. In addition, curling disadvantageously occurs in the optical reflective film. An object of a second aspect of the present invention is to provide an optical reflective film which has excellent folding resistance and suppresses occurrence of curling. The present inventors have made intensive studies in view of the above-described object of the second aspect of the present invention. As a result, the present inventors have found that occurrence of curling can be suppressed or prevented and folding resistance can be improved by using an ethylene-modified polyvinyl alcohol having a predetermined saponification degree as a binder for a high refractive index layer of the optical reflective film and by using titanium oxide particles having a predetermined content with respect to the high refractive index layer as inorganic oxide particles.

In the related art, an optical reflective film is manufactured by wet coating using a coating liquid in which a polymer as a binder is dissolved and inorganic oxide particles are dispersed to adjust a refractive index. However, when such a coating liquid is used, there are such problems as reduction in interlayer adhesion and occurrence of a defect in external appearance with time particularly in a case of exposure to such a severe condition as high humidity. An object of a third aspect of the present invention is to provide an optical reflective film having excellent interlayer adhesion and external appearance after exposure to high humidity conditions. The present inventors have made intensive studies in view of the above-described object of the third aspect of the present invention. As a result, the present inventors have found that reduction in interlayer adhesion and the defect in external appearance after exposure to high humidity conditions can be suppressed or prevented by using two or more kinds of alkylene-modified polyvinyl alcohols in a low refractive index layer and/or a high refractive index layer.

### DESCRIPTION OF EMBODIMENTS

### First Aspect of the Present Invention

An object of a first aspect of the present invention is to provide an optical reflective film capable of suppressing formation of a defect known as color bleeding. Another object of the first aspect of the present invention is to provide an optical reflective film having a low haze and/or an improved reflection property. The objects of the first aspect of the present invention are achieved by an optical reflective film which includes at least one unit in which a low refractive index layer and a high refractive index layer are laminated on a substrate, and in which at least one of the low refractive index layer and the high refractive index layer includes an ethylene-modified polyvinyl alcohol having a degree of ethylene modification of 1 to 10 mol % and inorganic oxide particles.

In the optical reflective film according to the first aspect of the present invention, color bleeding (defect) can be suppressed or prevented. In addition, the optical reflective film according to the first aspect of the present invention can provide an optical reflective film having an excellent optical reflection property of a desired wavelength. Furthermore, aqueous coating is possible, and therefore, simultaneous multilayer coating having excellent environmental protection at the time of manufacturing and high productivity is applicable.

The optical reflective film according to the first aspect of the present invention provides an optical reflective film which includes at least one unit in which a low refractive index layer and a high refractive index layer are laminated on a substrate, and in which at least one of the low refractive index layer and the high refractive index layer includes an ethylene-modified polyvinyl alcohol having a degree of ethylene modification of 1 to 10 mol % (in the first aspect of the present invention, also referred to as “ethylene-modified polyvinyl alcohol according to the first aspect of the present invention” or “ethylene modified PVA according to the first aspect of the present invention”) and inorganic oxide particles. The first aspect of the present invention is characterized in that the high refractive index layer and/or the low refractive index layer (in the first aspect of the present invention, also collectively referred to as “refractive index layer”) includes an ethylene-modified polyvinyl alcohol having such a specific degree of ethylene modification as described above. By the above-described structure, color bleeding (defect) formed in the optical reflective film can be suppressed or prevented. The optical reflective film according to the first aspect of the present invention is manufactured by coating, drying, and laminating a coating liquid on a substrate. A coating method may be a sequential coating. However, manufacturing using simultaneous multilayer coating is preferable in view of productivity.

By the above-described structure, the optical reflective film has a low haze and/or an excellent reflection property. A mechanism of exhibiting an effective nest by the above-described structure of the first aspect of the present invention is estimated to be as follows. Note that the present invention is not limited by the following estimation. That is, the ethylene-modified polyvinyl alcohol includes 1 to 10 mol % of a structural unit (CH₂—CH₂—) derived from ethylene and a structural unit (CH₂—C(OH)H—) derived from a vinyl alcohol. Here, a hydroxyl group (OH) of the structural unit derived from a vinyl alcohol in the ethylene-modified polyvinyl alcohol according to the first aspect of the present invention interacts with Ti—OH of inorganic oxide particles (e.g., titanium oxide fine particles) (is bonded to the surface of the inorganic oxide particles). On the other hand, the structural unit derived from ethylene in the ethylene-modified polyvinyl alcohol according to the first aspect of the present invention is hydrophobic. Therefore, the inorganic oxide particles which have interacted with the ethylene-modified polyvinyl alcohol according to the first aspect of the present invention are dispersed stably because the hydrophobic portion (structural unit derived from ethylene) forms an emulsion in the aqueous coating liquid. In addition, the structural unit derived from ethylene, which is a hydrophobic portion, has a low molecular weight. Therefore, the ethylene-modified polyvinyl alcohols are not entangled with each other much or at all. Therefore, the ethylene-modified polyvinyl alcohol according to the first aspect of the present invention suppresses or prevents flocculation of the inorganic oxide particles (formation of gel). Therefore, occurrence (formation) of color bleeding (defect) can be suppressed or prevented in the optical reflective film. As described above, particularly when the inorganic oxide particles are titanium oxide fine particles (particularly, titanium oxide particles treated with silica), a strong interaction occurs. Therefore, when the high refractive index layer includes an ethylene-modified polyvinyl alcohol and titanium oxide particle as inorganic oxide particles (particularly, titanium oxide particles treated with silica), the above-described effects can be exhibited significantly. Furthermore, these particles and the ethylene-modified polyvinyl alcohol according to the first aspect of the present invention interact with each other strongly. Therefore, when simultaneous multilayer coating (particularly, aqueous simultaneous multilayer coating) is performed, interlayer mixing is suppressed, and a high reflectivity is obtained.

High water resistance can be imparted to a coating film by using the ethylene-modified polyvinyl alcohol according to the first aspect of the present invention. Therefore, particularly when an optical reflective film is manufactured by aqueous simultaneous multilayer coating, the first aspect of the present invention can exhibit a remarkable effect. In the simultaneous multilayer coating, a plurality of coating liquids are laminated on a coater, coated on a substrate, and dried. Therefore, coating time is short, and defects on a coating surface are less than in sequential coating in which each layer is coated and dried. The simultaneous multilayer coating is excellent. By an application of the present invention, an optical reflective film having excellent performance and external appearance can be manufactured with high productivity.

Hereinafter, components of the optical reflective film of the first aspect of the present invention will be described in detail. Hereinafter, when the low refractive index layer and the high refractive index layer are not distinguished from each other, the low refractive index layer and the high refractive index layer are referred to as “refractive index layer” as a concept including the two.

In the first aspect of the present invention, “X to Y” indicating a range means “X or more and Y or less”. Unless otherwise specified, an operation and measurement for physical properties or the like are performed under the conditions of room temperature (20 to 25° C.)/relative humidity of 40 to 50%.

### Ethylene-Modified Polyvinyl Alcohol

The ethylene-modified polyvinyl alcohol according to the first aspect of the present invention acts as a binder (binder resin). The ethylene-modified polyvinyl alcohol according to the first aspect of the present invention has a degree of ethylene modification of 1 to 10 mol %. Here, when the degree of ethylene modification is less than 1 mol %, an amount of hydrophobic structural units derived from ethylene is too small, and occurrence (formation) of color bleeding (defect) cannot be suppressed or prevented. On the other hand, when the degree of ethylene modification is more than 10 mol %, an amount of undissolved residue at the time of dissolution is increased, and a haze of a film is increased. The degree of ethylene modification of more than 10 mol % is not preferable, either. The degree of ethylene modification of the ethylene-modified polyvinyl alcohol is preferably 3 to 7 mol %. In the first aspect of the present invention, the degree of ethylene modification means a copolymerization amount (mol %) of ethylene in an alcohol unit converted from a vinyl ester unit of a product obtained by saponifying an ethylene-vinyl ester polymer obtained by copolymerizing ethylene and a vinyl ester monomer. A numerical value thereof is measured by a nuclear magnetic resonance (proton NMR) method.

The ethylene-modified polyvinyl alcohol according to the first aspect of the present invention is a copolymer including a structural unit (CH₂—CH₂—) derived from ethylene, a structural unit (CH₂—C(OH)H—) derived from a vinyl alcohol, and if necessary a structural unit derived from another monomer copolymerizable with these structural units. Here, each structural unit included in the ethylene-modified polyvinyl alcohol according to the first aspect of the present invention may have any shape, and for example, may have a block shape or a random shape.

The ethylene-modified polyvinyl alcohol according to the first aspect of the present invention is preferably water-soluble (water-soluble binder resin). By using the water-soluble ethylene-modified polyvinyl alcohol, a stable coating liquid can be manufactured. As a result, coatability is excellent. Therefore, the water-soluble ethylene-modified polyvinyl alcohol is preferable. In the first aspect of the present invention, “water-soluble (water-soluble binder resin)” means a water-soluble polymer in which, when the water-soluble polymer is dissolved in water having a concentration of 0.5% by weight at a temperature at which the water-soluble polymer is dissolved most, a weight of an insoluble matter filtered out in a case of filtering the solution using a G2 glass filter (maximum pore 40 to 50 μm) is 50% by weight or less of an addition amount of the water-soluble polymer. When there are a plurality of refractive index layers, ethylene-modified polyvinyl alcohols used in the respective refractive index layers may be the same as or different from each other.

The ethylene-modified polyvinyl alcohol according to the first aspect of the present invention can be manufactured by saponifying (hydrolyzing) an ethylene-vinyl ester copolymer obtained by copolymerizing ethylene and a vinyl ester (vinyl ester monomer) and converting a vinyl ester unit into a vinyl alcohol unit. In the studies by the present inventors, a normal polyvinyl alcohol has a high interaction with inorganic oxide particles and is easily gelled. Particularly, this tendency is high for a highly saponified polyvinyl alcohol. However, an ethylene-modified polyvinyl alcohol is not gelled after being mixed with inorganic oxide particles even when the ethylene-modified polyvinyl alcohol is specifically highly saponified. As described above, this is considered to be because of stabilization of the particles after adsorption and a specifically high effect of suppressing gelation. This can suppress color bleeding and bring excellent coatability. In the first aspect of the present invention, there is preferably a difference in saponification degree between the high refractive index layer and the low refractive index layer. Here, the saponification degree means a ratio of a hydroxyl group with respect to the total number of the hydroxyl group and a carbonyloxy group such as an acetyloxy group (derived from vinyl acetate as a raw material) in the polyvinyl alcohol, and is common to an ethylene-modified polyvinyl alcohol and other polyvinyl alcohols. In this way, mixing of the binders can be significantly suppressed. This makes it possible to manufacture an optical reflective film having a high reflectivity. Furthermore, increase in a polymerization degree further enhances this function. This mechanism has not been elucidated yet, but is estimated to be as follows. That is, the increase in the polymerization degree decreases the number of molecules in a unit volume, suppresses physical mixing, emphasizes a difference in a solubility parameter, and suppresses mixing of the binders. The difference in the solubility parameter is made because of a difference in a ratio of a carbonyloxy group which is a hydrophobic group, such as an acetyloxy group. In order to increase the difference in the saponification degree, a layer (high refractive index layer) using a highly saponified ethylene-modified polyvinyl alcohol or polyvinyl alcohol and a layer (low refractive index layer) using a low saponified ethylene-modified polyvinyl alcohol or polyvinyl alcohol are necessary. In the first aspect of the present invention, as described above, the ethylene-modified polyvinyl alcohol according to the first aspect of the present invention is preferably used on a side of the high refractive index layer in which gelation easily occurs. That is, the high refractive index layer preferably includes the ethylene-modified polyvinyl alcohol.

In addition, in the first aspect of the present invention, as the binder, the refractive index layer may include only an ethylene-modified polyvinyl alcohol, or may include a polyvinyl alcohol other than the ethylene-modified polyvinyl alcohol in addition to the ethylene-modified polyvinyl alcohol. In the latter case, one layer includes the ethylene-modified polyvinyl alcohol preferably in an amount of 30% by weight or more, more preferably in an amount of 60% by weight or more with respect to the binder (total weight of the ethylene-modified polyvinyl alcohol and a polyvinyl alcohol other than the ethylene-modified polyvinyl alcohol). In this case, an upper limit of the ethylene-modified polyvinyl alcohol in the binder is not particularly limited, but is preferably 90% by weight or less, more preferably 80% by weight or less with respect to the binder (total weight of the ethylene-modified polyvinyl alcohol and a polyvinyl alcohol other than the ethylene-modified polyvinyl alcohol).

The polymerization degree of the ethylene-modified polyvinyl alcohol according to the first aspect of the present invention is not particularly limited, but is preferably 100 or more, more preferably 1000 or more. Here, as described above, an upper limit of the polymerization degree of the ethylene-modified polyvinyl alcohol according to the first aspect of the present invention is preferably high, and therefore, is not particularly limited, but is preferably 3000 or less, more preferably 2500 or less. Here, the polymerization degree of the ethylene-modified polyvinyl alcohol means a polymerization degree measured in conformity with JIS K6726: 1994.

The saponification degree of the ethylene-modified polyvinyl alcohol according to the first aspect of the present invention is not particularly limited, but is preferably 85 mol % or more, more preferably 90 mol % or more, still more preferably 97 mol % or more, most preferably 98 mol % or more (upper limit: 100 mol %). When the saponification degree is 85 mol % or more, an optical reflective film has excellent water resistance. Here, the saponification degree of the ethylene-modified polyvinyl alcohol can be measured in conformity with a method described in JIS K6726: 1994.

The vinyl ester monomer to form the ethylene-modified polyvinyl alcohol is not particularly limited. However, examples thereof include vinyl formate, vinyl acetate, vinyl propionate, vinyl valerate, vinyl laurate, vinyl stearate, vinyl benzoate, vinyl pivalate, and vinyl versatate. Among these, vinyl acetate is preferable. One kind of the vinyl ester monomers may be used alone, or a mixture of two or more kinds thereof may be used.

The ethylene-modified polyvinyl alcohol according to the first aspect of the present invention may include, if necessary, another copolymerizable monomer within a range not impairing the effect of the invention, in addition to ethylene and the vinyl ester monomer. When the ethylene-modified polyvinyl alcohol according to the first aspect of the present invention includes another copolymerizable monomer, a content of the other copolymerizable monomer is not particularly limited as long as the content is within a range not impairing the effect of the invention, but is preferably 0.1 to 10 mol % with respect to the total amount of ethylene and the vinyl ester monomer.

When the ethylene-modified polyvinyl alcohol according to the first aspect of the present invention includes another copolymerizable monomer, the other copolymerizable monomer is not particularly limited. However, examples thereof include an olefin having 3 to 30 carbon atoms, such as propylene, 1-butene, or isobutene; an acrylic acid and a salt thereof; an acrylate such as methyl acrylate, ethyl acrylate, n-propyl acrylate, isopropyl acrylate, n-butyl acrylate, isobutyl acrylate, t-butyl acrylate, 2-ethylhexyl acrylate, dodecyl acrylate, or octadecyl acrylate; methacrylic acid and a salt thereof; a methacrylate such as methyl methacrylate, ethyl methacrylate, n-propyl methacrylate, isopropyl methacrylate, n-butyl methacrylate, isobutyl methacrylate, t-butyl methacrylate, 2-ethylhexyl methacrylate, dodecyl methacrylate, or octadecyl methacrylate; an acrylamide derivative such as acrylamide, N-methyl acrylamide, N-ethyl acrylamide, N,N-dimethyl acrylamide, diacetone acrylamide, acrylamide propanesulfonic acid and a salt thereof, acrylamide propyl dimethylamine and a salt thereof, or N-methylol acrylamide and a derivative thereof; a methacrylamide derivative such as methacrylamide, N-methyl methacrylamide, N-ethyl methacrylamide, methacrylamide propane sulfonic acid and a salt thereof, methacrylamide propyl dimethylamine and a salt thereof, N-methylol methacrylamide and a derivative thereof; an N-vinyl amide such as N-vinylformamide, N-vinyl acetamide, or N-vinyl pyrrolidone; a nitrile such as a vinyl ether including methyl vinyl ether, ethyl vinyl ether, n-propyl vinyl ether, isopropyl vinyl ether, n-butyl vinyl ether, isobutyl vinyl ether, t-butyl vinyl ether, dodecyl vinyl ether and stearyl vinyl ether, acrylonitrile, or methacrylonitrile; a vinyl halide such as vinyl chloride, vinylidene chloride, vinyl fluoride, or vinylidene fluoride; an allyl compound such as allyl acetate or allyl chloride; maleic acid, a salt thereof, and an ester thereof; itaconic acid, a salt thereof, and an ester thereof; a vinylsilyl compound such as vinyl trimethoxy silane; and an N-vinylamide such as isopropenyl acetate, N-vinyl formamide, N-vinylacetamide, or N-vinylpyrrolidone. One kind of the other copolymerizable monomers may be used alone, or a mixture of two or more kinds thereof may be used.

The ethylene-modified polyvinyl alcohols may be each used alone, or two or more kinds thereof having different average polymerization degrees or different kinds of modification may be used.

In the first aspect of the present invention, a content of the ethylene-modified polyvinyl alcohol is preferably 3 to 50% by weight, more preferably 5 to 40% by weight with respect to 100% by weight of the total solid content of the refractive index layer. When the content of the ethylene-modified polyvinyl alcohol is 5% by weight or more, formation of color bleeding or disorder of the film surface is suppressed and transparency tends to become higher during drying after the refractive index layer is coated. On the other hand, when the content is 50% by weight or less, a relative content of the inorganic oxide particles is appropriate, and it is easy to increase the difference in the refractive index between the high refractive index layer and the low refractive index layer. Here, the ethylene-modified polyvinyl alcohol may be a commercially available product. The commercially available product is not particularly limited. However, examples thereof include EXCEVAL (registered trademark) RS-4104, RS-2117, RS-1117, RS-2817, RS-1717, RS-1113, RS-1713, and HR-3010 (manufactured by Kuraray Co. Ltd.).

In the alkylene-modified polyvinyl alcohol according to the first aspect of the present invention, a known initiator and known polymerization conditions can be used as the initiator and the polymerization conditions to be used for copolymerization of an olefin(ethylene) and a vinyl ester monomer without particular limitation. However, for example, matters described in the third aspect of the present invention can be employed.

[Polyvinyl Alcohol]

In the optical reflective film of the first aspect of the present invention, at least one of the low refractive index layer and the high refractive index layer is only required to include the ethylene-modified polyvinyl alcohol according to the first aspect of the present invention. Therefore, as described above, the low refractive index layer and/or the high refractive index layer may include the ethylene-modified polyvinyl alcohol according to the first aspect of the present invention and a polyvinyl alcohol 1 (an unmodified polyvinyl alcohol or a modified polyvinyl alcohol other than the ethylene-modified polyvinyl alcohol) other than the ethylene-modified polyvinyl alcohol. One of the low refractive index layer and the high refractive index layer may include the ethylene-modified polyvinyl alcohol according to the first aspect of the present invention, and the other one may include a polyvinyl alcohol other than an ethylene-modified polyvinyl alcohol without including the ethylene-modified polyvinyl alcohol according to the first aspect of the present invention. Preferably, the high refractive index layer includes, as a binder, one or more kinds of the ethylene-modified polyvinyl alcohols according to the first aspect of the present invention, or one or more kinds of the ethylene-modified polyvinyl alcohols according to the first aspect of the present invention and one or more kinds of polyvinyl alcohols other than the ethylene-modified polyvinyl alcohol, and the low refractive index layer includes, as a binder, one or more kinds of polyvinyl alcohols other than the ethylene-modified polyvinyl alcohol. In the first aspect of the present invention, the term “polyvinyl alcohol” itself indicates a normal polyvinyl alcohol (unmodified polyvinyl alcohol) obtained by hydrolyzing polyvinyl acetate and a polyvinyl alcohol other than the ethylene-modified polyvinyl alcohol.

The polyvinyl alcohol acts as a binder (binder resin). The polyvinyl alcohol is preferably a water-soluble polyvinyl alcohol (water-soluble binder resin). By using the water-soluble polyvinyl alcohol, a coating liquid of the refractive index layer has excellent liquid stability. As a result, coatability is excellent. Therefore, the water-soluble polyvinyl alcohol is preferable. When there are a plurality of refractive index layers, polyvinyl alcohols used in the respective refractive index layers may be the same as or different from each other.

Here, as described above, the unmodified polyvinyl alcohol may be obtained by hydrolyzing polyvinyl acetate, or may be a commercially available product. Examples of the commercially available product include KURARAYPOVAL PVA series (manufactured by Kuraray Co. Ltd.) and J-POVAL J series (manufactured by Japan VAM & POVAL Co., LTD.).

A modified polyvinyl alcohol which has been partially modified may be included. Examples of such a modified polyvinyl alcohol include a cation-modified polyvinyl alcohol, an anion-modified polyvinyl alcohol, and a nonion-modified polyvinyl alcohol.

Among these, the cation-modified polyvinyl alcohol is not particularly limited. However, for example, as described in JP 61-10483 A, the cation-modified polyvinyl alcohol is a polyvinyl alcohol containing a primary to tertiary amino group or a quaternary ammonium group in a main chain or a side chain of the polyvinyl alcohol, and is obtained by saponifying a copolymer of an unsaturated ethylene monomer containing a cationic group and vinyl acetate.

Examples of the unsaturated ethylene monomer containing a cationic group include trimethyl-(2-acrylamide-2,2-dimethylethyl) ammonium chloride, trimethyl-(3-acrylamide-3,3-dimethylpropyl) ammonium chloride, N-vinylimidazole, N-vinyl-2-methylimidazole, N-(3-dimethylaminopropyl)methacrylamide, hydroxyethyl trimethyl ammonium chloride, trimethyl-(2-methacrylamidepropyl) ammonium chloride, and N-(1,1-dimethyl-3-dimethylaminopropyl) acrylamide. A ratio of the monomer containing a cationic modification group in the cation-modified polyvinyl alcohol is 0.1 to 10 mol %, preferably 0.2 to 5 mol % with respect to vinyl acetate.

The anion-modified polyvinyl alcohol is not particularly limited. However, examples thereof include such a polyvinyl alcohol containing an anionic group as described in JP 1-206088 A, such a copolymer of vinyl alcohol and a vinyl compound containing a water-soluble group as described in JP 61-237681 A and JP 63-307979 A, and such a modified polyvinyl alcohol containing a water-soluble group as described in JP 7-285265 A.

The nonion-modified polyvinyl alcohol is not particularly limited. However, examples thereof include such a polyvinyl alcohol derivative obtained by adding a polyalkylene oxide group to a part of vinyl alcohol as described in JP 7-9758 A, a silanol-modified polyvinyl alcohol containing a silanol group, and a reactive group-modified polyvinyl alcohol containing a reactive group such as an acetoacetyl group, a carbonyl group, or a carboxyl group.

The polyvinyl alcohols may be each used alone, or two or more kinds thereof having different average polymerization degrees or different kinds of modification may be used.

The polymerization degree of the polyvinyl alcohol is not particularly limited, but is preferably 1000 to 5000, more preferably 2000 to 5000. In this range, the coating film has excellent strength, and the coating liquid is stable. Particularly when the polymerization degree is 2000 or more, a crack is not generated in the coating film, and an excellent haze is obtained. Therefore, the polymerization degree of 2000 or more is preferable. In the first aspect of the present invention, the polymerization degree of the polyvinyl alcohol means a polymerization degree measured in conformity with JIS K6726: 1994.

The saponification degree of the polyvinyl alcohol is not particularly limited, but is preferably 85 mol % or more, more preferably 90 mol % or more, still more preferably 95 mol % or more, most preferably 98 mol % or more (upper limit: 99.5 mol %). When the saponification degree is 85 mol % or more, the optical reflective film has excellent water resistance. In the first aspect of the present invention, the saponification degree of the ethylene-modified polyvinyl alcohol can be measured in conformity with a method described in JIS K6726: 1994.

A content of the polyvinyl alcohol in the refractive index layer is preferably 3 to 70% by weight, more preferably 5 to 60% by weight, still more preferably 10 to 50% by weight, particularly preferably 15 to 45% by weight, with respect to the total solid content of the refractive index layer.

[Curing Agent]

In the first aspect of the present invention, the refractive index layer preferably uses a curing agent. When a polyvinyl alcohol is used as a binder resin, an effect thereof can be particularly exhibited.

The curing agent which can be used with the polyvinyl alcohol is not particularly limited as long as the curing agent causes a curing reaction with the polyvinyl alcohol, but is preferably boric acid or a salt thereof. In addition to boric acid and a salt thereof, a known curing agent can be used. In general, a compound containing a group which can react with the polyvinyl alcohol, or a compound which promotes a reaction between different groups contained in the polyvinyl alcohol is appropriately selected to be used. Specific examples of the curing agent include an epoxy-based curing agent (diglycidyl ethyl ether, ethylene glycol diglycidyl ether, 1,4-butanediol diglycidyl ether, 1,6-diglycidyl cyclohexane, N,N-diglycidyl-4-glycidyloxy aniline, sorbitol polyglycidyl ether, glycerol polyglycidyl ether, etc.), an aldehyde-based curing agent (formaldehyde, glyoxal, etc.), an active halogen-based curing agent (2,4-dichloro-4-hydroxy-1,3,5,-s-triazine, etc.), an active vinyl compound (1,3,5-trisacryloyl-hexahydro-s-triazine, bisvinylsulfonyl methyl ether, etc.), and aluminum alum.

Here, boric acid or a salt thereof means an oxygen acid containing a boron atom as a central atom or a salt thereof. Specific examples thereof include orthoboric acid, diboric acid, metaboric acid, tetraboric acid, pentaboric acid, octaboric acid, and salts thereof.

Here, borax is a mineral represented by Na₂B₄O₅(OH)₄.8H₂O (decahydrate of sodium tetraborate Na₂B₄O₇).

Boric acid, a borate, and borax containing a boron atom as the curing agent may be each used alone as an aqueous solution, or two or more kinds thereof may be mixed to be used. An aqueous solution of boric acid or a mixed aqueous solution of boric acid and borax is preferable. An aqueous solution of boric acid and an aqueous solution of borax can be each added only as a relatively dilute aqueous solution. However, by mixing the two, a concentrated aqueous solution can be obtained, and the coating liquid can be concentrated. It is possible to relatively freely control the pH of the aqueous solution to be added.

In the first aspect of the present invention, in order to obtain the effect of the first aspect of the present invention, boric acid and a salt thereof and/or borax are preferably used. When boric acid and a salt thereof and/or borax are used, inorganic oxide particles and an OH group of a polyvinyl alcohol form a hydrogen bond network. It is considered that, as a result, interlayer mixing between the high refractive index layer and the low refractive index layer is suppressed, and a preferable optical reflection property is achieved. Particularly when a set-type coating process is used, a more preferable effect can be exhibited. In the set-type coating process, a multilayer of the high refractive index layer and the low refractive index layer is coated with a coater, and then, the temperature on the surface of the coating film is temporarily lowered to about 15° C., and then, the film surface is dried.

A total use amount of the curing agent is preferably 10 to 600 mg, more preferably 20 to 500 mg per g of the polyvinyl alcohol (or the ethylene-modified polyvinyl alcohol, or a total amount of the polyvinyl alcohol and the ethylene-modified polyvinyl alcohol when the polyvinyl alcohol and the ethylene-modified polyvinyl alcohol are used together).

[Resin Binder (Other Water-Soluble Polymers)]

In the first aspect of the present invention, each refractive index layer may include, as a binder, another water-soluble polymer such as gelatin, a cellulose, a polysaccharide thickener, or a polymer containing a reactive functional group, described in the second aspect of the present invention.

[Other Additives]

The high refractive index layer according to the first aspect of the present invention or the low refractive index layer described below may include known additives. Examples thereof include an ultraviolet absorber described in JP 57-74193 A, JP 57-87988 A, and JP 62-261476 A, an anti-fading agent described in JP 57-74192 A, JP 57-87989 A, JP 60-72785 A, JP 61-146591 A, JP 1-95091 A, JP 3-13376 A, and the like, an anionic, cationic, or nonionic surfactant, a fluorescent whitening agent described in JP 59-42993 A, JP 59-52689 A, JP 62-280069 A, JP 61-242871 A, JP 4-219266 A, and the like, a pH adjusting agent such as sulfuric acid, phosphoric acid, acetic acid, citric acid, sodium hydroxide, potassium hydroxide, or potassium carbonate, an antifoaming agent, a lubricant such as diethylene glycol, a preservative, an anti-static agent, and a matting agent.

[Inorganic Oxide Particles Used in High Refractive Index Layer]

In the first aspect of the present invention, in order to form a transparent high refractive index layer having a higher refractive index, the high refractive index layer includes inorganic oxide particles (high refractive index metal oxide fine particles) such as titanium oxide, zirconia, tin oxide, zinc oxide, alumina, colloidal alumina, niobium oxide, europium oxide, or zircon. Among these, the high refractive index layer includes preferably titanium oxide or zirconia, more preferably titanium oxide. That is, the high refractive index layer includes preferably titanium oxide particles as inorganic oxide particles, more preferably an ethylene-modified polyvinyl alcohol and the titanium oxide particles as inorganic oxide particles. The high refractive index layer particularly preferably includes rutile type (tetragonal) titanium oxide particles due to exhibition of a high refractive index. The size of the high refractive index metal oxide fine particle is not particularly limited. However, a volume average particle diameter thereof is preferably 1 to 100 nm or less, more preferably 3 to 50 nm. In order to adjust the refractive index, one kind of the high refractive index metal oxide fine particles may be used, or two or more kinds thereof may be used together.

Titanium oxide particles capable of being dispersed in an organic solvent or the like, obtained by modifying the surface of an aqueous titanium oxide sol, are preferably used.

As a method for preparing the aqueous titanium oxide sol, any method known in the related art can be used. For example, description in JP 63-17221 A, JP 7-819 A, JP 9-165218 A (corresponding to U.S. Pat. No. 5,840,111), JP 11-43327 A, or the like can be referred to.

As for other methods for manufacturing the titanium oxide particles, for example, “titanium oxide-physical properties and application technology”, Manabu Kiyono, p 255-258 (2000) Gihodo Publishing Co., or a method of step (2) described in paragraphs “0011”-“0023” in WO2007/039953 (corresponding to US 2008/0305338 A) can be referred to.

The above-described manufacturing method of step (2) includes the step (2). In the step (2), a titanium dioxide dispersion obtained in step (1) is treated with a carboxylic acid group-containing compound and an inorganic acid after the step (1). In the step (1), titanium dioxide hydrate is treated with at least one kind of basic compound selected from the group consisting of a hydroxide of an alkali metal and a hydroxide of an alkali earth metal.

Furthermore, as other methods for manufacturing inorganic oxide particles including the titanium oxide particles, description in JP 2000-053421 A, JP 2000-063119 A, or the like can be referred to. JP 2000-053421 A describes a titanium oxide sol including an alkyl silicate as a dispersion stabilizer and having a weight ratio (SiO₂/TiO₂) of 0.7 to 10. The weight ratio is a ratio between an amount obtained by converting silicon in the alkyl silicate into SiO₂ and an amount obtained by converting titanium in the titanium oxide into TiO₂. JP 2000-063119 A describes a sol in which the surface of composite colloidal particles of TiO₂—ZrO₂—SnO₂ as a core is coated with composite oxide colloidal particles of WO₃—SnO₂—SiO₂.

In addition, a form of core shell particles is preferable. In the form of core shell particles, the titanium oxide particles are coated with a silicon-containing hydrous oxide. Here, “coated” means a state in which the silicon-containing hydrous oxide adheres to at least a part of the surface of the titanium oxide particles. In the first aspect of the present invention, the coated titanium oxide is also referred to as “silica adhesion titanium dioxide” or “silica coated titanium oxide.” That is, the surface of the titanium oxide particles used as inorganic oxide particles (metal oxide particles) may be completely coated with the silicon-containing hydrous oxide, or a part of the surface of the titanium oxide particles may be coated with the silicon-containing hydrous oxide. A part of the surface of the titanium oxide particles is preferably coated with the silicon-containing hydrous oxide from such a viewpoint that the refractive index of the coated titanium oxide particles is controlled by a coating amount of the silicon-containing hydrous oxide.

The titanium oxide of the titanium oxide particles coated with the silicon-containing hydrous oxide may be a rutile type or an anatase type. The titanium oxide particles coated with the silicon-containing hydrous oxide are preferably rutile type titanium oxide particles coated with the silicon-containing hydrous oxide. This is because the rutile type titanium oxide particles have a lower photocatalytic activity than the anatase type titanium oxide particles, and therefore, the high refractive index layer and the low refractive index layer adjacent thereto have higher weather resistance and higher refractive indices. In the first aspect of the present invention, “silicon-containing hydrous oxide” may be any one of a hydrate of an inorganic silicon compound and a hydrolyzate and/or a condensate of an organic silicon compound, but more preferably contains a silanol group in order to obtain the effect of the first aspect of the present invention. Therefore, in the first aspect of the present invention, the high refractive index metal oxide fine particles are preferably silica-modified (silanol-modified) titanium oxide particles in which the titanium oxide particles are silica-modified.

A coating amount of the silicon-containing hydrous oxide is 3 to 30% by weight, preferably 3 to 20% by weight, more preferably 3 to 10% by weight with respect to titanium oxide as a core. The reasons are as follows. When the coating amount is 30% by weight or less, a desired refractive index of the high refractive index layer is obtained. When the coating amount is 3% by weight or more, particles can be formed stably.

As a method for coating the titanium oxide particles with the silicon-containing hydrous oxide, a method known in the related art can be used. For example, description in JP 10-158015 A, JP 2000-204301 A, JP 2007-246351 A, or the like can be referred to. JP 10-158015 A describes a treatment of rutile type titanium oxide with an Si/Al hydrous oxide. That is, JP 10-158015 A describes a method for manufacturing a titanium oxide sol obtained by depositing a water-containing oxide of silicon and/or aluminum on the surface of titanium oxide and performing a surface treatment thereof after peptization of a titanic acid cake in an alkali region. JP 2000-204301 A describes a sol obtained by coating rutile type titanium oxide with a composite oxide of Si and an oxide of Zr and/or Al, and a hydrothermal treatment. JP 2007-246351 A describes a method for manufacturing a titanium oxide hydrosol coated with a water-containing oxide of silicon. In the method, an organoalkoxysilane of the formula R¹ₙSiX₄₋ₙ (in the formula, R¹ represents a C₁-C₈ alkyl group, a glycidyloxy-substituted C₁-C₈ alkyl group, or a C₂-C₈ alkenyl group, X represents an alkoxy group, and n represents 1 or 2) or a compound having a complexing action to titanium oxide is added as a stabilizer to a hydrosol of titanium oxide obtained by peptization of water-containing titanium oxide, the resulting mixture is added to a sodium silicate solution or a silica sol solution in an alkali region, the pH is adjusted, and aging is performed.

In the core shell particles according to the first aspect of the present invention, the entire surface of the titanium oxide particles as a core may be coated with a silicon-containing hydrous oxide, or a part of the surface of the titanium oxide particles as a core may be coated with the silicon-containing hydrous oxide.

The inorganic oxide particles used in the high refractive index layer can be determined by a volume average particle diameter or a primary average particle diameter. The volume average particle diameter of the inorganic oxide particles used in the high refractive index layer is preferably 30 nm or less, more preferably 1 to 30 nm, still more preferably 5 to 15 nm. The primary average particle diameter of the inorganic oxide particles used for the inorganic oxide particles used in the high refractive index layer is preferably 30 nm or less, more preferably 1 to 30 nm, still more preferably 5 to 15 nm. Inorganic oxide particles having a primary average particle diameter of 1 nm or more and 30 nm or less are preferable in view of a low haze and an excellent visible light transmittance. Inorganic oxide particles having a volume average particle diameter or a primary average particle diameter of 30 nm or less are preferable in view of a low haze and an excellent visible light transmittance. By containing core shell particles as high refractive index metal oxide fine particles, interlayer mixing between the high refractive index layer and the low refractive index layer is suppressed due to an interaction between the silicon-containing hydrous oxide in the shell layer and the polyvinyl alcohol. Here in a case of the titanium oxide particles coated with the silicon-containing hydrous oxide, the volume average particle diameter and the primary average particle diameter indicate a volume average particle diameter and a primary average particle diameter of titanium oxide particles (not coated with the silicon-containing hydrous oxide), respectively.

The volume average particle diameter in the first aspect of the present invention is calculated as follows. That is, particle diameters of any 1000 particles are measured by a method of observing the particles themselves using a laser diffraction scattering method, a dynamic light scattering method, or an electron microscope, or by a method of observing particle images appearing on a cross section or the surface of the refractive index layer using an electron microscope. When a volume per particle is vi in a group of the inorganic oxide particles in which particles having a particle diameter of d1, d2, . . . di . . . dk exist in the number of n1, n2, . . . ni . . . nk, respectively, an average particle diameter weighted by a volume, represented by mv={Σ(vi·di)}/{Σ(vi)}, is calculated.

Furthermore, the inorganic oxide particles used in the first aspect of the present invention are preferably monodispersed. Here, monodipersion means that a monodispersion degree is 40% or less. The monodispersion degree is determined by the following formula. The monodispersion degree is more preferably 30% or less, particularly preferably 0.1 to 20%.

monodispersion degree=(standard deviation of particle diameter)/(average value of particle diameter)×10 [Numerical formula 1]

In the first aspect of the present invention, a content of the inorganic oxide particles in the high refractive index layer is not particularly limited, but is preferably 15 to 85% by weight, more preferably 20 to 80% by weight, still more preferably 30 to 75% by weight with respect to the total solid content of the high refractive index layer. By the content within the above-described range, an excellent optical reflection property can be obtained.

[Inorganic Oxide in Low Refractive Index Layer]

In the low refractive index layer, silica (silicon dioxide) is preferably used as an inorganic oxide (metal oxide). Specific examples thereof include synthetic amorphous silica, colloidal silica, zinc oxide, alumina, and colloidal alumina. Among these, a colloidal silica sol, particularly an acidic colloidal silica sol is more preferably used, and colloidal silica dispersed in an organic solvent is particularly preferably used. In order to further reduce the refractive index, hollow fine particles having pores inside the particles may be used as the inorganic oxide particles (metal oxide particles) of the low refractive index layer. Hollow fine particles of silica (silicon dioxide) are particularly preferably used. Known inorganic oxide particles other than silica can be also used. In order to adjust the refractive index, one kind of the inorganic oxide particles may be used, or two or more kinds thereof may be used together for the low refractive index layer.

The inorganic oxide particles (preferably silicon dioxide) included in the low refractive index layer preferably have an average particle diameter (number average; diameter) of 3 to 100 nm. The average particle diameter of primary particles of silicon dioxide dispersed in a state of primary particles (particle diameter in a state of a dispersion liquid before coating) is more preferably 3 to 50 nm, still more preferably 1 to 40 nm, particularly preferably 3 to 20 nm, most preferably 4 to 10 nm. The average particle diameter of secondary particles is preferably 30 nm or less in view of a low haze and an excellent visible light transmittance.

In the first aspect of the present invention, the primary average particle diameter can be measured from an electron micrograph by a transmission electron microscope (TEM) or the like. The primary average particle diameter may be measured by a particle size distribution analyzer or the like using a dynamic light scattering method, a static light scattering method, or the like.

When being determined using the transmission electron microscope, the primary average particle diameter of the particles is determined by observing the particles themselves or the particles appearing on a cross section or the surface of the refractive index layer using an electron microscope, by measuring particle diameters of any 1000 particles, and by determining a simple average value thereof (number average). Here, the particle diameter of each particle is expressed by a diameter when a circle equal to a projected area thereof is assumed.

The particle diameter of the inorganic oxide particles in the low refractive index layer can be determined by a volume average particle diameter in addition to the primary average particle diameter.

The colloidal silica used in the first aspect of the present invention is obtained by heat aging a silica sol obtained by methathesis with an acid of sodium silicate or the like, or transmission through an ion-exchange resin layer. Examples thereof include colloidal silica described in JP 57-14091 A, JP 60-219083 A, JP 60-219084 A, JP 61-188183 A, JP 4-93284 A, JP 5-278324 A, JP 6-92011 A, JP 6-183134 A, JP 6-297830 A, JP 7-81214 A, JP 7-101142 A, JP 7-179029 A, JP 7-137431 A, and WO 94/26530 A (corresponding to EP 0655346 A).

Such a colloidal silica may be a synthetic product or a commercially available product. Examples of the commercially available product include Snowtex series available from Nissan Chemical Industries, Ltd. (Snowtex OS, OXS, S, OS, 20, 30, 40, O, N, C, etc.).

The surface of the colloidal silica may be cation-modified, or may be treated with Al, Ca, Mg, Ba, or the like.

As the inorganic oxide particles in the low refractive index layer, hollow particles can be used. When hollow fine particles are used, an average particle pore diameter is preferably 3 to 70 nm, more preferably 5 to 50 nm, still more preferably 5 to 45 nm. The average particle pore diameter of the hollow fine particles is an average value of inner diameters of the hollow fine particles. When the average particle pore diameter of the hollow fine particles is within the above-described range, the refractive index of the low refractive index layer is sufficiently lowered. The average particle pore diameter is obtained by observing at random 50 or more pore diameters which can be observed as a circle or an oval, or can be substantially observed as a circle or an oval using an electron microscope, by determining pore diameters of the particles, and by determining a number average value thereof. The average particle pore diameter means the shortest distance among distances obtained by sandwiching an outer periphery of the pore diameter which can be observed as a circle or an oval, or can be substantially observed as a circle or an oval with two parallel lines.

A content of the inorganic oxide particles in the low refractive index layer is preferably 20 to 90% by weight, more preferably 30 to 85% by weight, still more preferably 40 to 70% by weight with respect to the total solid content of the low refractive index layer. When the content is 20% by weight or more, a desired refractive index is obtained. When the content is 90% by weight or less, coatability is excellent. Therefore, the content of 20% by weight or more and 90% by weight or less is preferable.

The inorganic oxide particles in the low refractive index layer are only required to be included in at least one layer of the plurality of low refractive index layers.

[Method for Manufacturing Optical Reflective Film]

A method for manufacturing the optical reflective film of the first aspect of the present invention is not particularly limited. Any method can be used, as long as at least one unit including a high refractive index layer and a low refractive index layer can be formed on a substrate.

In the method for manufacturing the optical reflective film of the first aspect of the present invention, a unit including a high refractive index layer and a low refractive index layer is laminated on a substrate to form an optical reflective film.

Specifically, a high refractive index layer and a low refractive index layer are preferably alternately coated and dried to form a laminated body. Specific examples of the embodiment include: (1) a method for manufacturing an optical reflective film, in which a high refractive index layer coating liquid is coated on a substrate and dried to form a high refractive index layer, and then a low refractive index layer coating liquid is coated and dried to form a low refractive index layer; (2) a method for manufacturing an optical reflective film, in which a low refractive index layer coating liquid is coated on a substrate and dried to form a low refractive index layer, and then a high refractive index layer coating liquid is coated and dried to form a high refractive index layer; (3) a method for manufacturing an optical reflective film including a high refractive index layer and a low refractive index layer, in which a high refractive index layer coating liquid and a low refractive index layer coating liquid are alternately and sequentially coated on a substrate in a form of a multilayer and then dried; and (4) a method for manufacturing an optical reflective film including a high refractive index layer and a low refractive index layer, in which a high refractive index layer coating liquid and a low refractive index layer coating liquid are simultaneously coated on a substrate in a form of a multilayer and dried. Among these, the above method (4) which is a simpler manufacturing method, is preferable. That is, the method for manufacturing the optical reflective film of the first aspect of the present invention preferably includes laminating the high refractive index layer and the low refractive index layer by an aqueous simultaneous multilayer coating method.

In the first aspect of the present invention, one of the low refractive index layer and the high refractive index layer may include an ethylene-modified polyvinyl alcohol, or both the layers may include an ethylene-modified polyvinyl alcohol. In view of suppressing/preventing color bleeding, the high refractive index layer including particles having reactivity with a hydroxyl group, such as titanium oxide or zirconium preferably includes an ethylene-modified polyvinyl alcohol.

Preferable examples of a coating method include a roll coating method, a rod bar coating method, an air knife coating method, a spray coating method, a curtain coating method, a slide bead coating method using a hopper described in U.S. Pat. No. 2,761,419 and U.S. Pat. No. 2,761,791, and an extrusion coating method.

A solvent for preparing the high refractive index layer coating liquid and the low refractive index layer coating liquid is not particularly limited. However, water, an organic solvent, or a mixture thereof is preferable. In the first aspect of the present invention, an aqueous solvent can be used because an ethylene-modified polyvinyl alcohol/polyvinyl alcohol is mainly used as a resin binder. The aqueous solvent does not require large-scaled manufacturing facilities unlike in a case of using an organic solvent. Therefore, the aqueous solvent is preferable in view of productivity and environmental protection.

Examples of the organic solvent include an alcohol such as methanol, ethanol, 2-propanol, or 1-butanol; an ester such as ethyl acetate, butyl acetate, propylene glycol monomethyl ether acetate, or propylene glycol monoethyl ether acetate; an ether such as diethyl ether, propylene glycol monomethyl ether, or ethylene glycol monoethyl ether; an amide such as dimethylformamide or N-methyl pyrrolidone; and a ketone such as acetone, methyl ethyl ketone, acetylacetone, or cyclohexanone. The organic solvents may be each used alone, or a mixture of two or more kinds thereof may be used. The aqueous solvent is preferable as a solvent of the coating liquid in view of environment, easiness of the operation, and the like. Water or a mixed solvent of water and methanol, water and ethanol, or water and ethyl acetate is more preferable. Water is particularly preferable.

When a mixed solvent of water and a small amount of organic solvent is used, a content of water in the mixed solvent is preferably 80 to 99.9% by weight, more preferably 90 to 99.5% by weight with respect to 100% by weight of the total content of the mixed solvent. Here, the reasons are as follows. That is, the content of 80% by weight or more makes it possible to reduce fluctuation in volume due to volatilization of the solvent, and improves handling. The content of 99.9% by weight or less increases homogeneity during liquid addition, and makes it possible to obtain stable liquid physical properties.

A concentration of an ethylene-modified polyvinyl alcohol/polyvinyl alcohol in the high refractive index layer coating liquid (total concentration of the ethylene-modified polyvinyl alcohol and the polyvinyl alcohol in the coating liquid) is preferably 0.5 to 10% by weight. A concentration of inorganic oxide particles in the high refractive index layer coating liquid is preferably 1 to 50% by weight.

A concentration of a polyvinyl alcohol in the low refractive index layer coating liquid is preferably 0.5 to 10% by weight. A concentration of inorganic oxide particles in the low refractive index layer coating liquid is preferably 1 to 50% by weight.

A method for preparing the high refractive index layer coating liquid or the low refractive index layer coating liquid is not particularly limited. For example, inorganic oxide particles, a polyvinyl alcohol, a chelate compound having a higher refractive index than the polyvinyl alcohol, an acylate compound, a salt thereof, and another additive to be added if necessary, are added, stirred, and mixed. At this time, the order of adding the components is not particularly limited. The components may be sequentially added and mixed while being stirred, or may be simultaneously added and mixed while being stirred.

In the first aspect of the present invention, when the simultaneous multilayer coating is performed, the saponification degree of the polyvinyl alcohol in the high refractive index layer coating liquid is preferably different from that in the low refractive index layer coating liquid. The difference in the saponification degree makes it possible to suppress mixing of the layers in each step of coating and drying. This mechanism has not been elucidated yet, but is estimated to be as follows. That is, mixing is suppressed due to a difference in surface tension derived from the difference in the saponification degree. In the first aspect of the present invention, the difference in the saponification degree of the polyvinyl alcohol between the high refractive index layer coating liquid and the low refractive index layer coating liquid is preferably 3 mol % or more, more preferably 8 mol % or more. That is, the difference between the saponification degree of the high refractive index layer and that of the low refractive index layer is preferably 3 mol % or more, more preferably 8 mol % or more. An upper limit of the difference between the saponification degree of the high refractive index layer and that of the low refractive index layer is preferably higher in view of suppressing/preventing interlayer mixing between the high refractive index layer and the low refractive index layer, and is not particularly limited, but is preferably 20 mol % or less, more preferably 15 mol % or less.

When each refractive index layer includes a plurality of polyvinyl alcohols (having different saponification degrees and polymerization degrees), a polyvinyl alcohol for which the difference in the saponification degree is compared in each refractive index layer is a polyvinyl alcohol having the largest content in the refractive index layer. Here, when a polyvinyl alcohol is referred to as “a polyvinyl alcohol having the largest content in the refractive index layer”, it is assumed that polyvinyl alcohols having the difference in the saponification degree of less than 2 mol % are the same polyvinyl alcohol, and the polymerization degree is calculated. Specifically, when one layer includes 10% by weight of a polyvinyl alcohol having a saponification degree of 90 mol %, 40% by weight of a polyvinyl alcohol having a saponification degree of 91 mol %, and 50% by weight of a polyvinyl alcohol having a saponification degree of 92 mol %, these three polyvinyl alcohols are assumed to be the same polyvinyl alcohol, and the saponification degree of the mixture of these three polyvinyl alcohols is (0.90×0.1+0.91×0.4+0.92×0.5)×100=91.4 mol %. The above-described “polyvinyl alcohols having a difference in the saponification degree of less than 2 mol %” is only required to have a difference in the saponification degree of less than 2 mol % when attention is focused on any one of the polyvinyl alcohols. For example, when vinyl alcohols of 90, 91, and 92 mol % are included, any polyvinyl alcohol has a difference of less than 2 mol % when attention is focused on the vinyl alcohol of 91 mol %, and therefore, these are the same polyvinyl alcohol.

When one layer includes polyvinyl alcohols having a difference in the saponification degree of 2 mol % or more, these polyvinyl alcohols are assumed to be a mixture of different polyvinyl alcohols, and the polymerization degree and the saponification degree for each polyvinyl alcohol are calculated.

For example, 30% by weight of a polyvinyl alcohol having a polymerization degree of 1300 and a saponification degree of 98%, 10% by weight of a polyvinyl alcohol having a polymerization degree of 1700 and a saponification degree of 88%, 10% by weight of a polyvinyl alcohol having a polymerization degree of 2200 and a saponification degree of 87%, 10% by weight of a polyvinyl alcohol having a polymerization degree of 2400 and a saponification degree of 86%, 20% by weight of a polyvinyl alcohol having a polymerization degree of 3500 and a saponification degree of 87%, and 20% by weight of a polyvinyl alcohol having a polymerization degree of 4500 and a saponification degree of 86%, are included, a polyvinyl alcohol having the largest content is a mixture of the five polyvinyl alcohols having polymerization degrees of 1700, 2200, 2400, 3500, and 4500 (the difference in the saponification degree is less than 2 mol %, and therefore, these polyvinyl alcohols are assumed to be the same polyvinyl alcohol). The polymerization degree of the mixture is (1700×0.1+2200×0.1+2400×0.1+3500×0.2+4500×0.2)/0.7≈3186. The saponification degree is 87%.

When the simultaneous multilayer coating is performed using a slide bead coating method, the temperature of the high refractive index layer coating liquid or the low refractive index layer coating liquid is preferably 25 to 60° C., more preferably 30 to 45° C. When a curtain coating method is used, the temperature is preferably 25 to 60° C., more preferably 30 to 45° C.

When the simultaneous multilayer coating is performed, the viscosity of the high refractive index layer coating liquid or the low refractive index layer coating liquid is not particularly limited. However, when the slide bead coating method is used, the viscosity is preferably 5 to 160 mPa·s, more preferably 60 to 140 mPa·s in the above-described preferable temperature range of the coating liquid. When the curtain coating method is used, the viscosity is preferably 5 to 1200 mPa·s, more preferably 25 to 500 mPa·s in the above-described preferable temperature range of the coating liquid. Within such a range of the viscosity, it is possible to perform the simultaneous multilayer coating efficiently.

The viscosity of the coating liquid at 15° C. is preferably 100 mPa·s or more, more preferably 100 to 30000 mPa·s, still more preferably 2500 to 30000 mPa·s.

Conditions for coating and drying methods are not particularly limited. However, for example, in a sequential coating method, first, one of the high refractive index layer coating liquid and the low refractive index layer coating liquid heated to 30 to 60° C. is coated on a substrate and dried to form a layer. Thereafter, the other coating liquid is coated on the layer and dried to form a laminated film precursor (unit). Subsequently, the number of the units necessary for exhibiting desired shielding performance are sequentially coated, dried, and laminated by the above-described method to obtain a laminated film precursor. When being dried, the formed coating film is preferably dried at 30° C. or higher. For example, the coating film is preferably dried at a wet bulb temperature of 5 to 50° C. and at a film surface temperature of 5 to 100° C. (preferably 10 to 50° C.). For example, warm air at 40 to 60° C. is blown for 1 to 5 seconds for drying. As the drying method, warm air drying, infrared drying, or microwave drying is used. Drying in a multi stage process is more preferable than drying in a single process. The temperature of a constant rate drying section is preferably lower than that of a falling rate drying section. In this case, the temperature range of the constant rate drying section is preferably 30 to 60° C., and the temperature range of the falling rate drying section is preferably 50 to 100° C.

Conditions for coating and drying methods in the simultaneous multilayer coating are as follows. That is, the high refractive index layer coating liquid and the low refractive index layer coating liquid are heated to 30 to 60° C., and the simultaneous multilayer coating of the high refractive index layer coating liquid and the low refractive index layer coating liquid is performed on a substrate. Thereafter, the temperature of the formed coating film is temporarily lowered preferably to 1 to 15° C. (setting), and then the coating film is preferably dried at 10° C. or higher. More preferable conditions for drying are the wet bulb temperature of 5 to 50° C. and the film surface temperature of 10 to 50° C. For example, drying is performed by blowing warm air at 40 to 80° C. for 1 to 5 seconds. As a cooling method immediately after coating, a horizontal setting method is preferably used in view of improving the uniformity of the formed coating film.

Here, the above-described setting means a step of increasing the viscosity of a coating film composition, and lowering fluidity of the materials between the layers or in the layers or gelling the coating film composition, for example, by lowering the temperature by blowing cool air or the like to the coating film. A state in which nothing is stuck to a finger when the surface of the coating film is pressed by the finger, is defined as a state in which setting is completed.

A period of time (setting time) from the time of coating to the time when setting is completed by blowing cool air, is preferably 5 minutes or less, more preferably 2 minutes or less. A lower limit of the time is not particularly limited, but is preferably 45 seconds or more. When the setting time is too short, mixing of the components in the layer may be insufficient. On the other hand, when the setting time is too long, interlayer diffusion of the inorganic oxide particles proceeds, and the difference in the refractive index between the high refractive index layer and the low refractive index layer may be insufficient. If elasticity of an intermediate layer between the high refractive index layer and the low refractive index layer becomes higher quickly, it is not necessary to provide the setting step.

The setting time can be adjusted by adjusting a concentration of the polyvinyl alcohol or the inorganic oxide particles, or by adding other components, for example, a known gelling agent such as gelatin, pectin, agar, carrageenan, or gellan gum.

The temperature of the cool air is preferably 0 to 25° C., more preferably 5 to 10° C. The time during which the coating film is exposed to the cool air depends on a conveying speed of the coating film, but is preferably 10 to 360 seconds, more preferably 10 to 300 seconds, still more preferably 10 to 120 seconds.

Coating should be performed such that the coating thickness of the high refractive index layer coating liquid or the low refractive index layer coating liquid is the above-described preferable thickness when being dried.

[Substrate]

As a substrate of the optical reflective film, various resin films can be used. Examples thereof include a polyolefin film (polyethylene, polypropylene, etc.), a polyester film (polyethylene terephthalate (PET), polyethylene naphthalate, etc.), polyvinyl chloride, and cellulose triacetate. A preferable example thereof is a polyester film. The polyester film (hereinafter, referred to as polyester) is not particularly limited, but is preferably a polyester including a dicarboxylic acid component and a diol component as main components and having a film-forming property.

Examples of the dicarboxylic acid component as a main component include terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylethane dicarboxylic acid, cyclohexane dicarboxylic acid, diphenyl dicarboxylic acid, diphenylthioether dicarboxylic acid, diphenylketone dicarboxylic acid, and phenylindan dicarboxylic acid. Examples of the diol component include ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone, and cyclohexanediol. Among the polyesters including these compounds as main components, a polyester mainly including terephthalic acid or 2,6-naphthalene dicarboxylic acid as the dicarboxylic acid component, and ethylene glycol or 1,4-cyclohexane dimethanol as the diol component, is preferable in view of transparency, mechanical strength, dimensional stability, or the like. Among these, a polyester mainly including polyethylene terephthalate or polyethylene naphthalate, a copolyester including terephthalic acid, 2,6-naphthalene dicarboxylic acid, and ethylene glycol, and a polyester mainly including a mixture of two or more kinds of these polyesters are preferable.

The thickness of the substrate used in the first aspect of the present invention is preferably 10 to 300 μm, particularly preferably 20 to 150 μm. Two sheets of the substrate may be laminated. In this case, the kinds thereof may be the same as or different from each other.

The transmittance of the substrate in a visible light region indicated by JIS R3106-1998 is preferably 85% or more, particularly preferably 90% or more. The substrate having a transmittance of the above-described value or more is advantageous in view of obtaining a transmittance in a visible light region indicated by JIS R3106-1998 of 50% or more (upper limit: 100%) when an optical reflective film is formed, and is preferable.

The substrate using the above-described resin or the like may be an undrawn film or a drawn film. The drawn film is preferable in view of improving strength and suppressing thermal expansion.

The substrate can be manufactured by a general method known in the related art. For example, it is possible to manufacture an undrawn substrate which is substantially amorphous and is not oriented, by melting a resin as a material with an extruder, extruding the resin using a circular die or a T die, and cooling the resin rapidly. It is possible to manufacture a drawn substrate by drawing the undrawn substrate in a flow (longitudinal) direction of the substrate or a direction perpendicular (transverse) to the flow direction of the substrate by a known method such as uniaxial drawing, tenter-type sequential biaxial drawing, tenter-type simultaneous biaxial drawing, or tubular type simultaneous biaxial drawing. In this case, a draw ratio can be appropriately selected according to the resin as a raw material of the substrate, but is preferably 2 to 10 times in each of the longitudinal direction and the transverse direction.

The substrate may be subjected to a relaxation treatment or an off-line heat treatment in view of dimensional stability. The relaxation treatment is preferably performed after thermal fixation in a drawing and film-forming step of the polyester film, in a tenter of the transverse drawing or in a step after the polyester film leaves the tenter and before the polyester film is wound. The relaxation treatment is performed preferably at a treatment temperature of 80 to 200° C., more preferably at a treatment temperature of 100 to 180° C. The relaxation treatment is performed preferably at a relaxation ratio of 0.1 to 10%, more preferably at a relaxation ratio of 2 to 6% in each of the longitudinal direction and the transverse direction. The substrate subjected to the relaxation treatment has improved heat resistance and excellent dimensional stability by being subjected to the following off-line heat treatment.

An undercoating layer coating liquid is preferably coated on one surface or both surfaces of the substrate in-line in a film forming step. Undercoating in the film forming step is referred to as in-line undercoating. Examples of the resin used for the undercoating layer coating liquid include a polyester resin, an acrylic-modified polyester resin, a polyurethane resin, an acrylic resin, a vinyl resin, a vinylidene chloride resin, a polyethyleneimine vinylidene resin, a polyethyleneimine resin, a polyvinyl alcohol resin (polyvinyl alcohol), a modified polyvinyl alcohol resin (modified polyvinyl alcohol), and gelatin. Any of these resins can be preferably used. An additive known in the related art can be added to the undercoating layer. The undercoating layer can be coated by a known method such as roll coating, gravure coating, knife coating, dip coating, or spray coating. A coating amount of the undercoating layer is preferably about 0.01 to 2 g/m² (dry state).

[Film Design]

The optical reflective film of the first aspect of the present invention includes at least one unit in which a high refractive index layer and a low refractive index layer are laminated. The optical reflective film preferably includes a multilayer optical interference film formed by alternately laminating the high refractive index layer and the low refractive index layer on one surface or both surfaces of the substrate. In view of productivity, a preferable range of the total number of the high refractive index layer and the low refractive index layer per surface of the substrate is 100 or less, more preferably 45 or less. A lower limit of the preferable range of the total number of the high refractive index layer and the low refractive index layer is preferably 5 or more. The preferable range of the total number of the high refractive index layer and the low refractive index layer is applicable when laminating is performed only on one surface of the substrate, and is applicable when laminating is performed simultaneously on both surfaces of the substrate. When laminating is performed on both surfaces of the substrate, the total number of the high refractive index layer and the low refractive index layer on one surface of the substrate may be the same as or different from that on the other surface. In the optical reflective film of the first aspect of the present invention, each of the bottom layer (layer in contact with the substrate) and the top surface layer may be the high refractive index layer or the low refractive index layer. However, the optical reflective film of the first aspect of the present invention preferably has a layer structure in which each of the bottom layer and the top surface layer is the low refractive index layer, in view of adhesion of the bottom layer to the substrate, blown resistance of the top surface layer, and excellent coatability and adhesion of a hard coat layer or the like to the top surface layer due to the layer structure in which the low refractive index layer is positioned in each of the bottom layer and the top surface layer.

In general, it is preferable to design an optical reflective film having a large difference in the refractive index between the high refractive index layer and the low refractive index layer, in view of being able to increase a reflectivity with respect to a desired ray of light with a small number of layers. In the first aspect of the present invention, at least a difference in the refractive index between two adjacent layers (the high refractive index layer and the low refractive index layer) is preferably 0.3 or more, more preferably 0.35 or more, still more preferably 0.4 or more. An upper limit thereof is not particularly limited, but is usually 1.4 or less.

It is possible to calculate the difference in the refractive index and the necessary number of layers using a commercially available optical design software. For example, in order to obtain a reflectivity of near infrared light of 90% or more, when the difference in the refractive index is less than 0.1, it is necessary to laminate 200 or more layers. In addition to lower productivity, scattering on the lamination interface becomes large, transparency is reduced, and it may be very difficult to manufacture the film without failure.

When the high refractive index layer and the low refractive index layer are alternately laminated in the optical reflective film, the difference in the refractive index between the high refractive index layer and the low refractive index layer is preferably within the above-described preferable range of the difference in the refractive index. However, for example, when the top surface layer is formed as a layer to protect the film, or when the bottom layer is formed as an adhesion improving layer to the substrate, the top surface layer or the bottom layer may have a structure having a difference in the refractive index outside the above-described preferable range.

In the first aspect of the present invention, the terms “high refractive index layer” and “low refractive index layer” mean that a refractive index layer having a higher refractive index is referred to as a high refractive index layer, and a refractive index layer having a lower refractive index is referred to as a low refractive index layer, when the difference in the refractive index between two adjacent layers is compared. Therefore, the terms “high refractive index layer” and “low refractive index layer” include any form other than a form in which the refractive index layers have the same refractive index when attention is focused on two adjacent refractive index layers in the refractive index layers included in the optical reflective film.

The larger a ratio of the refractive index is, the higher the reflectivity is, because reflection on an interface between adjacent layers depends on the ratio of the refractive index between the layers. When a single layer film is viewed, by a relation of an optical path difference between a ray of reflected light on the layer surface and a ray of reflected light on the layer bottom, represented by n·d=wavelength/4, control can be performed such that both rays of reflective light are enhanced to each other due to a phase difference, and the reflectivity can be increased. Here, n represents a refractive index, d represents a physical film thickness of a layer, and n·d represents an optical film thickness. By utilizing the optical path difference, reflection can be controlled. By utilizing the relation, the refractive index and the film thickness of each layer are controlled, and reflection of visible light or near infrared light is controlled. That is, the reflectivity in a specific wavelength region can be increased by the refractive index of each layer, the film thickness of each layer, and a method for laminating layers.

The optical reflective film of the first aspect of the present invention can be a visible light reflective film or a near infrared ray reflective film by changing the specific wavelength region to increase the reflectivity. That is, when the specific wavelength region to increase the reflectivity is set to a visible light region, the optical reflective film becomes a visible light reflective film. When the specific wavelength region to increase the reflectivity is set to a near infrared region, the optical reflective film becomes a near infrared ray reflective film. When the specific wavelength region to increase the reflectivity is set to an ultraviolet ray region, the optical reflective film becomes an ultraviolet ray reflective film. When the optical reflective film of the first aspect of the present invention is used for a heat shielding film, the optical reflective film is only required to be a (near) infrared reflective (shielding) film. In the case of the infrared reflective film, a multilayer film in which films having different reflective indices are laminated is formed on a polymer film. The transmittance at 550 nm in a visible light region indicated by JIS R3106-1998 is preferably 50% or more, more preferably 70% or more, still more preferably 75% or more. The transmittance at 1200 nm is preferably 35% or less, more preferably 25% or less, still more preferably 20% or less. It is preferable to design the optical film thickness and the unit so as to have the transmittance within these preferable ranges. A region of the wavelength of 900 nm to 1400 nm preferably includes a region having a reflectivity of more than 50%.

Infrared region of incident spectra of light reaching directly from the sun has a relation to an increase in room temperature. By shielding the light in the infrared region, it is possible to suppress the increase in room temperature. As for an accumulation energy ratio from the shortest wavelength (760 nm) to the longest wavelength of 3200 nm based on a weighting coefficient described in Japanese Industrial Standard JIS R3106-1998, in the accumulation energy from 760 nm to each wavelength when the total energy in the whole infrared region from the wavelength of 760 nm to the longest wavelength of 3200 nm is assumed to be 100, the total energy from 760 to 1300 nm occupies about 75% of the total energy in the whole infrared region. Therefore, it is effective in saving energy by shielding a heat ray to shield light in the wavelength region up to 1300 nm.

When the reflectivity in the near infrared region (760 to 1300 nm) is about 80% or more at a maximum peak value, lowering of a sensible temperature is obtained by a sensory evaluation. For example, at a window side facing the southeast way in the morning in August, when light was shielded such that the reflectivity in the near infrared region was about 80% at a maximum peak value, there was a clear difference in the sensible temperature.

A multilayer film structure required to exhibit such a function was obtained by an optical simulation (FTG Software Associates Film DESIGN Version 2.23.3700). As a result, it has been found that excellent properties are obtained when six or more layers are laminated using a high refractive index layer of 1.9 or more, preferably 2.0 or more. For example, in a simulation result of a model in which eight high refractive index layers and low refractive index layers (refractive index=1.35) are alternately laminated, when the high refractive index layer has a refractive index of 1.8, the reflectivity does not reach 70%, but when the high refractive index layer has a refractive index of 1.9, the reflectivity is about 80%. In a model in which the high refractive index layers (refractive index=2.2) and the low refractive index layers (refractive index=1.35) are alternately laminated, when the number of laminated layers is four, the reflectivity does not reach 60%, but when the number of laminated layers is six, the reflectivity is about 80%.

The low refractive index layer has a refractive index preferably of 1.10 to 1.60, more preferably of 1.30 to 1.50. The high refractive index layer has a refractive index preferably of 1.80 to 2.50, more preferably of 1.90 to 2.20.

The thickness (thickness after drying) per layer of the refractive index layer is preferably 20 to 1000 nm, more preferably 50 to 500 nm, still more preferably 50 to 350 nm.

The total thickness of the optical reflective film of the first aspect of the present invention is preferably 12 μm to 315 μm, more preferably 15 μm to 200 μm, still more preferably 20 μm to 100 μm.

[Layer Structure of Optical Reflective Film]

The optical reflective film includes at least one unit in which a high refractive index layer and a low refractive index layer are laminated on a substrate. The unit may be formed only on one surface of the substrate, or may be formed on both surfaces thereof. The unit is preferably formed on both surfaces of the substrate, because the reflectivity of a specific wavelength is improved.

In order to add additional functions, the optical reflective film may include one or more functional layers under the substrate or on the top surface layer opposite to the substrate. Examples of the functional layer include a conductive layer, an antistatic layer, a gas barrier layer, an easily adhesive layer (adhesive layer), an antifouling layer, a deodorant layer, a drop-flowing layer, an easily slidable layer, a hard coat layer, an abrasion resistant layer, an antireflection layer, an electromagnetic wave shielding layer, an ultraviolet absorbing layer, an infrared absorbing layer, a printing layer, a fluorescent emitting layer, a hologram layer, a peeling layer, a pressure-sensitive adhesive layer, an adhesive layer, an infrared cut layer other than the high refractive index layer and the low refractive index layer (metal layer, liquid crystal layer), a colored layer (visible light absorbing layer), and an intermediate film layer to be used for laminated glass.

The order of laminating the above-described various functional layers in the reflective film is not particularly limited.

For example, when the optical reflective film is stuck to an interior side of window glass (inner sticking), a preferable example is as follows. That is, an optical reflective layer including at least one unit in which a high refractive index layer and a low refractive index layer are laminated, and a pressure-sensitive adhesive layer are laminated on a surface of a substrate in this order, and a hard coat layer is coated on the opposite surface of the substrate to the surface on which these layers are laminated. The order may be the pressure-sensitive adhesive layer, the substrate, the optical reflective layer, and the hard coat layer. Another functional layer, another substrate, an infrared absorber, or the like may be further included. When the optical reflective film of the first aspect of the present invention is stuck to an exterior side of window glass (outer sticking), a preferable example is as follows. That is, the optical reflective layer and the pressure-sensitive adhesive layer are laminated on a surface of the substrate in this order, and the hard coat layer is coated on the opposite surface of the substrate to the surface on which these layers are laminated. As in the inner sticking, the order may be the pressure-sensitive adhesive layer, the substrate, the optical reflective layer, and the hard coat layer, and another functional layer substrate, an infrared absorber, or the like may be further included.

[Application of Optical Reflective Film: Optical Reflector]

The optical reflective film of the first aspect of the present invention can be applied to a wide range of fields. That is, a preferable embodiment of the first aspect of the present invention is an optical reflector in which the optical reflective film is provided on at least one surface of a base. For example, the optical reflective film is used mainly in order to increase weather resistance as a film to be stuck to window, a film for an agricultural greenhouse, or the like. Examples of the film to be stuck to window include a heat ray reflecting film which is stuck to an apparatus (base) exposed to the sunlight for a long time, such as outdoor window of a building or car window, to impart a heat ray reflecting effect. Particularly, the optical reflective film is suitable for a member in which the optical reflective film according to the first aspect of the present invention is stuck to a base such as glass or a glass alternative resin directly or through an adhesive.

Specific examples of the base include glass, a polycarbonate resin, a polysulfone resin, an acrylic resin, a polyolefin resin, a polyether resin, a polyester resin, a polyamide resin, a polysulfide resin, an unsaturated polyester resin, an epoxy resin, a melamine resin, a phenol resin, a diallyl phthalate resin, a polyimide resin, an urethane resin, a polyvinyl acetate resin, a polyvinyl alcohol resin, a styrene resin, a vinyl chloride resin, a metal plate, and a ceramic. The kind of the resin may be any of a thermoplastic resin, a thermosetting resin, and an ionizing radiation curable resin. Two or more kinds thereof may be used in combination. The base can be manufactured by a known method such as extrusion molding, calender molding, injection molding, hollow molding, or compression molding. The thickness of the base is not particularly limited, but is usually 0.1 mm to 5 cm.

An adhesive layer or a pressure-sensitive adhesive layer to stick the optical reflective film and the base together is preferably disposed such that the optical reflective film is disposed on a side of an incident surface of the sunlight (heat ray). When the optical reflective film is sandwiched between window glass and the base, the optical reflective film can be sealed from surrounding gas such as moisture, has excellent durability, and is preferable. Even when the optical reflective film according to the first aspect of the present invention is disposed outdoors or outside a car (for outer sticking), the optical reflective film has environmental durability, and is preferable.

An adhesive layer or a pressure-sensitive adhesive layer to stick the optical reflective film and the base together is preferably disposed such that the optical reflective film is disposed on a side of an incident surface of the sunlight (heat ray) when the optical reflective film is stuck to window glass or the like. When the optical reflective film is sandwiched between window glass and a substrate, the optical reflective film can be sealed from surrounding gas such as moisture and has preferable durability. Even when the optical reflective film of the first aspect of the present invention is disposed outdoors or outside a car (for outer sticking), the optical reflective film has environmental durability, and is preferable.

As the adhesive applicable to the first aspect of the present invention, an adhesive including a photocurable or thermosetting resin as a main component can be used.

An adhesive having durability to an ultraviolet ray is preferable, and an acrylic pressure-sensitive adhesive or a silicone pressure-sensitive adhesive is preferable. The acrylic pressure-sensitive adhesive is more preferable in view of a pressure-sensitive adhesive property and cost. Of a solvent type and emulsion type acrylic pressure-sensitive adhesives, the solvent type acrylic pressure-sensitive adhesive is preferable particularly because of easy control of peel strength. When a solution polymerization polymer is used as the acrylic solvent pressure-sensitive adhesive, a known monomer can be used as the monomer for the polymer.

Furthermore, a polyvinyl butyral resin or an ethylene-vinyl acetate copolymer resin used as an intermediate layer of laminated glass may be used. Specific examples thereof include a plastic polyvinyl butyral [manufactured by Sekisui Chemical Co., Ltd., Mitsubishi Monsanto Co., etc.], an ethylene-vinyl acetate copolymer [DURAMIN manufactured by DuPont, manufactured by Takeda Pharmaceutical Company Limited], and a modified ethylene-vinyl acetate copolymer [Melthene G manufactured by Tosoh Corporation]. An ultraviolet absorber, an anti-oxidant, an antistatic agent, a heat stabilizer, a lubricant, a filler, a coloring, an adhesion control agent, or the like may be appropriately added and blended to the adhesive layer.

Thermal insulation performance or solar heat shielding performance of the optical reflective film or the optical reflector (infrared shield) can be generally determined by a method in conformity with JIS R 3209 (1998) (multi-layered glass), JIS R 3106 (1998) (method for testing a transmittance, a reflectivity, an emissivity, and a solar heat gain coefficient of plate glass), or JIS R 3107 (1998) (method for calculating thermal resistance of plate glass and a heat transmission coefficient in architecture).

In measurement of a solar transmittance, a solar reflectivity, an emissivity, and a visible light transmittance, (1) a spectral transmittance and a spectral reflectivity for various kinds of single plate glass are measured using a spectrometer of a wavelength (300 to 2500 nm). In addition, the emissivity is measured using a spectrometer of a wavelength of 5.5 to 50 μm. Default values are used for the emissivity of float plate glass, polished glass, template glass, and heat ray absorbing plate glass. (2) In calculation of the solar transmittance, the solar reflectivity, a solar absorbance, and a corrected emissivity, the solar transmittance, the solar reflectivity, the solar absorbance, and a normal emissivity are calculated in conformity with JIS R 3106 (1998). The corrected emissivity is determined by multiplying the normal emissivity by a coefficient indicated in JIS R 3107 (1998). In calculation of a thermal insulation property and a solar heat shielding property, (1) heat resistance of multi-layered glass is calculated using a measured value of thickness and the corrected emissivity in conformity with JIS R 3209 (1998). However, when the thickness of the hollow layer is more than 2 mm, gas heat conductance of the hollow layer is determined in conformity with JIS R 3107 (1998). (2) The thermal insulation property is determined as heat transmission resistance by adding heat transfer resistance to the heat resistance of the multi-layered glass. (3) The solar heat shielding property is calculated by determining a solar heat gain coefficient in conformity with JIS R 3106 (1998) and subtracting the solar heat gain coefficient from one.

### Second Aspect of the Present Invention

An object of a second aspect of the present invention is to provide an optical reflective film which has excellent folding resistance and suppresses occurrence of curling. The object of the second aspect of the present invention is achieved by an optical reflective film including at least one unit in which a low refractive index layer and a high refractive index layer are laminated on a substrate. The high refractive index layer includes an ethylene-modified polyvinyl alcohol and titanium oxide particle as inorganic oxide particles. The saponification degree of the ethylene-modified polyvinyl alcohol is 95.0 to 99.9 mol %. A content of the inorganic oxide particles in the high refractive index layer is 40 to 60% by volume.

The optical reflective film of the second aspect of the present invention can suppress or prevent occurrence of curling. The optical reflective film of the second aspect of the present invention has excellent folding resistance.

The second aspect of the present invention provides an optical reflective film including at least one unit in which a low refractive index layer and a high refractive index layer are laminated on a substrate. The high refractive index layer includes an ethylene-modified polyvinyl alcohol and titanium oxide particle as inorganic oxide particles. The saponification degree of the ethylene-modified polyvinyl alcohol is 95.0 to 99.9 mol %. A content of the inorganic oxide particles in the high refractive index layer is preferably 40 to 60% by volume.

The optical reflective film of the second aspect of the present invention is characterized in that the high refractive index layer includes, as a binder resin, an ethylene-modified polyvinyl alcohol having such a specific saponification degree as described above and includes, as inorganic oxide particles, titanium oxide particles having a specific content. By the above-described structure, occurrence of curling in the optical reflective film can be suppressed or prevented, and an optical reflective film having excellent folding resistance can be obtained.

A mechanism of exhibiting an effective nest by the above-described structure of the second aspect of the present invention is estimated to be as follows. Note that the present invention is not limited by the following estimation.

That is, the optical reflective film as a target of the second aspect of the present invention is usually manufactured by using a coating liquid for each of the high refractive index layer and the low refractive index layer and by coating a unit manufactured from each coating liquid so as to have an alternate multilayer structure. When an aqueous coating liquid unit is used, it is necessary to secure a refractive index designed for each layer by preventing components of the coating liquid in each layer from being mixed as much as possible. At the same time, in order to control the refractive index, it is necessary to increase the content of the inorganic oxide particles included in each layer. A coating film having a large content of the inorganic oxide particles has low flexibility, and may cause a crack on a surface of the coating film or may be peeled off from a substrate when the temperature or the humidity changes. Furthermore, curling occurs in the film by a change in volume due to water absorption of the inorganic oxide particles.

The ethylene-modified polyvinyl alcohol used for the high refractive index layer of the optical reflective film of the second aspect of the present invention includes a structural unit (CH₂—CH₂—) derived from ethylene and a structural unit (CH₂—C(OH) H—) derived from a vinyl alcohol. In the optical reflective film of the second aspect of the present invention, a film which does not easily absorb water and has excellent folding resistance can be obtained by introducing the structural unit derived from ethylene into a polyvinyl alcohol as a binder. A hydroxyl group (OH) of the structural unit derived from a vinyl alcohol in the ethylene-modified polyvinyl alcohol forms a Ti—OH bond with titanium oxide particles as the inorganic oxide particles and strongly interacts therewith (is bonded to the surface of the titanium oxide particles). Therefore, water is not easily adsorbed on the surface of the inorganic oxide particles. In addition, the inorganic oxide particles which have interacted with the ethylene-modified polyvinyl alcohol are dispersed stably because the hydrophobic portion (structural unit derived from ethylene) forms an emulsion in the aqueous coating liquid. In addition, the structural unit derived from ethylene, which is the hydrophobic portion, has a low molecular weight. Therefore, the ethylene-modified polyvinyl alcohols are not entangled with each other much or at all. Therefore, a uniform coating film can be manufactured by suppressing or preventing flocculation of the inorganic oxide particles (formation of gel).

In addition, water resistance can be improved by setting the saponification degree of the ethylene-modified polyvinyl alcohol within a predetermined range. Therefore, an optical reflective film in which curling hardly occurs can be obtained. An optical reflective film which has high folding resistance and suppresses occurrence of curling can be obtained by controlling the content of the inorganic oxide particles within a predetermined range.

Hereinafter, components of the optical reflective film of the second aspect of the present invention will be described in detail. In the description of the second aspect of the present invention, when the low refractive index layer and the high refractive index layer are not distinguished from each other, the low refractive index layer and the high refractive index layer are referred to as “refractive index layer” as a concept including the two.

In the second aspect of the present invention, “X to Y” indicating a range means “X or more and Y or less”. Unless otherwise specified, an operation and measurement for physical properties or the like are performed under the conditions of room temperature (20 to 25° C.)/relative humidity of 40 to 50%.

[Ethylene-Modified Polyvinyl Alcohol]

The optical reflective film of the second aspect of the present invention includes at least one kind of ethylene-modified polyvinyl alcohol in the high refractive index layer. The ethylene-modified polyvinyl alcohol acts as a binder (binder resin) in the optical reflective film of the second aspect of the present invention.

Among the binders used in the high refractive index layer, a content of the ethylene-modified polyvinyl alcohol is preferably 80 to 100% by weight, more preferably 90 to 100% by weight, still more preferably 95 to 100% by weight, most preferably 100% by weight. As a binder which can be added to the high refractive index layer, other than the ethylene-modified polyvinyl alcohol, a polyvinyl alcohol other than the ethylene-modified polyvinyl alcohol (an unmodified polyvinyl alcohol or a modified polyvinyl alcohol other than the ethylene-modified polyvinyl alcohol), described below, or another water-soluble polymer can be used.

The ethylene-modified polyvinyl alcohol is a copolymer including a structural unit (CH₂—CH₂—) derived from ethylene, a structural unit (CH₂—C(OH)H—) derived from a vinyl alcohol, and if necessary a structural unit derived from another monomer copolymerizable with these structural units. Here, each structural unit included in the ethylene-modified polyvinyl alcohol used in the high refractive index layer of the optical reflective film of the second aspect of the present invention may have any shape, and for example, may have a block shape or a random shape.

A degree of ethylene modification of the ethylene-modified polyvinyl alcohol in the second aspect of the present invention is not particularly limited, but is preferably 1 to 10 mol %. When the degree of ethylene modification is 1 mol % or more, an effect of increasing strength by the hydrophobic structural unit derived from ethylene can be obtained sufficiently. When the degree of ethylene modification is 10 mol % or less, increase in haze of the film due to an undissolved residue at the time of dissolution can be suppressed. The degree of ethylene modification of the ethylene-modified polyvinyl alcohol is preferably 3 to 7 mol %. In the second aspect of the present invention, the degree of ethylene modification means a copolymerization amount (mol %) of ethylene in an alcohol unit converted from a vinyl ester unit of a product obtained by saponifying an ethylene-vinyl ester polymer obtained by copolymerizing ethylene and a vinyl ester monomer. A numerical value thereof is measured by a nuclear magnetic resonance (proton NMR) method.

The ethylene-modified polyvinyl alcohol is preferably water-soluble (water-soluble binder resin). By using the water-soluble ethylene-modified polyvinyl alcohol, a stable coating liquid can be manufactured. As a result, coatability is excellent. Therefore, the water-soluble ethylene-modified polyvinyl alcohol is preferable. In the second aspect of the present invention, the meaning of “water-soluble (water-soluble binder resin)” is similar to that in the first aspect of the present invention. When there are a plurality of refractive index layers, ethylene-modified polyvinyl alcohols used in the respective refractive index layers may be the same as or different from each other.

The ethylene-modified polyvinyl alcohol can be manufactured by saponifying (hydrolyzing) an ethylene-vinyl ester copolymer obtained by copolymerizing ethylene and a vinyl ester (vinyl ester monomer) and converting a vinyl ester unit into a vinyl alcohol unit. In the studies by the present inventors, a normal polyvinyl alcohol has a high interaction with inorganic oxide particles and is easily gelled. Particularly, this tendency is high for a highly saponified polyvinyl alcohol. However, the ethylene-modified polyvinyl alcohol is not gelled after being mixed with the inorganic oxide particles even when the ethylene-modified polyvinyl alcohol is specifically highly saponified. As described above, this is considered to be because of stabilization of the particles after adsorption and a specifically high effect of suppressing gelation. This can bring excellent coatability.

The saponification degree of the ethylene-modified polyvinyl alcohol included in the high refractive index layer of the optical reflective film of the second aspect of the present invention is 95.0 to 99.9 mol %. Here, the saponification degree means a ratio of a hydroxyl group with respect to the total number of the hydroxyl group and a carbonyloxy group such as an acetyloxy group (derived from vinyl acetate as a raw material) in the structural unit derived from a vinyl alcohol. When the high refractive index layer includes a plurality of ethylene-modified polyvinyl alcohols, the saponification degree means a saponification degree of the ethylene-modified polyvinyl alcohol having the largest content in the high refractive index layer. Here, when an ethylene-modified polyvinyl alcohol is referred to as “an ethylene-modified polyvinyl alcohol having the largest content in the high refractive index layer”, it is assumed that ethylene-modified polyvinyl alcohols having a difference in the saponification degree of less than 2 mol % are the same ethylene-modified polyvinyl alcohol, and the saponification degree is calculated. When one layer includes ethylene-modified polyvinyl alcohols having the difference in the saponification degree of 2 mol % or more, these ethylene-modified polyvinyl alcohols are assumed to be a mixture of different ethylene-modified polyvinyl alcohols, and the saponification degree for each ethylene-modified polyvinyl alcohol is calculated. When the saponification degree of the ethylene-modified polyvinyl alcohol is less than 95 mol %, water resistance of the optical reflective film is lowered, curling easily occurs due to water absorption, and folding resistance is lowered. The saponification degree of the ethylene-modified polyvinyl alcohol is preferably higher, but an upper limit thereof is substantially 99.9 mol %. Here, the saponification degree of the ethylene-modified polyvinyl alcohol can be measured in conformity with a method described in JIS K6726: 1994.

A polymerization degree of the ethylene-modified polyvinyl alcohol is not particularly limited, but is preferably 100 or more, more preferably 1000 or more. Here, as described above, an upper limit of the polymerization degree of the ethylene-modified polyvinyl alcohol according to the second aspect of the present invention is preferably high, and therefore, is not particularly limited, but is preferably 3000 or less, more preferably 2500 or less. In the second aspect of the present invention, the polymerization degree of the ethylene-modified polyvinyl alcohol means a polymerization degree measured in conformity with JIS K6726: 1994.

A vinyl ester monomer to form the ethylene-modified polyvinyl alcohol is not particularly limited. However, examples thereof include the monomers exemplified in the first embodiment of the present invention, such as vinyl acetate. Among these, vinyl acetate is preferable. One kind of the vinyl ester monomers may be used alone, or a mixture of two or more kinds thereof may be used.

The ethylene modified polyvinyl used in the second aspect of the present invention may include, if necessary, another copolymerizable monomer within a range not impairing the effect of the invention, in addition to ethylene and the vinyl ester monomer. When the ethylene-modified polyvinyl alcohol according to the second aspect of the present invention includes another copolymerizable monomer, a content of the other copolymerizable monomer is not particularly limited as long as the content is within a range not impairing the effect of the invention, but is preferably 1 to 5 mol % with respect to a total amount of ethylene and the vinyl ester monomer.

When the ethylene-modified polyvinyl alcohol used in the second aspect of the present invention includes another copolymerizable monomer, the other copolymerizable monomer is not particularly limited. However, examples thereof include propylene described above and exemplified in the first aspect of the present invention. One kind of the other copolymerizable monomers may be used alone, or a mixture of two or more kinds thereof may be used.

The ethylene-modified polyvinyl alcohols may be each used alone, or two or more kinds thereof having different average polymerization degrees or different kinds of modification may be used.

As described above, the ethylene-modified polyvinyl alcohol may be obtained by saponifying (hydrolyzing) an ethylene-vinyl ester copolymer obtained by copolymerizing ethylene and a vinyl ester (vinyl ester monomer) and converting a vinyl ester unit into a vinyl alcohol unit, or may be a commercially available product. Examples of the commercially available product include EXCEVAL (registered trademark) RS-4104, RS-2117, RS-1117, RS-2817, RS-1113, and HR-3010 (manufactured by Kuraray Co. Ltd.).

In the alkylene-modified polyvinyl alcohol according to the second aspect of the present invention, a known initiator and known polymerization conditions can be used as the initiator and the polymerization conditions to be used for copolymerization of an olefin(ethylene) and a vinyl ester monomer without particular limitation. However, for example, matters described in the third aspect of the present invention can be employed.

In the high refractive index layer of the optical reflective film of the second aspect of the present invention, a content of the binder is preferably 3 to 50% by weight, more preferably 5 to 40% by weight with respect to 100% by weight of the total solid content of the high refractive index layer. When the content of the binder is 5% by weight or more, disorder of the film surface is suppressed and transparency tends to become higher during drying after the high refractive index layer is coated. On the other hand, when the content is 50% by weight or less, a relative content of the inorganic oxide particles is appropriate, and it is easy to increase the difference in the refractive index between the high refractive index layer and the low refractive index layer.

[Polyvinyl Alcohol]

In the optical reflective film of the second aspect of the present invention, the high refractive index layer is only required to include at least one kind of ethylene-modified polyvinyl alcohol. Therefore, the low refractive index layer and/or the high refractive index layer may include a polyvinyl alcohol (an unmodified polyvinyl alcohol or a modified polyvinyl alcohol other than the ethylene-modified polyvinyl alcohol) other than the ethylene-modified polyvinyl alcohol. The low refractive index layer includes, as a binder, preferably one or more kinds of ethylene-modified polyvinyl alcohols or one or more kinds of polyvinyl alcohols other than the ethylene-modified polyvinyl alcohol, more preferably one or more kinds of polyvinyl alcohols other than the ethylene-modified polyvinyl alcohol.

Among the binders used in the low refractive index layer of the optical reflective film of the second aspect of the present invention, a content of the polyvinyl alcohol is preferably 80 to 100% by weight, more preferably 90 to 100% by weight. Among the binders used in the low refractive index layer of the optical reflective film of the second aspect of the present invention, a content of the polyvinyl alcohol other than the ethylene-modified polyvinyl alcohol is preferably 80 to 100% by weight, more preferably 90 to 100% by weight, still more preferably 95 to 100% by weight, most preferably 100% by weight.

In the second aspect of the present invention, the term “polyvinyl alcohol” itself indicates a normal polyvinyl alcohol (unmodified polyvinyl alcohol) obtained by hydrolyzing polyvinyl acetate, and a polyvinyl alcohol resin including a modified polyvinyl alcohol other than the ethylene-modified polyvinyl alcohol and the ethylene-modified polyvinyl alcohol.

The polyvinyl alcohol acts as a binder (binder resin). The polyvinyl alcohol is preferably a water-soluble polyvinyl alcohol (water-soluble binder resin). By using the water-soluble polyvinyl alcohol, a coating liquid of the refractive index layer has excellent liquid stability. As a result, coatability is excellent. Therefore, the water-soluble polyvinyl alcohol is preferable. When there are a plurality of refractive index layers, polyvinyl alcohols used in the respective refractive index layers may be the same as or different from each other.

Here, as described above, the unmodified polyvinyl alcohol may be obtained by hydrolyzing polyvinyl acetate, or may be a commercially available product. Examples of the commercially available product include KURARAYPOVAL PVA series (PVA-235, PVA-420, etc.) (manufactured by Kuraray Co. Ltd.) and J-POVAL J series (manufactured by Japan VAM & POVAL Co., LTD.).

A modified polyvinyl alcohol which has been partially modified may be included. Examples of such a modified polyvinyl alcohol include a cation-modified polyvinyl alcohol, an anion-modified polyvinyl alcohol, and a nonion-modified polyvinyl alcohol.

Among these, the cation-modified polyvinyl alcohol is not particularly limited, but is obtained, for example, by the above-described method exemplified in the first aspect of the present invention.

Examples of the unsaturated ethylene monomer containing a cationic group include trimethyl-(2-acrylamide-2,2-dimethylethyl) ammonium chloride, exemplified in the first aspect of the present invention. A ratio of the monomer containing a cationic modification group in the cation-modified polyvinyl alcohol is 0.1 to 10 mol %, preferably 0.2 to 5 mol % with respect to vinyl acetate.

The anion-modified polyvinyl alcohol is not particularly limited. However, examples thereof include anion-modified polyvinyl alcohols described in the above publications exemplified in the first aspect of the present invention.

The nonion-modified polyvinyl alcohol is not particularly limited. However, examples thereof include the above-described nonion-modified polyvinyl alcohols exemplified in the first aspect of the present invention.

The polyvinyl alcohols may be each used alone, or two or more kinds thereof having different average polymerization degrees or different kinds of modification may be used.

The polymerization degree of the polyvinyl alcohol is not particularly limited, but is preferably 1000 to 5000, more preferably 2000 to 5000. In this range, the coating film has excellent strength, and the coating liquid is stable. Particularly, when the polymerization degree is 2000 or more, a crack is not generated in the coating film, and a haze thereof is excellent. Therefore, the polymerization degree of 2000 or more is preferable. In the second aspect of the present invention, the polymerization degree of the polyvinyl alcohol means a polymerization degree measured in conformity with JIS K6726: 1994.

The saponification degree of the polyvinyl alcohol used in the low refractive index layer of the optical reflective film of the second aspect of the present invention is not particularly limited, but is preferably 80 mol % to 90 mol %. When the low refractive index layer includes a plurality of polyvinyl alcohols, the saponification degree means a saponification degree of the polyvinyl alcohol having the largest content in the low refractive index layer. When a polyvinyl alcohol is referred to as “a polyvinyl alcohol having the largest content in the low refractive index layer”, it is assumed that polyvinyl alcohols having a difference in the saponification degree of less than 2 mol % are the same polyvinyl alcohol, and the saponification degree is calculated. When one layer includes polyvinyl alcohols having the difference in the saponification degree of 2 mol % or more, these polyvinyl alcohols are assumed to be a mixture of different polyvinyl alcohols, and the saponification degree for each polyvinyl alcohol is calculated. When the saponification degree is 80 mol % or more, the optical reflective film has excellent water resistance. On the other hand, when the saponification degree is 90 mol % or less, the difference in the saponification degree from the ethylene-modified polyvinyl alcohol included in the high refractive index layer becomes large. Interlayer mixing between the high refractive index layer and the low refractive index layer is thereby suppressed, and disorder of the interface can be reduced.

In the low refractive index layer of the optical reflective film of the second aspect of the present invention, a content of the binder is preferably 3 to 70% by weight, more preferably 5 to 60% by weight, still more preferably 10 to 50% by weight, particularly preferably 15 to 45% by weight, with respect to the total solid content of the low refractive index layer.

[Curing Agent]

In the second aspect of the present invention, the refractive index layer preferably uses a curing agent. When a polyvinyl alcohol including an ethylene-modified polyvinyl alcohol is used as a binder resin, an effect thereof can be particularly exhibited.

The curing agent which can be used with the polyvinyl alcohol including an ethylene-modified polyvinyl alcohol is not particularly limited as long as the curing agent causes a curing reaction with the polyvinyl alcohol, but is preferably boric acid or a salt thereof. In addition to boric acid and a salt thereof, a known curing agent can be used. In general, a compound containing a group which can react with the polyvinyl alcohol, or a compound which promotes a reaction between different groups contained in the polyvinyl alcohol is appropriately selected to be used. Specific examples of the curing agent include the above-described epoxy-based curing agent exemplified in the first aspect of the present invention.

Boric acid, a borate, and borax containing a boron atom as the curing agent may be each used alone as an aqueous solution, or two or more kinds thereof may be mixed to be used. An aqueous solution of boric acid or a mixed aqueous solution of boric acid and borax is preferable. An aqueous solution of boric acid and an aqueous solution of borax can be each added only as a relatively dilute aqueous solution. However, by mixing the two, a concentrated aqueous solution can be obtained, and the coating liquid can be concentrated. It is possible to relatively freely control the pH of the aqueous solution to be added.

In the second aspect of the present invention, in order to obtain the effect of the second aspect of the present invention, boric acid and a salt thereof and/or borax are preferably used. When boric acid and a salt thereof and/or borax are used, inorganic oxide particles and an OH group of a polyvinyl alcohol form a hydrogen bond network. As a result, it is considered that interlayer mixing between the high refractive index layer and the low refractive index layer is suppressed, and a preferable optical reflection property is achieved. Particularly when a set-type coating process is used, a more preferable effect can be exhibited. In the set-type coating process, a multilayer of the high refractive index layer and the low refractive index layer is coated with a coater, and then, the temperature on the surface of the coating film is temporarily lowered to about 15° C., and then, the film surface is dried.

A total use amount of the curing agent is preferably 10 to 600 mg, more preferably 20 to 500 mg per g of the polyvinyl alcohol (or the ethylene-modified polyvinyl alcohol, or a total amount of the polyvinyl alcohol and the ethylene-modified polyvinyl alcohol when the polyvinyl alcohol and the ethylene-modified polyvinyl alcohol are used together).

[Resin Binder (Other Water-Soluble Polymers)]

In the second aspect of the present invention, each refractive index layer may include another water-soluble polymer.

In the second aspect of the present invention, the binder resin preferably includes a water-soluble binder resin in view of no need to use an organic solvent and environmental protection. That is, in the second aspect of the present invention, within a range not impairing the effect, a water-soluble polymer other than the polyvinyl alcohol resin may be used as a binder resin in addition to the ethylene-modified polyvinyl alcohol or the polyvinyl alcohol. Examples of the other water-soluble polymer include gelatin, a cellulose, a polysaccharide thickener, and a polymer containing a reactive functional group. The water-soluble polymers may be each used alone, or a mixture of two or more kinds thereof may be used.

Hereinafter, the water-soluble polymers will be described.

(Gelatin)

Various gelatins which have been used widely in a silver halide photographic material field in the related art are applicable to the second aspect of the present invention. Examples thereof include an acid-treated gelatin, an alkali-treated gelatin, an enzyme-treated gelatin which is treated with an enzyme in a process of manufacturing gelatin, and a gelatin derivative. That is, a gelatin which contains an amino group, an imino group, a hydroxyl group, or a carboxyl group as a functional group in a molecule thereof, and is treated with a reagent containing a group obtained by reacting therewith to be reformed, may be also applicable. A general method for manufacturing a gelatin is well known. For example, description in T. H. James: The Theory of Photographic Process 4th. ed. 1977 (Macmillan) 55 Section, science photo Handbook (first volume) 72-75 Sections (Maruzen), the basis of photo engineering-the silver halide photography 119-124 (Corona Corporation), can be referred to. In addition, a gelatin described in Research Disclosure Journal Vol. 176, No. 17643 (December 1978) Section IX can be mentioned.

(Film Hardening Agent)

When a gelatin is used, a film hardening agent of gelatin can be added if necessary.

As a usable film hardening agent, a known compound used as a film hardening agent of a usual photographic emulsion layer can be used. Examples thereof include an organic film hardening agent such as a vinyl sulfone compound, a urea-formalin condensate, a melanin-formalin condensate, an epoxy compound, an aziridine compound, an active olefin, or an isocyanate compound, and inorganic polyvalent metal salt such as chromium, aluminum, or zirconium.

(Cellulose)

As a cellulose which can be used in the second aspect of the present invention, a water-soluble cellulose derivative can be preferably used. Examples thereof include a water-soluble cellulose derivative such as carboxymethyl cellulose (cellulose carboxymethyl ether), methyl cellulose, hydroxymethyl cellulose, hydroxyethyl cellulose, or hydroxypropyl cellulose, and a carboxylic acid group-containing cellulose such as carboxymethyl cellulose (cellulose carboxymethyl ether) or carboxyethyl cellulose.

(Polysaccharide Thickener)

A polysaccharide thickener which can be used in the second aspect of the present invention is not particularly limited. Examples thereof include a generally known natural simple polysaccharide, natural complex polysaccharide, synthetic simple polysaccharide and synthetic complex polysaccharide. For details of the polysaccharides, “Biochemistry Encyclopedia (2nd Edition), Tokyo Kagaku Dojin Publishing”, “Food Industry” Vol. 31 (1988) 21 pp., and the like can be referred to.

The polysaccharide thickener in the second aspect of the present invention is a polymer of a saccharide and contains many hydrogen bond groups in a molecule thereof. The polysaccharide thickener in the second aspect of the present invention has a large difference in viscosity between at a low temperature and at a high temperature due to a change of a hydrogen bonding force between molecules depending on the temperature. More preferably, when inorganic oxide particles are added, the viscosity is increased probably due to the hydrogen bond with the inorganic oxide particles at a low temperature. Increase in the viscosity of the polysaccharide at 15° C. by adding the inorganic oxide particles is preferably 1.0 mPa·s or more, more preferably 5.0 mPa·s or more, still more preferably 10.0 mPa·s or more.

Examples of the polysaccharide thickener applicable to the second aspect of the present invention include a natural polymeric polysaccharide derived from red algae, such as a galactan (agarose, agaropectin, etc.), a galactomannoglycan (locust bean gum, guaran, etc.), a xyloglucan (tamarind gum, etc.), a glucomannoglycan (konjac mannan, wood-derived glucomannan, xanthan gum, etc.), a galacto glucomannoglycan (softwood-derived glycan, etc.), an arabino galactoglycan (soybean-derived glycan, microorganisms-derived glycan, etc.), a glucorhamno glycan (gellan gum, etc.), a glycosaminoglycan (hyaluronic acid, keratan sulfate, etc.), alginic acid and an alginate, agar, κ-carrageenan, λ-carrageenan, ι-carrageenan, or furcellaran. In view of not lowering dispersion stability of the inorganic oxide particles coexisting in the coating liquid, a polysaccharide the structural unit of which does not contain a carboxylic acid group or a sulfonic acid group is preferable. Examples of such a polysaccharide include a polysaccharide only containing a pentose such as L-arabitose, D-ribose, 2-deoxyribose, or D-xylose, and a hexose such as D-glucose, D-fructose, D-mannose, or D-galactose. Specific preferable examples thereof include tamarind seed gum known as xyloglucan, having a glucose as a main chain and a glucose as a side chain, a guar gum known as galactomannan, having a mannose as a main chain and a glucose as a side chain, cationized guar gum, hydroxypropyl guar gum, locust bean gum, tara gum, and arabinogalactan having a galactose as a main chain and an arabinose as a side. In the second aspect of the present invention, tamarind, guar gum, cationized guar gum, and hydroxypropyl guar gum are particularly preferable. Two or more kinds of polysaccharide thickeners may be used in combination.

(Polymer Containing Reactive Functional Group)

Examples of the water-soluble polymer applicable to the second aspect of the present invention include a polymer containing a reactive functional group. Examples thereof include a polyvinyl pyrrolidone, an acrylic resin (polyacrylic acid, an acrylic acid-acrylonitrile copolymer, a potassium acrylate-acrylonitrile copolymer, a vinyl acetate-acrylate copolymer, an acrylic acid-acrylate copolymer, etc.), a styrene-acrylic acid resin (a styrene-acrylic acid copolymer, a styrene-methacrylic acid copolymer, a styrene-methacrylic acid-acrylate copolymer, a styrene-α-methyl styrene-acrylic acid copolymer, a styrene-α-methyl styrene-acrylic acid-acrylate copolymer, etc.), a styrene-sodium styrene sulfonate copolymer, a styrene-2-hydroxyethyl acrylate copolymer, a styrene-2-hydroxyethyl acrylate-potassium styrene sulfonate copolymer, a styrene-maleic acid copolymer, a styrene-maleic anhydride copolymer, a vinyl naphthalene-acrylic acid copolymer, a vinyl naphthalene-maleic acid copolymer, a vinyl acetate copolymer (a vinyl acetate-maleate copolymer, a vinyl acetate-crotonic acid copolymer, a vinyl acetate-acrylic acid copolymer, etc.), and a salt thereof.

[Inorganic Oxide Particles Used in High Refractive Index Layer]

In the second aspect of the present invention, in order to form a transparent high refractive index layer having a higher refractive index, the high refractive index layer includes titanium oxide particles as inorganic oxide particles. Among metal oxides, a hydroxyl group on the surface of the titanium oxide particles strongly interacts with a hydroxyl group of the structural unit derived from a vinyl alcohol in the ethylene-modified polyvinyl alcohol. Therefore, an optical reflective film which suppresses occurrence of curling and has excellent folding resistance can be obtained. The high refractive index layer particularly preferably includes rutile type (tetragonal) titanium oxide particles due to exhibition of a high refractive index. The size of the inorganic oxide particle used in the high refractive index layer is not particularly limited. However, a volume average particle diameter thereof is preferably 1 to 100 nm or less, more preferably 3 to 50 nm.

Among the inorganic oxide particles used in the high refractive index layer, a content of the titanium oxide particles is preferably 80 to 100% by weight, more preferably 90 to 100% by weight, still more preferably 95 to 100% by weight, most preferably 100% by weight. Examples of inorganic oxide particles other than titanium oxide include zirconia, tin oxide, zinc oxide, alumina, colloidal alumina, niobium oxide, europium oxide, and zircon.

Titanium oxide particles capable of being dispersed in an organic solvent or the like, obtained by modifying the surface of an aqueous titanium oxide sol, are preferably used.

As a method for preparing the aqueous titanium oxide sol, any method known in the related art can be used. For example, the description in the above publications exemplified in the first aspect of the present invention can be referred to.

As for other methods for manufacturing the titanium oxide particles, for example, the methods described in the above publications exemplified in the first aspect of the present invention can be referred to.

As for other methods for manufacturing the inorganic oxide particles including the titanium oxide particles, the above description exemplified in the first aspect of the present invention can be referred to.

In addition, a form of core shell particles is preferable. In the form of core shell particles, the titanium oxide particles are coated with a silicon-containing hydrous oxide. Here, “coated” means a state in which the silicon-containing hydrous oxide adheres to at least a part of the surface of the titanium oxide particles. In the second aspect of the present invention, the coated titanium oxide is also referred to as “silica adhesion titanium dioxide.” That is, the surface of the titanium oxide particles used as inorganic oxide particles (metal oxide particles) may be completely coated with the silicon-containing hydrous oxide, or a part of the surface of the titanium oxide particles may be coated with the silicon-containing hydrous oxide. A part of the surface of the titanium oxide particles is preferably coated with the silicon-containing hydrous oxide from such a viewpoint that the refractive index of the coated titanium oxide particles is controlled by a coating amount of the silicon-containing hydrous oxide.

The titanium oxide of the titanium oxide particles coated with the silicon-containing hydrous oxide may be a rutile type or an anatase type. The titanium oxide particles coated with the silicon-containing hydrous oxide are preferably rutile type titanium oxide particles coated with the silicon-containing hydrous oxide. This is because the rutile type titanium oxide particles have a lower photocatalytic activity than the anatase type titanium oxide particles, and therefore, the high refractive index layer and the low refractive index layer adjacent thereto have higher weather resistance and higher refractive indices. In the second aspect of the present invention, “silicon-containing hydrous oxide” may be any one of a hydrate of an inorganic silicon compound and a hydrolyzate and/or a condensate of an organic silicon compound, but more preferably contains a silanol group in order to obtain the effect of the second aspect of the present invention. Therefore, in the second aspect of the present invention, the inorganic oxide particles of the high refractive index layer are preferably silica-modified (silanol-modified) titanium oxide particles in which the titanium oxide particles are silica-modified.

A coating amount of the silicon-containing hydrous oxide is 3 to 30% by weight, preferably 3 to 20% by weight, more preferably 3 to 10% by weight with respect to titanium oxide as a core. The reasons are as follows. When the coating amount is 30% by weight or less, a desired refractive index of the high refractive index layer is obtained. When the coating amount is 3% by weight or more, particles can be formed stably.

As a method for coating the titanium oxide particles with the silicon-containing hydrous oxide, a method known in the related art can be used. For example, the above description exemplified in the first aspect of the present invention can be referred to.

In the core shell particles according to the second aspect of the present invention, the entire surface of the titanium oxide particles as a core may be coated with a silicon-containing hydrous oxide, or a part of the surface of the titanium oxide particles as a core may be coated with the silicon-containing hydrous oxide.

The inorganic oxide particles used in the high refractive index layer can be determined by a volume average particle diameter or a primary average particle diameter. The volume average particle diameter of the inorganic oxide particles used in the high refractive index layer is preferably 30 nm or less, more preferably 1 to 30 nm, still more preferably 5 to 15 nm. The primary average particle diameter of the inorganic oxide particles used for the inorganic oxide particles used in the high refractive index layer is preferably 30 nm or less, more preferably 1 to 30 nm, still more preferably 5 to 15 nm. Inorganic oxide particles having a primary average particle diameter of 1 nm or more and 30 nm or less are preferable in view of a low haze and an excellent visible light transmittance. Inorganic oxide particles having a volume average particle diameter or a primary average particle diameter of 30 nm or less are preferable in view of a low haze and an excellent visible light transmittance. By containing core shell particles as the inorganic oxide particles of the high refractive index layer, interlayer mixing between the high refractive index layer and the low refractive index layer is suppressed due to an interaction between the silicon-containing hydrous oxide in the shell layer and the polyvinyl alcohol. Here, in a case of the titanium oxide particles coated with the silicon-containing hydrous oxide, the volume average particle diameter and the primary average particle diameter indicate a volume average particle diameter and a primary average particle diameter of titanium oxide particles (not coated with the silicon-containing hydrous oxide), respectively. A method for calculating the volume average particle diameter in the second aspect of the present invention is similar to that in the first aspect of the present invention.

Furthermore, the inorganic oxide particles used in the second aspect of the present invention are preferably monodispersed. Here, monodipersion means that a monodispersion degree is 40% or less. The monodispersion degree is determined by the above-described formula in the first aspect of the present invention. The monodispersion degree is more preferably 30% or less, particularly preferably 0.1 to 20%.

In the second aspect of the present invention, a content of the inorganic oxide particles in the high refractive index layer is 40 to 60% by volume with respect to the total solid content of the high refractive index layer. When the content of the inorganic oxide particles is less than 40% by volume, it is difficult to obtain a sufficient difference in the refractive index from the low refractive index layer. On the other hand, when the content of the inorganic oxide particles is more than 60% by volume, curling of the film easily occurs, and the film is easily peeled off from the substrate or broken when being folded. The content of the inorganic oxide particles in the high refractive index layer is preferably 45 to 55% by volume with respect to the total solid content of the high refractive index layer.

[Inorganic Oxide in Low Refractive Index Layer]

The low refractive index layer of the optical reflective film of the second aspect of the present invention preferably includes inorganic oxide particles.

In the low refractive index layer, silica (silicon dioxide) is preferably used as inorganic oxide particles. Specific examples thereof include synthetic amorphous silica, colloidal silica, zinc oxide, alumina, and colloidal alumina. Among these, a colloidal silica sol, particularly an acidic colloidal silica sol is more preferably used, and colloidal silica dispersed in an organic solvent is particularly preferably used. In order to further reduce the refractive index, hollow fine particles having pores inside the particles may be used as the inorganic oxide particles in the low refractive index layer. Hollow fine particles of silica (silicon dioxide) are particularly preferably used. Known inorganic oxide particles other than silica can be also used. In order to adjust the refractive index, one kind of the inorganic oxide particles may be used, or two or more kinds thereof may be used together for the low refractive index layer.

The inorganic oxide particles (preferably silicon dioxide) included in the low refractive index layer preferably have an average particle diameter (number average; diameter) of 3 to 100 nm. The average particle diameter of primary particles of silicon dioxide dispersed in a state of primary particles (particle diameter in a state of a dispersion liquid before coating) is more preferably 3 to 50 nm, still more preferably 1 to 40 nm, particularly preferably 3 to 20 nm, most preferably 4 to 10 nm. The average particle diameter of secondary particles is preferably 30 nm or less in view of a low haze and excellent visible light transmittance.

In the second aspect of the present invention, the primary average particle diameter can be measured from an electron micrograph by a transmission electron microscope (TEM) or the like. The primary average particle diameter may be measured by a particle size distribution analyzer or the like using a dynamic light scattering method or a static light scattering method.

When being determined using the transmission electron microscope, the primary average particle diameter of the particles is similar to that in the first aspect of the present invention.

The particle diameter of the inorganic oxide particles in the low refractive index layer can be determined by a volume average particle diameter in addition to the primary average particle diameter.

The colloidal silica used in the second aspect of the present invention is obtained by heat aging a silica sol obtained by methathesis with an acid of sodium silicate or the like, or transmission through an ion-exchange resin layer. Examples thereof include colloidal silica described in the above literatures exemplified in the first aspect of the present invention.

Such a colloidal silica may be a synthetic product or a commercially available product. Examples of the commercially available product include Snowtex series available from Nissan Chemical Industries, Ltd. (Snowtex OS, OXS, S, OS, 20, 30, 40, O, N, C, etc.).

The surface of the colloidal silica may be cation-modified, or may be treated with Al, Ca, Mg, Ba, or the like.

As the inorganic oxide particles in the low refractive index layer, hollow particles can be used. When hollow fine particles are used, the description about the hollow particles in the first aspect of the present invention is referred to.

A content of the inorganic oxide particles in the low refractive index layer is preferably 40 to 60% by volume, more preferably 40 to 50% by volume with respect to the total solid content of the low refractive index layer. When the content is 40% by volume or more, a desired refractive index is obtained. When the content is 60% by volume or less, an optical reflective film which suppresses occurrence of curling and has excellent folding resistance can be obtained. Therefore, the content of 40% by volume or more and 60% by volume or less is preferable.

The inorganic oxide particles in the low refractive index layer are only required to be included in at least one layer of the plurality of low refractive index layers.

[Other Additives]

The high refractive index layer or the low refractive index layer of the optical reflective film of the second aspect of the present invention may include known additives, for example, described in the above literatures exemplified in the first aspect of the present invention. Examples thereof include an ultraviolet absorber, an anti-fading agent, an anionic, cationic, or nonionic surfactant, a fluorescent whitening agent, a pH adjusting agent such as sulfuric acid, phosphoric acid, acetic acid, citric acid, sodium hydroxide, potassium hydroxide, or potassium carbonate, an antifoaming agent, a lubricant such as diethylene glycol, a preservative, an anti-static agent, and a matting agent.

[Method for Manufacturing Optical Reflective Film]

A method for manufacturing the optical reflective film of the second aspect of the present invention is not particularly limited. Any method can be used, as long as at least one unit including a high refractive index layer and a low refractive index layer can be formed on a substrate.

In the method for manufacturing the optical reflective film of the second aspect of the present invention, a unit including a high refractive index layer and a low refractive index layer is laminated to form an optical reflective film.

Specifically, a high refractive index layer and a low refractive index layer are preferably alternately coated and dried to form a laminated body. Specific examples of the embodiment include: (1) a method for manufacturing an optical reflective film, in which a high refractive index layer coating liquid is coated on a substrate and dried to form a high refractive index layer, and then a low refractive index layer coating liquid is coated and dried to forma low refractive index layer; (2) a method for manufacturing an optical reflective film, in which a low refractive index layer coating liquid is coated on a substrate and dried to form a low refractive index layer, and then a high refractive index layer coating liquid is coated and dried to form a high refractive index layer; (3) a method for manufacturing an optical reflective film including a high refractive index layer and a low refractive index layer, in which a high refractive index layer coating liquid and a low refractive index layer coating liquid are alternately and sequentially coated on a substrate in a form of a multilayer and then dried; and (4) a method for manufacturing an optical reflective film including a high refractive index layer and a low refractive index layer, in which a high refractive index layer coating liquid and a low refractive index layer coating liquid are simultaneously coated on a substrate in a form of a multilayer and dried. Among these, the above method (4) which is a simpler manufacturing method, is preferable. That is, the method for manufacturing the optical reflective film of the second aspect of the present invention preferably includes laminating the high refractive index layer and the low refractive index layer by a simultaneous multilayer coating method.

When the simultaneous multilayer coating is performed, the layers are laminated in a state of undried liquid. Therefore, interlayer mixing or the like more easily occurs. However, it is known that particularly when the saponification degree of the ethylene-modified polyvinyl alcohol included in the high refractive index layer is different from that of the polyvinyl alcohol included in the low refractive index layer, compatibility between polyvinyl alcohols having different saponification degrees is low. Therefore, at the time of laminating the high refractive index layer and the low refractive index layer in a state of undried liquid, even when the layers are mixed with each other a little, water as a solvent is volatilized and concentrated in a drying process. The polyvinyl alcohol resins having different saponification degrees thereby cause a phase separation. A force to minimize an area of the interface of each layer works. Therefore, interphase mixing is suppressed, and disorder of the interface is reduced. Therefore, an optical reflective film having a low haze can be obtained.

High water resistance can be imparted to a coating film by using the ethylene-modified polyvinyl alcohol as a binder. Therefore, particularly when an optical reflective film is manufactured by aqueous simultaneous multilayer coating, the second aspect of the present invention can exhibit a remarkable effect. In the simultaneous multilayer coating, a plurality of coating liquids are laminated on a coater, coated on a substrate, and dried. Therefore, coating time is short, and defects on a coating surface are less than in sequential coating in which each layer is coated and dried. The simultaneous multilayer coating is excellent. By an application of the second aspect of the present invention, an optical reflective film having excellent performance and external appearance can be manufactured with high productivity.

Preferable examples of a coating method include the above roll coating method exemplified in the first aspect of the present invention.

A solvent for preparing the high refractive index layer coating liquid and the low refractive index layer coating liquid is not particularly limited. However, water, an organic solvent, or a mixture thereof is preferable. In the second aspect of the present invention, an aqueous solvent can be used because an ethylene-modified polyvinyl alcohol/polyvinyl alcohol is mainly used as a binder. The aqueous solvent does not require large-scaled manufacturing facilities unlike in a case of using an organic solvent. Therefore, the aqueous solvent is preferable in view of productivity and environmental protection.

Examples of the organic solvent include the above methanol exemplified in the first aspect of the present invention. The organic solvents may be each used alone, or a mixture of two or more kinds thereof may be used. The aqueous solvent is preferable as a solvent of the coating liquid in view of environment, easiness of the operation, and the like. Water or a mixed solvent of water and methanol, water and ethanol, or water and ethyl acetate is more preferable. Water is particularly preferable.

When a mixed solvent of water and a small amount of organic solvent is used, a content of water in the mixed solvent is preferably 80 to 99.9% by weight, more preferably 90 to 99.5% by weight with respect to 100% by weight of the total content of the mixed solvent. Here, the reasons are as follows. That is, the content of 80% by weight or more makes it possible to reduce fluctuation in volume due to volatilization of the solvent, and improves handling. The content of 99.9% by weight or less increases homogeneity during liquid addition, and makes it possible to obtain stable liquid physical properties.

A concentration of the binder in the high refractive index layer coating liquid is preferably 0.5 to 10% by weight. A concentration of the inorganic oxide particles in the high refractive index layer coating liquid is preferably 1 to 50% by weight.

A concentration of the binder in the low refractive index layer coating liquid is preferably 0.5 to 10% by weight. A concentration of the inorganic oxide particles in the low refractive index layer coating liquid is preferably 1 to 50% by weight.

A method for manufacturing the high refractive index layer coating liquid or the low refractive index layer coating liquid is not particularly limited. For example, inorganic oxide particles, a polyvinyl alcohol (polyvinyl alcohol resin), a chelate compound having a higher refractive index than the polyvinyl alcohol, an acylate compound, a salt thereof, and another additive to be added if necessary, are added, and stirred and mixed. At this time, the order of adding the components is not particularly limited. The components may be sequentially added and mixed while being stirred, or may be simultaneously added and mixed while being stirred.

In the second aspect of the present invention, when the simultaneous multilayer coating is performed, the saponification degree of the polyvinyl alcohol (polyvinyl alcohol resin) in the high refractive index layer coating liquid is preferably different from that in the low refractive index layer coating liquid. Here, the saponification degree means a ratio of a hydroxyl group with respect to the total number of the hydroxyl group and a carbonyloxy group such as an acetyloxy group (derived from vinyl acetate as a raw material) in the polyvinyl alcohol, and is common to the ethylene-modified polyvinyl alcohol and other polyvinyl alcohols. The difference in the saponification degree makes it possible to suppress mixing of the layers in each step of coating and drying. This mechanism has not been elucidated yet, but is estimated to be as follows. That is, mixing is suppressed due to a difference in surface tension derived from the difference in the saponification degree. Furthermore, increase in the polymerization degree further enhances this function. This mechanism has not been elucidated yet, but is estimated to be as follows. That is, the increase in the polymerization degree decreases the number of molecules in a unit volume, suppresses physical mixing, emphasizes a difference in a solubility parameter, and suppresses mixing of the binders. The difference in the solubility parameter is made because of a difference in a ratio of a carbonyloxy group such as an acetyloxy group, which is a hydrophobic group.

In the second aspect of the present invention, the difference in the saponification degree of the polyvinyl alcohol (polyvinyl alcohol resin) between the high refractive index layer coating liquid and the low refractive index layer coating liquid is preferably 3 mol % or more, more preferably 8 mol % or more. That is, the difference between the saponification degree of the ethylene-modified polyvinyl alcohol included in the high refractive index layer and that of the polyvinyl alcohol included in the low refractive index layer is preferably 3 mol % or more, more preferably 8 mol % or more. An upper limit of the difference between the saponification degree of the ethylene-modified polyvinyl alcohol in the high refractive index layer and that of the polyvinyl alcohol in the low refractive index layer is preferably higher in view of suppressing/preventing interlayer mixing between the high refractive index layer and the low refractive index layer, and is not particularly limited, but is preferably 15 mol % or less, more preferably 10 mol % or less.

When each refractive index layer includes a plurality of polyvinyl alcohols (having different saponification degrees and polymerization degrees), the polyvinyl alcohol for which the difference in the saponification degree is compared in each refractive index layer is a polyvinyl alcohol having the largest content in the refractive index layer. Here, when a polyvinyl alcohol is referred to as “a polyvinyl alcohol having the largest content in the refractive index layer”, it is assumed that polyvinyl alcohols having the difference in the saponification degree of less than 2 mol % are the same polyvinyl alcohol, and the saponification degree or the polymerization degree is calculated. A specific method therefor is similar to the description in the first embodiment of the present invention.

When one layer includes polyvinyl alcohols having the difference in the saponification degree of 2 mol % or more, these polyvinyl alcohols are assumed to be a mixture of different polyvinyl alcohols, and the polymerization degree and the saponification degree for each polyvinyl alcohol are calculated as described in the first embodiment of the present invention.

When the simultaneous multilayer coating is performed using a slide bead coating method, the temperature of the high refractive index layer coating liquid or the low refractive index layer coating liquid is preferably 25 to 60° C., more preferably 30 to 45° C. When a curtain coating method is used, the temperature is preferably 25 to 60° C., more preferably 30 to 45° C.

When the simultaneous multilayer coating is performed, the viscosity of the high refractive index layer coating liquid or the low refractive index layer coating liquid is not particularly limited. However, when the slide bead coating method is used, the viscosity is preferably 5 to 160 mPa·s, more preferably 60 to 140 mPa·s in the above-described preferable temperature range of the coating liquid. When the curtain coating method is used, the viscosity is preferably 5 to 1200 mPa·s, more preferably 25 to 500 mPa·s in the above-described preferable temperature range of the coating liquid. Within such a range of the viscosity, it is possible to perform the simultaneous multilayer coating efficiently.

The viscosity of the coating liquid at 15° C. is preferably 100 mPa·s or more, more preferably 100 to 30000 mPa·s, still more preferably 2500 to 30000 mPa·s.

Conditions for coating and drying methods are not particularly limited. However, for example, in a sequential coating method, first, one of the high refractive index layer coating liquid and the low refractive index layer coating liquid heated to 30 to 60° C. is coated on a substrate and dried to form a layer. Thereafter, the other coating liquid is coated on the layer and dried to form a laminated film precursor (unit). Subsequently, the number of the units necessary for exhibiting desired shielding performance are sequentially coated, dried, and laminated by the above-described method to obtain a laminated film precursor. When being dried, the formed coating film is preferably dried at 30° C. or higher. For example, the coating film is preferably dried at a wet bulb temperature of 5 to 50° C. and at a film surface temperature of 5 to 100° C. (preferably 10 to 50° C.). For example, warm air at 40 to 60° C. is blown for 1 to 5 seconds for drying. As the drying method, warm air drying, infrared drying, or microwave drying is used. Drying in a multi stage process is more preferable than drying in a single process. The temperature of a constant rate drying section is preferably lower than that of a falling rate drying section. In this case, the temperature range of the constant rate drying section is preferably 30 to 60° C., and the temperature range of the falling rate drying section is preferably 50 to 100° C.

Conditions for coating and drying methods in the simultaneous multilayer coating are as follows. That is, the high refractive index layer coating liquid and the low refractive index layer coating liquid are heated to 30 to 60° C., and the simultaneous multilayer coating of the high refractive index layer coating liquid and the low refractive index layer coating liquid is performed on a substrate. Thereafter, the temperature of the formed coating film is temporarily lowered preferably to 1 to 15° C. (setting), and then the coating film is preferably dried at 10° C. or higher. More preferable conditions for drying are the wet bulb temperature of 5 to 50° C. and the film surface temperature of 10 to 50° C. For example, drying is performed by blowing warm air at 40 to 80° C. for 1 to 5 seconds. As a cooling method immediately after coating, a horizontal setting method is preferably used in view of improving the uniformity of the formed coating film. Here, the meaning of the setting and the definition of completion of the setting are similar to those in the first aspect of the present invention.

A period of time (setting time) from the time of coating to the time when setting is completed by blowing cool air, is preferably 5 minutes or less, more preferably 2 minutes or less. A lower limit of the time is not particularly limited, but is preferably 45 seconds or more. When the setting time is too short, mixing of the components in the layer may be insufficient. On the other hand, when the setting time is too long, interlayer diffusion of the inorganic oxide particles proceeds, and the difference in the refractive index between the high refractive index layer and the low refractive index layer may be insufficient. If elasticity of an intermediate layer between the high refractive index layer and the low refractive index layer becomes higher quickly, it is not necessary to provide the setting step.

The setting time can be adjusted by adjusting a concentration of the polyvinyl alcohol or the inorganic oxide particles, or by adding other components, for example, a known gelling agent such as gelatin, pectin, agar, carrageenan, or gellan gum.

The temperature of the cool air is preferably 0 to 25° C., more preferably 5 to 10° C. The time during which the coating film is exposed to the cool air depends on a conveying speed of the coating film, but is preferably 10 to 360 seconds, more preferably 10 to 300 seconds, still more preferably 10 to 120 seconds.

Coating should be performed such that the coating thickness of the high refractive index layer coating liquid or the low refractive index layer coating liquid is the above-described preferable thickness when being dried.

[Substrate]

As a substrate of the optical reflective film, various resin films can be used. Examples thereof include the resin films exemplified in the first embodiment of the present invention, such as a polyester film (polyethylene terephthalate (PET), polyethylene naphthalate, etc.). A preferable example thereof is a polyester film. The polyester film (hereinafter, referred to as polyester) is not particularly limited, but is preferably a polyester including a dicarboxylic acid component and a diol component as main components and having a film-forming property.

Examples of the dicarboxylic acid component as a main component include the above-described terephthalic acid exemplified in the first aspect of the present invention. Among the polyesters including these compounds as main components, a polyester mainly including terephthalic acid or 2,6-naphthalene dicarboxylic acid as the dicarboxylic acid component, and ethylene glycol or 1,4-cyclohexane dimethanol as the diol component, is preferable in view of transparency, mechanical strength, dimensional stability, or the like. Among these, a polyester mainly including polyethylene terephthalate or polyethylene naphthalate, a copolyester including terephthalic acid, 2,6-naphthalene dicarboxylic acid, and ethylene glycol, and a polyester mainly including a mixture of two or more kinds of these polyesters are preferable.

The thickness of the substrate used in the second aspect of the present invention is preferably 10 to 300 μm, particularly preferably 20 to 150 μm. Two sheets of the substrate may be laminated. In this case, the kinds thereof may be the same as or different from each other.

The transmittance of the substrate in a visible light region indicated by JIS R3106-1998 is preferably 85% or more, particularly preferably 90% or more. The substrate having a transmittance of the above-described value or more is advantageous in view of obtaining a transmittance in a visible light region indicated by JIS R3106-1998 of 50% or more (upper limit: 100%) when an infrared shielding film is formed, and is preferable.

The substrate using the above-described resin or the like may be an undrawn film or a drawn film. The drawn film is preferable in view of improving strength and suppressing thermal expansion.

The substrate can be manufactured by a general method known in the related art. For example, it is possible to manufacture an undrawn substrate which is substantially amorphous and is not oriented, by melting a resin as a material with an extruder, extruding the resin using a circular die or a T die, and cooling the resin rapidly. It is possible to manufacture a drawn substrate by drawing the undrawn substrate in a flow direction (longitudinal direction) of the substrate or a direction perpendicular to the flow direction of the substrate (transverse direction) by a known method such as uniaxial drawing, tenter-type sequential biaxial drawing, tenter-type simultaneous biaxial drawing, or tubular type simultaneous biaxial drawing. In this case, the draw ratio can be appropriately selected according to the resin as a raw material of the substrate, but is preferably 2 to 10 times in each of the longitudinal direction and the transverse direction.

The substrate may be subjected to a relaxation treatment or an off-line heat treatment in view of dimensional stability. The relaxation treatment is preferably performed after thermal fixation in a drawing and film-forming step of the polyester film, in a tenter of the transverse drawing or in a step after the polyester film leaves the tenter and before the polyester film is wound. The relaxation treatment is performed preferably at a treatment temperature of 80 to 200° C., more preferably at a treatment temperature of 100 to 180° C. The relaxation treatment is performed preferably at a relaxation ratio of 0.1 to 10%, more preferably at a relaxation ratio of 2 to 6% in each of the longitudinal direction and the transverse direction. The substrate subjected to the relaxation treatment has improved heat resistance and excellent dimensional stability by being subjected to the following off-line heat treatment.

An undercoating layer coating liquid is preferably coated on one surface or both surfaces of the substrate in-line in a film forming step. Undercoating in the film forming step is referred to as in-line undercoating. Examples of the resin used for the undercoating layer coating liquid include the above-described polyester resin exemplified in the first aspect of the present invention. Any of these resins can be preferably used. An additive known in the related art can be added to the undercoating layer. The undercoating layer can be coated by a known method such as roll coating, gravure coating, knife coating, dip coating, or spray coating. A coating amount of the undercoating layer is preferably about 0.01 to 2 g/m² (dry state).

[Film Design]

The optical reflective film of the second aspect of the present invention includes at least one unit in which a high refractive index layer and a low refractive index layer are laminated. The optical reflective film preferably includes a multilayer optical interference film formed by alternately laminating the high refractive index layer and the low refractive index layer on one surface or both surfaces of the substrate. In view of productivity, a preferable range of the total number of the high refractive index layers and the low refractive index layers per surface of the substrate is 100 or less, more preferably 45 or less. A lower limit of the preferable range of the total number of the high refractive index layers and the low refractive index layers per surface of the substrate is not particularly limited, but is preferably 5 or more. The preferable range of the total number of the high refractive index layer and the low refractive index layer is applicable when laminating is performed only on one surface of the substrate, and is applicable when laminating is performed simultaneously on both surfaces of the substrate. When laminating is performed on both surfaces of the substrate, the total number of the high refractive index layer and the low refractive index layer on one surface of the substrate may be the same as or different from that on the other surface. In the optical reflective film of the second aspect of the present invention, each of the bottom layer (layer in contact with the substrate) and the top surface layer may be the high refractive index layer or the low refractive index layer. However, the optical reflective film of the second aspect of the present invention preferably has a layer structure in which each of the bottom layer and the top surface layer is the low refractive index layer, in view of adhesion of the bottom layer to the substrate, blown resistance of the top surface layer, and excellent coatability and adhesion of a hard coat layer or the like to the top surface layer due to the layer structure in which the low refractive index layer is positioned in each of the bottom layer and the top surface layer.

In general, it is possible to increase a reflectivity with respect to a desired ray of light with a small number of layers by designing an optical reflective film having a large difference in the refractive index between the high refractive index layer and the low refractive index layer. In the second aspect of the present invention, at least a difference in the refractive index between two adjacent layers (high refractive index layer and low refractive index layer) is preferably 0.3 or more, more preferably 0.35 or more, still more preferably 0.4 or more. An upper limit thereof is not particularly limited, but is usually 1.4 or less.

It is possible to calculate the difference in the refractive index and the necessary number of layers using a commercially available optical design software, as described in the first aspect of the present invention.

When the high refractive index layer and the low refractive index layer are alternately laminated in the optical reflective film, the difference in the refractive index between the high refractive index layer and the low refractive index layer is preferably within the above-described preferable range of the difference in the refractive index. However, for example, when the top surface layer is formed as a layer to protect the film, or when the bottom layer is formed as an adhesion improving layer to the substrate, the top surface layer or the bottom layer may have a structure having a difference in the refractive index outside the above-described preferable range.

In the second aspect of the present invention, the terms “high refractive index layer” and “low refractive index layer” are similar to those in the first aspect of the present invention. Therefore, the terms “high refractive index layer” and “low refractive index layer” include any form other than a form in which the refractive index layers have the same refractive index when attention is focused on two adjacent refractive index layers in the refractive index layers included in the optical reflective film.

The larger a ratio of the refractive index is, the higher the reflectivity is, because reflection on an interface between adjacent layers depends on the ratio of the refractive index between the layers. When the film is viewed in a single layer film, by a relation of an optical path difference between a ray of reflected light on the layer surface and a ray of reflected light on the layer bottom, represented by n·d=wavelength/4, control can be performed such that both rays of reflective light are enhanced to each other due to a phase difference, and the reflectivity can be increased. Here, n represents a refractive index, d represents a physical film thickness of a layer, and n·d represents an optical film thickness. By utilizing the optical path difference, reflection can be controlled. By utilizing the relation, the refractive index and the film thickness of each layer are controlled, and reflection of visible light or near infrared light is controlled. That is, the reflectivity in a specific wavelength region can be increased by the refractive index of each layer, the film thickness of each layer, and a method for laminating layers.

The optical reflective film of the second aspect of the present invention can be a visible light reflective film or a near infrared ray reflective film by changing the specific wavelength region to increase the reflectivity. That is, when the specific wavelength region to increase the reflectivity is set to a visible light region, the optical reflective film becomes a visible light reflective film. When the specific wavelength region to increase the reflectivity is set to a near infrared region, the optical reflective film becomes a near infrared ray reflective film. When the specific wavelength region to increase the reflectivity is set to an ultraviolet ray region, the optical reflective film becomes an ultraviolet ray reflective film. When the optical reflective film of the second aspect of the present invention is used for a heat shielding film, the optical reflective film is only required to be a (near) infrared reflective (shielding) film. In the case of the infrared reflective film, a multilayer film in which films having different reflective indices are laminated is formed on a polymer film. The transmittance at 550 nm in a visible light region indicated by JIS R3106-1998 is preferably 50% or more, more preferably 70% or more, still more preferably 75% or more. The transmittance at 1200 nm is preferably 35% or less, more preferably 25% or less, still more preferably 20% or less. It is preferable to design the optical film thickness and the unit so as to have the transmittance within these preferable ranges. A region of the wavelength of 900 nm to 1400 nm preferably includes a region having a reflectivity of more than 50%.

Infrared region of incident spectra of light reaching directly from the sun has a relation to an increase in room temperature. By shielding the light in the infrared region, it is possible to suppress the increase in room temperature. As for an accumulation energy ratio from the shortest wavelength (760 nm) to the longest wavelength of 3200 nm based on a weighting coefficient described in Japanese Industrial Standard JIS R3106-1998, in the accumulation energy from 760 nm to each wavelength when the total energy in the whole infrared region from the wavelength of 760 nm to the longest wavelength of 3200 nm is assumed to be 100, the total energy from 760 to 1300 nm occupies about 75% of the total energy in the whole infrared region. Therefore, it is effective in saving energy by shielding a heat ray to shield light in the wavelength region up to 1300 nm.

The low refractive index layer has a refractive index preferably of 1.10 to 1.60, more preferably of 1.30 to 1.50. The high refractive index layer has a refractive index preferably of 1.80 to 2.50, more preferably of 1.90 to 2.20.

The thickness (thickness after drying) per layer of the refractive index layer is preferably 20 to 1000 nm, more preferably 50 to 500 nm, still more preferably 50 to 350 nm.

The total thickness of the optical reflective film of the second aspect of the present invention is preferably 12 μm to 315 μm, more preferably 15 μm to 200 μm, still more preferably 20 μm to 100 μm.

[Layer Structure of Optical Reflective Film]

The optical reflective film includes at least one unit in which a high refractive index layer and a low refractive index layer are laminated on a substrate. The unit may be formed only on one surface of the substrate, or may be formed on both surfaces thereof. The reflectivity of a specific wavelength can be improved by forming the unit on both surfaces of the substrate.

In order to add additional functions, the optical reflective film may include one or more functional layers under the substrate or on the top surface layer opposite to the substrate. Examples of the functional layer include a conductive layer, an antistatic layer, a gas barrier layer, an easily adhesive layer (adhesive layer), an antifouling layer, a deodorant layer, a drop-flowing layer, an easily slidable layer, a hard coat layer, an abrasion resistant layer, an antireflection layer, an electromagnetic wave shielding layer, an ultraviolet absorbing layer, an infrared absorbing layer, a printing layer, a fluorescent emitting layer, a hologram layer, a peeling layer, a pressure-sensitive adhesive layer, an adhesive layer, an infrared cut layer other than the high refractive index layer and the low refractive index layer (metal layer, liquid crystal layer), a colored layer (visible light absorbing layer), and an intermediate film layer to be used for laminated glass.

The order of laminating the above-described various functional layers in the optical reflective film is not particularly limited.

For example, when the optical reflective film is stuck to an interior side of window glass (inner sticking), a preferable example is as follows. That is, an optical reflective layer including at least one unit in which a high refractive index layer and a low refractive index layer are laminated, and a pressure-sensitive adhesive layer are laminated on a surface of a substrate in this order, and a hard coat layer is coated on the opposite surface of the substrate to the surface on which these layers are laminated. The order may be the pressure-sensitive adhesive layer, the substrate, the optical reflective layer, and the hard coat layer. Another functional layer, another substrate, an infrared absorber, or the like may be included. When the optical reflective film of the second aspect of the present invention is stuck to an exterior side of window glass (outer sticking), a preferable example is as follows. That is, the optical reflective layer and the pressure-sensitive adhesive layer are laminated on a surface of the substrate in this order, and the hard coat layer is coated on the opposite surface of the substrate to the surface on which these layers are laminated. As in the inner sticking, the order may be the pressure-sensitive adhesive layer, the substrate, the optical reflective layer, and the hard coat layer, and another functional layer substrate, an infrared absorber, or the like may be included.

[Application of Optical Reflective Film: Optical Reflector]

The optical reflective film of the second aspect of the present invention can be applied to a wide range of fields. That is, a preferable embodiment of the second aspect of the present invention is an optical reflector in which the optical reflective film is provided on at least one surface of a base. For example, the optical reflective film is used mainly in order to increase weather resistance as a film to be stuck to window, a film for an agricultural greenhouse, or the like. Examples of the film to be stuck to window include a heat ray reflecting film which is stuck to an apparatus (base) exposed to the sunlight for a long time, such as outdoor window of a building or car window, to impart a heat ray reflecting effect. Particularly, the optical reflective film is suitable for a member in which the optical reflective film according to the second aspect of the present invention is stuck to a base such as glass or a glass alternative resin directly or through an adhesive.

Specific examples of the base include the above-described glass exemplified in the first aspect of the present invention. The kind of the resin may be any of a thermoplastic resin, a thermosetting resin, and an ionizing radiation curable resin. Two or more kinds thereof may be used in combination. The base can be manufactured by a known method such as extrusion molding, calender molding, injection molding, hollow molding, or compression molding. The thickness of the base is not particularly limited, but is usually 0.1 mm to 5 cm.

An adhesive layer or a pressure-sensitive adhesive layer to stick the optical reflective film and the base together is preferably disposed such that the optical reflective film is disposed on a side of an incident surface of the sunlight (heat ray). When the optical reflective film is sandwiched between window glass and the base, the optical reflective film can be sealed from surrounding gas such as moisture, has excellent durability, and is preferable. Even when the optical reflective film according to the second aspect of the present invention is disposed outdoors or outside a car (for outer sticking), the optical reflective film has environmental durability, and is preferable.

An adhesive layer or a pressure-sensitive adhesive layer to stick the optical reflective film and the base together is preferably disposed such that the optical reflective film is disposed on a side of an incident surface of the sunlight (heat ray) when the optical reflective film is stuck to window glass or the like. When the optical reflective film is sandwiched between window glass and a substrate, the optical reflective film can be sealed from surrounding gas such as moisture and has preferable durability. Even when the optical reflective film of the second aspect of the present invention is disposed outdoors or outside a car (for outer sticking), the optical reflective film has environmental durability, and is preferable.

As the adhesive applicable to the second aspect of the present invention, an adhesive including a photocurable or thermosetting resin as a main component can be used.

An adhesive having durability to ultraviolet rays is preferable, and an acrylic pressure-sensitive adhesive or a silicone pressure-sensitive adhesive is preferable. The acrylic pressure-sensitive adhesive is more preferable in view of a pressure-sensitive adhesion property and cost. Of a solvent type and emulsion type acrylic pressure-sensitive adhesives, the solvent type acrylic pressure-sensitive adhesive is preferable because of particularly easy control of peel strength. When a solution polymerization polymer is used as the acrylic solvent pressure-sensitive adhesive, a known monomer can be used as the monomer for the polymer.

Furthermore, a polyvinyl butyral resin or an ethylene-vinyl acetate copolymer resin used as an intermediate layer of laminated glass may be used. Specific examples thereof are similar to those exemplified in the first aspect of the present invention. An ultraviolet absorber, an anti-oxidant, an antistatic agent, a heat stabilizer, a lubricant, a filler, a coloring, an adhesion control agent, or the like may be appropriately added and blended to the adhesive layer.

Thermal insulation performance or solar heat shielding performance of the optical reflective film or the optical reflector (infrared shield) can be generally determined by a method in conformity with JIS R 3209 (1998) (multi-layered glass), JIS R 3106 (1998) (method for testing a transmittance, a reflectivity, an emissivity, and a solar heat gain coefficient of plate glass), or JIS R 3107 (1998) (method for calculating thermal resistance of plate glass and a heat transmission coefficient in architecture).

Measurement of a solar transmittance, a solar reflectivity, an emissivity, and a visible light transmittance, calculation of the solar transmittance, the solar reflectivity, a solar absorbance, and a corrected emissivity, and calculation of a thermal insulation property and a solar heat shielding property are similar to those in the first aspect of the present invention.

### Third Aspect of the Present Invention

An object of a third aspect of the present invention is to provide an optical reflective film having excellent interlayer adhesion and external appearance after exposure to high humidity conditions. The object of the third aspect of the present invention is achieved by an optical reflective film which includes at least one unit in which a low refractive index layer and a high refractive index layer are laminated on a substrate, and in which at least one of the low refractive index layer and the high refractive index layer includes two or more kinds of alkylene-modified polyvinyl alcohols and inorganic oxide particles.

In the optical reflective film of the third aspect of the present invention, reduction in interlayer adhesion and the defect in external appearance after exposure to high humidity conditions can be suppressed or prevented. Furthermore, aqueous coating is possible, and therefore, simultaneous multilayer coating having excellent environmental protection at the time of manufacturing and high productivity is applicable.

The optical reflective film of the third aspect of the present invention provides an optical reflective film which includes at least one unit in which a low refractive index layer and a high refractive index layer are laminated on a substrate, and in which at least one of the low refractive index layer and the high refractive index layer includes two or more kinds of alkylene-modified polyvinyl alcohols and inorganic oxide particles. The present invention is characterized in that the high refractive index layer and/or the low refractive index layer (in the third aspect of the present invention, also collectively referred to as “refractive index layer”) include/includes two or more kinds of alkylene-modified polyvinyl alcohols described above. By the above-described structure, reduction in interlayer adhesion and the defect in external appearance after exposure of the optical reflective film to high humidity conditions can be suppressed or prevented. The optical reflective film of the third aspect of the present invention is manufactured by coating, drying, and laminating a coating liquid on a substrate. A coating method may be a sequential coating. However, manufacturing using simultaneous multilayer coating is preferable in view of productivity.

A structural unit (alkylene unit) derived from an olefin in the alkylene-modified polyvinyl alcohol according to the third aspect of the present invention is hydrophobic. Therefore, high water resistance can be imparted to a coating film by using the alkylene-modified polyvinyl alcohol according to the third aspect of the present invention. Therefore, particularly when an optical reflective film is manufactured by aqueous simultaneous multilayer coating, the third aspect of the present invention can exhibit a remarkable effect. In the simultaneous multilayer coating, a plurality of coating liquids are laminated on a coater, coated on a substrate, and dried. Therefore, coating time is short, and defects on a coating surface are less than in sequential coating in which each layer is coated and dried. The simultaneous multilayer coating is excellent. By an application of the third aspect of the present invention, an optical reflective film having excellent performance and external appearance can be manufactured with high productivity.

Hereinafter, components of the optical reflective film of the third aspect of the present invention will be described in detail.

In the third aspect of the present invention, “X to Y” indicating a range means “X or more and Y or less”. Unless otherwise specified, an operation and measurement for physical properties or the like are performed under the conditions of room temperature (20 to 25° C.)/relative humidity of 40 to 50%.

[Alkylene-Modified Polyvinyl Alcohol]

The alkylene-modified polyvinyl alcohol according to the third aspect of the present invention acts as a binder (binder resin). The alkylene-modified polyvinyl alcohol according to the third aspect of the present invention can be manufactured by saponifying (hydrolyzing) an olefin-vinyl ester copolymer obtained by copolymerizing an olefin (an olefin monomer, for example, ethylene) and a vinyl ester (a vinyl ester monomer, for example, vinyl acetate) and converting a vinyl ester unit into a vinyl alcohol unit.

The alkylene-modified polyvinyl alcohol according to the third aspect of the present invention is preferably water-soluble (water-soluble binder resin). By using the water-soluble alkylene-modified polyvinyl alcohol, a stable coating liquid can be manufactured. As a result, coatability is excellent. Therefore, the water-soluble ethylene-modified polyvinyl alcohol is preferable. In the third aspect of the present invention, “water-soluble (water-soluble binder resin)” is similar to that in the first aspect of the present invention. When there are a plurality of refractive index layers, alkylene-modified polyvinyl alcohols used in the respective refractive index layers may be the same as or different from each other.

In the optical reflective film of the third aspect of the present invention, at least one of the low refractive index layer and the high refractive index layer includes two or more kinds of alkylene-modified polyvinyl alcohols. In the third aspect of the present invention, the term “two or more kinds of alkylene-modified polyvinyl alcohols” means two or more kinds of alkylene-modified polyvinyl alcohols having different chemical structures (primary structures). Examples of the chemical structure include a polymerization degree, a saponification degree, a degree of alkylene modification, and the kind of an alkylene unit.

(Polymerization Degree)

In the third aspect of the present invention, two or more kinds of alkylene-modified polyvinyl alcohols having different polymerization degrees can be used. The polymerization degree of the alkylene-modified polyvinyl alcohol according to the third aspect of the present invention is not particularly limited, but is preferably 100 or more, more preferably 1000 or more. By using an alkylene-modified polyvinyl alcohol having a high polymerization degree, it is possible to suppress mixing between binders in the high refractive index layer and the low refractive index layer. This makes it possible to manufacture an optical reflective film having a high reflectivity. This mechanism has not been elucidated yet, but is estimated to be as follows. That is, the increase in the polymerization degree decreases the number of molecules in a unit volume, suppresses physical mixing, emphasizes a difference in a solubility parameter, and suppresses mixing of the binders. The difference in the solubility parameter is made because of a difference in a ratio of a carbonyloxy group (derived from a vinyl ester monomer as a raw material) which is a hydrophobic group. The polymerization degree of the alkylene-modified polyvinyl alcohol according to the third aspect of the present invention is preferably high, and an upper limit thereof is not particularly limited, but is preferably 3000 or less, more preferably 2500 or less. In the third aspect of the present invention, the polymerization degree of the alkylene-modified polyvinyl alcohol means a polymerization degree measured in conformity with Japanese Industrial Standard JIS K6726: 1994. The polymerization degree of the alkylene-modified polyvinyl alcohol may be different or the same between the low refractive index layer and the high refractive index layer. A person skilled in the art can arbitrarily adjust the polymerization degree by adjusting reaction temperature, reaction time, a concentration of an initiator, use of a chain transfer agent, or the like at the time of manufacturing the alkylene-modified polyvinyl alcohol.

In the optical reflective film of the third aspect of the present invention, when at least one of the low refractive index layer and the high refractive index layer includes two or more kinds of alkylene-modified polyvinyl alcohols having different polymerization degrees as alkylene-modified polyvinyl alcohols having different chemical structures, a combination thereof can be set arbitrarily. In this case, alkylene-modified polyvinyl alcohols having a difference in the polymerization degree measured in conformity with Japanese Industrial Standard JIS K6726: 1994 of 50 or more are used as the alkylene-modified polyvinyl alcohols having different chemical structures.

For example, two or more kinds of alkylene-modified polyvinyl alcohols satisfying the following formula (3-1) can be used. For convenience of explanation, in the two paragraphs immediately after the formula (3-1), the terms “first kind of alkylene-modified polyvinyl alcohol”, “second kind of alkylene-modified polyvinyl alcohol”, “third kind of alkylene-modified polyvinyl alcohol”, and “fourth kind of alkylene-modified polyvinyl alcohol” are used. These terms mean alkylene-modified polyvinyl alcohols having different polymerization degrees from each other, satisfying the requirements described later.

[Numerical formula 2]

50≦|P₁−P₂|≦2900 Formula (3-1)

In the formula (3-1), P₁ represents a polymerization degree of the first kind of alkylene-modified polyvinyl alcohol, and is an integer of 100 to 3000. P₂ represents a polymerization degree of the second kind of alkylene-modified polyvinyl alcohol, and is preferably an integer of 100 to 3000.

That is, at least one of the low refractive index layer and the high refractive index layer can include a combination of the first kind of alkylene-modified polyvinyl alcohol having a polymerization degree of 100 to 3000 and the second kind of alkylene-modified polyvinyl alcohol having a difference in the polymerization degree from the first kind of alkylene-modified polyvinyl alcohol of 50 to 2900 (the polymerization degree of the second kind of alkylene-modified polyvinyl alcohol is preferably 100 to 3000). The polymerization degree of the alkylene-modified polyvinyl alcohol used as the first kind is preferably 150 to 2500, more preferably 200 to 2500. The alkylene-modified polyvinyl alcohol used as the second kind has a difference in the polymerization degree from the first kind of alkylene-modified polyvinyl alcohol preferably of 100 to 2500, more preferably of 200 to 2000. A ratio between the first kind of alkylene-modified polyvinyl alcohol and the second kind of alkylene-modified polyvinyl alcohol can be set arbitrarily. However, for example, at least one of the low refractive index layer and the high refractive index layer can include the first kind and the second kind of alkylene-modified polyvinyl alcohols at a ratio of 1:5 to 5:1 (weight ratio, for example, 1:3). The ratio between the first kind and the second kind of alkylene-modified polyvinyl alcohols is preferably 1:4 to 4:1 (weight ratio), particularly preferably 1:3.5 to 3.5:1 (weight ratio). In addition to the first kind or the second kind of alkylene-modified polyvinyl alcohol, the third kind or the fourth kind of alkylene-modified polyvinyl alcohol may be further included at an arbitrary ratio. The third kind or the fourth kind of alkylene-modified polyvinyl alcohol has a different polymerization degree from the first kind or the second kind of alkylene-modified polyvinyl alcohol, that is, has a difference in the polymerization degree from the first kind or the second kind of alkylene-modified polyvinyl alcohol of 50 or more (for example, 2900 or less).

(Saponification Degree)

In the third aspect of the present invention, two or more kinds of alkylene-modified polyvinyl alcohols having different saponification degrees can be used. In the third aspect of the present invention, the saponification degree means a ratio of a hydroxyl group with respect to the total number of the hydroxyl group and a carbonyloxy group in the polyvinyl alcohol, and is common to the alkylene-modified polyvinyl alcohol and other polyvinyl alcohols. By the difference in the saponification degree between the high refractive index layer and the low refractive index layer, mixing of the binders can be significantly suppressed. This makes it possible to manufacture an optical reflective film having a high reflectivity. Therefore, the saponification degree of the high refractive index layer is preferably different from that of the low refractive index layer.

The saponification degree of the alkylene-modified polyvinyl alcohol according to the third aspect of the present invention is not particularly limited, but is preferably 85 mol % or more, more preferably 90 mol % or more, still more preferably 97 mol % or more, most preferably 98 mol % or more (upper limit: 100 mol %). When the saponification degree is 85 mol % or more, the optical reflective film has excellent water resistance. In the third aspect of the present invention, the saponification degree of the alkylene-modified polyvinyl alcohol can be measured in conformity with a method described in Japanese Industrial Standard JIS K6726: 1994. A person skilled in the art can arbitrarily adjust the saponification degree by controlling saponification time, temperature, an amount of a saponifying agent, or the like at the time of manufacturing the alkylene-modified polyvinyl alcohol.

In the optical reflective film of the third aspect of the present invention, when at least one of the low refractive index layer and the high refractive index layer includes two or more kinds of alkylene-modified polyvinyl alcohols having different saponification degrees as alkylene-modified polyvinyl alcohols having different chemical structures, a combination thereof can be set arbitrarily. In this case, alkylene-modified polyvinyl alcohols having a difference in the saponification degree measured in conformity with Japanese Industrial Standard JIS K6726: 1994 of 2 mol % or more are used as the alkylene-modified polyvinyl alcohols having different chemical structures.

For example, two or more kinds of alkylene-modified polyvinyl alcohols satisfying the following formula (3-2) can be used. For convenience of explanation, in the two paragraphs immediately after the formula (3-2), the terms “first kind of alkylene-modified polyvinyl alcohol”, “second kind of alkylene-modified polyvinyl alcohol”, “third kind of alkylene-modified polyvinyl alcohol”, and “fourth kind of alkylene-modified polyvinyl alcohol” are used. These terms mean alkylene-modified polyvinyl alcohols having different saponification degrees from each other, satisfying the requirements described later.

[Numerical formula 3]

2≦|S₁−S₂|≦15(unit:mol %) Formula (3-2)

In the formula (3-2), S₁ represents a saponification degree of the first kind of alkylene-modified polyvinyl alcohol, and is 85 to 100 mol %. S₂ represents a saponification degree of the second kind of alkylene-modified polyvinyl alcohol, and is preferably 85 to 100 mol %.

That is, at least one of the low refractive index layer and the high refractive index layer can include a combination of the first kind of alkylene-modified polyvinyl alcohol having a saponification degree of 85 to 100 mol % and the second kind of alkylene-modified polyvinyl alcohol having a difference in the saponification degree from the first kind of alkylene-modified polyvinyl alcohol of 2 to 15 mol % (the saponification degree of the second kind of alkylene-modified polyvinyl alcohol is preferably 85 to 100 mol %). The saponification degree of the alkylene-modified polyvinyl alcohol used as the first kind is preferably 87 to 100 mol %, more preferably 90 to 100 mol %. The alkylene-modified polyvinyl alcohol used as the second kind has a difference in the saponification degree from the first kind of alkylene-modified polyvinyl alcohol preferably of 2.5 to 13 mol %, more preferably of 3 to 10 mol %. A ratio between the first kind of alkylene-modified polyvinyl alcohol and the second kind of alkylene-modified polyvinyl alcohol can be set arbitrarily. However, for example, at least one of the low refractive index layer and the high refractive index layer can include the first kind and the second kind of alkylene-modified polyvinyl alcohols at a ratio of 1:5 to 5:1 (weight ratio, for example, 3:1). The ratio between the first kind and the second kind of alkylene-modified polyvinyl alcohols is preferably 1:4 to 4:1 (weight ratio), particularly preferably 1:3.5 to 3.5:1 (weight ratio). In addition to the first kind or the second kind of alkylene-modified polyvinyl alcohol, the third kind or the fourth kind of alkylene-modified polyvinyl alcohol may be further included at an arbitrary ratio. The third kind or the fourth kind of alkylene-modified polyvinyl alcohol has a different saponification degree from the first kind or the second kind of alkylene-modified polyvinyl alcohol, that is, has a difference in the saponification degree from the first kind or the second kind of alkylene-modified polyvinyl alcohol of 2 mol % or more (for example, 15 mol % or less).

(Degree of Alkylene Modification)

In the third aspect of the present invention, two or more kinds of alkylene-modified polyvinyl alcohols having different degrees of alkylene modification can be used. The degree of alkylene modification of the alkylene-modified polyvinyl alcohol according to the third aspect of the present invention is only required to be 1 to 15 mol %, preferably 1 to 10 mol %, more preferably 3 to 7 mol %. In the third aspect of the present invention, the degree of alkylene modification means a copolymerization amount (mol %) of an olefin in a vinyl alcohol unit converted from a vinyl ester unit of a product obtained by saponifying an olefin-vinyl ester polymer obtained by copolymerizing an olefin and a vinyl ester monomer. A numerical value thereof is measured by a nuclear magnetic resonance (proton NMR) method. The degree of alkylene modification of the alkylene-modified polyvinyl alcohol may be different or the same between the low refractive index layer and the high refractive index layer. A person skilled in the art can arbitrarily adjust the degree of alkylene modification by adjusting an olefin introduction pressure or the like at the time of manufacturing the alkylene-modified polyvinyl alcohol.

In the optical reflective film of the third aspect of the present invention, when at least one of the low refractive index layer and the high refractive index layer includes two or more kinds of alkylene-modified polyvinyl alcohols having different degrees of alkylene modification as alkylene-modified polyvinyl alcohols having different chemical structures, a combination thereof can be set arbitrarily. In this case, alkylene-modified polyvinyl alcohols having a difference in the degree of alkylene modification measured by a nuclear magnetic resonance (proton NMR) method of 0.5 mol % or more are used as the alkylene-modified polyvinyl alcohols having different chemical structures.

For example, two or more kinds of alkylene-modified polyvinyl alcohols satisfying the following formula (3-3) can be used. For convenience of explanation, in the two paragraphs immediately after the formula (3-3), the terms “first kind of alkylene-modified polyvinyl alcohol”, “second kind of alkylene-modified polyvinyl alcohol”, “third kind of alkylene-modified polyvinyl alcohol”, and “fourth kind of alkylene-modified polyvinyl alcohol” are used. These terms mean alkylene-modified polyvinyl alcohols having different degrees of alkylene modification from each other, satisfying the requirements described later.

[Numerical formula 4]

0.5≦|D₁−D₂|≦14.5(unit:mol %) Formula (3-3)

In the formula, D₁ represents a degree of alkylene modification of the first kind of alkylene-modified polyvinyl alcohol, and is 1 to 15 mol %. D₂ represents a degree of alkylene modification of the second kind of alkylene-modified polyvinyl alcohol, and is preferably 1 to 15 mol %.

That is, at least one of the low refractive index layer and the high refractive index layer can include a combination of the first kind of alkylene-modified polyvinyl alcohol having a degree of alkylene modification of 1 to 15 mol % and the second kind of alkylene-modified polyvinyl alcohol having a difference in the degree of alkylene modification from the first kind of alkylene-modified polyvinyl alcohol of 0.5 to 14.5 mol % (the degree of alkylene modification of the second kind of alkylene-modified polyvinyl alcohol is preferably 1 to 15 mol %). The degree of alkylene modification of the alkylene-modified polyvinyl alcohol used as the first kind is preferably 1 to 10 mol %, more preferably 3 to 7 mol %. The alkylene-modified polyvinyl alcohol used as the second kind has a difference in the degree of alkylene modification from the first kind of alkylene-modified polyvinyl alcohol preferably of 1 to 14 mol %, more preferably of 1 to 12 mol %. A ratio between the first kind of alkylene-modified polyvinyl alcohol and the second kind of alkylene-modified polyvinyl alcohol can be set arbitrarily. However, for example, at least one of the low refractive index layer and the high refractive index layer can include the first kind and the second kind of alkylene-modified polyvinyl alcohols at a ratio of 1:5 to 5:1 (weight ratio, for example, 1:3). The ratio between the first kind and the second kind of alkylene-modified polyvinyl alcohols is preferably 1:4 to 4:1 (weight ratio), particularly preferably 1:3.5 to 3.5:1 (weight ratio). In addition to the first kind or the second kind of alkylene-modified polyvinyl alcohol, the third kind or the fourth kind of alkylene-modified polyvinyl alcohol may be further included at an arbitrary ratio. The third kind or the fourth kind of alkylene-modified polyvinyl alcohol has a different degree of alkylene modification from the first kind or the second kind of alkylene-modified polyvinyl alcohol, that is, has a difference in the degree of alkylene modification from the first kind or the second kind of alkylene-modified polyvinyl alcohol of 0.5 mol % or more (for example, 4.5 mol % or less).

(Kind of Alkylene Unit)

The alkylene-modified polyvinyl alcohol according to the third aspect of the present invention is a copolymer including a structural unit —(CₙH₂ₙ)— derived from an olefin (an alkylene unit, n is an integer of 2 or more), a structural unit derived from a vinyl ester (a vinyl ester unit or a vinyl alcohol unit), and if necessary a structural unit derived from another monomer copolymerizable with these structural units. Here, each structural unit included in the alkylene-modified polyvinyl alcohol according to the third aspect of the present invention may have any shape, and for example, may have a block shape or a random shape. In the third aspect of the present invention, two or more kinds of alkylene-modified polyvinyl alcohols having different kinds of alkylene units can be used as alkylene-modified polyvinyl alcohols having different chemical structures. The kind of the alkylene unit of the alkylene-modified polyvinyl alcohol may be different or the same between the low refractive index layer and the high refractive index layer.

For convenience of explanation, in the following paragraph, the terms “first kind of alkylene-modified polyvinyl alcohol”, “second kind of alkylene-modified polyvinyl alcohol”, “third kind of alkylene-modified polyvinyl alcohol”, and “fourth kind of alkylene-modified polyvinyl alcohol” are used. These terms mean alkylene-modified polyvinyl alcohols having different kinds of alkylene units from each other, satisfying the requirements described later.

In the optical reflective film of the third aspect of the present invention, when at least one of the low refractive index layer and the high refractive index layer includes two or more kinds of alkylene-modified polyvinyl alcohols having different kinds of alkylene units as alkylene-modified polyvinyl alcohols having different chemical structures, a combination thereof can be set arbitrarily. For example, at least one of the low refractive index layer and the high refractive index layer can include a combination of the first kind of alkylene-modified polyvinyl alcohol including any one of an ethylene group, a propylene group, and a linear or branched butylene group as an alkylene unit and the second kind of alkylene-modified polyvinyl alcohol including an ethylene group, a propylene group, or a linear or branched butylene group, different from the alkylene unit of the first kind. As the first kind of alkylene-modified polyvinyl alcohol, an ethylene-modified polyvinyl alcohol is preferably used. As the second kind of alkylene-modified polyvinyl alcohol, a propylene-modified polyvinyl alcohol or a linear or branched butylene-modified polyvinyl alcohol is preferably used, and the propylene-modified polyvinyl alcohol is particularly preferably used. These alkylene-modified polyvinyl alcohols can be included at an arbitrary ratio. For example, at least one of the low refractive index layer and the high refractive index layer can include these alkylene-modified polyvinyl alcohols at a molar ratio of 1:5 to 5:1 (weight ratio, for example, 3:1), preferably at a molar ratio of 1 to 4:4 to 1 (weight ratio), particularly preferably at a molar ratio of 1:3.5 to 3.5:1 (weight ratio). When an ethylene-modified polyvinyl alcohol is used as the first kind of alkylene-modified polyvinyl alcohol, and a propylene-modified polyvinyl alcohol is used as the second kind of alkylene-modified polyvinyl alcohol, linear or branched butylene-modified polyvinyl alcohols may be further included at an arbitrary ratio as the third kind of alkylene-modified polyvinyl alcohol or the fourth kind of alkylene-modified polyvinyl alcohol.

(Other Description for Alkylene-Modified Polyvinyl Alcohol)

The number of the kind of the alkylene-modified polyvinyl alcohol included in at least one of the low refractive index layer and the high refractive index layer of the optical reflective film according to the third aspect of the present invention is only required to be two or more, but is preferably two to four, more preferably two or three, particularly preferably two. By the above-described structure, reduction in interlayer adhesion and the defect in external appearance after exposure of the optical reflective film to high humidity conditions can be suppressed or prevented. When the number of the kind of the alkylene-modified polyvinyl alcohol is four or less, a manufacturing process is not extremely complicated.

The two or more kinds of alkylene-modified polyvinyl alcohols included in the optical reflective film of the third aspect of the present invention are only required to have one or more points of difference in the chemical structure, and may have a plurality of points of difference. For example, two or more kinds of alkylene-modified polyvinyl alcohols having difference in any one of the polymerization degree, the saponification degree, the degree of alkylene modification, and the kind of alkylene unit may be used.

When two or more kinds of alkylene-modified polyvinyl alcohols having difference in any two of the polymerization degree, the saponification degree, the degree of alkylene modification, and the kind of alkylene unit are used, it is only required to use two or more kinds of alkylene-modified polyvinyl alcohols having difference in the polymerization degree and the saponification degree, two or more kinds of alkylene-modified polyvinyl alcohols having difference in the polymerization degree and the degree of alkylene modification, two or more kinds of alkylene-modified polyvinyl alcohols having difference in the polymerization degree and the kind of alkylene unit, two or more kinds of alkylene-modified polyvinyl alcohols having difference in the saponification degree and the degree of alkylene modification, two or more kinds of alkylene-modified polyvinyl alcohols having difference in the saponification degree and the kind of alkylene unit, or two or more kinds of alkylene-modified polyvinyl alcohols having difference in the degree of alkylene modification and the kind of alkylene unit.

When two or more kinds of alkylene-modified polyvinyl alcohols having difference in any three of the polymerization degree, the saponification degree, the degree of alkylene modification, and the kind of alkylene unit are used, it is only required to use two or more kinds of alkylene-modified polyvinyl alcohols having difference in the polymerization degree, the saponification degree, and the degree of alkylene modification, two or more kinds of alkylene-modified polyvinyl alcohols having difference in the polymerization degree, the saponification degree, and the kind of alkylene unit, two or more kinds of alkylene-modified polyvinyl alcohols having difference in the polymerization degree, the degree of alkylene modification, and the kind of alkylene unit, or two or more kinds of alkylene-modified polyvinyl alcohols having difference in the saponification degree, the degree of alkylene modification, and the kind of alkylene unit.

Alternatively, two or more kinds of alkylene-modified polyvinyl alcohols having difference in all of the polymerization degree, the saponification degree, the degree of alkylene modification, and the kind of alkylene unit may be used.

In addition, alkylene-modified polyvinyl alcohols having difference in a copolymerization form (block shape, random shape, or graft shape), tacticity, a direction of a repeating unit (head-tail bonding or head-head bonding), or a structure of a vinyl ester unit before the saponification (kind of a residue before saponification) can be used for the optical reflective film of the third aspect of the present invention. However, these points of difference are not assumed to be the difference in the chemical structure in the third aspect of the present invention. That is, even when alkylene-modified polyvinyl alcohols have difference in at least one of the copolymerization form (block shape, random shape, or graft shape), tacticity, the direction of a repeating unit (head-tail bonding or head-head bonding), and/or the structure of a vinyl ester unit before the saponification, when the alkylene-modified polyvinyl alcohols have no difference in at least one of the polymerization degree, the saponification degree, the degree of alkylene modification, and the kind of alkylene unit, the alkylene-modified polyvinyl alcohols do not correspond to the two or more kinds of alkylene-modified polyvinyl alcohols in the third aspect of the present invention. On the other hand, when the alkylene-modified polyvinyl alcohols having difference in at least one of the copolymerization form (block shape, random shape, or graft shape), tacticity, the direction of a repeating unit (head-tail bonding or head-head bonding), and/or the structure of a vinyl ester unit before the saponification have difference in at least one of the polymerization degree, the saponification degree, the degree of alkylene modification, and the kind of alkylene unit, it is possible to use the alkylene-modified polyvinyl alcohols as the two or more kinds of alkylene-modified polyvinyl alcohols in the third aspect of the present invention.

A vinyl ester monomer to form the alkylene-modified polyvinyl alcohol is not particularly limited. However, examples thereof include the monomers exemplified in the first embodiment of the present invention, such as vinyl acetate. Among these, vinyl acetate is preferable. One kind of the vinyl ester monomers may be used alone, or a mixture of two or more kinds thereof may be used.

The alkylene modified polyvinyl used in the third aspect of the present invention may include, if necessary, another copolymerizable monomer within a range not impairing the effect of the invention, in addition to an olefin and the vinyl ester monomer. When the alkylene-modified polyvinyl alcohol according to the third aspect of the present invention includes another copolymerizable monomer, a content of the other copolymerizable monomer is not particularly limited as long as the content is within a range not impairing the effect of the invention, but is preferably 0.1 to 10 mol % with respect to a total amount of the olefin and the vinyl ester monomer. Even when the alkylene-modified polyvinyl alcohols have difference in the kind of the other copolymerizable monomer or a content thereof, or the kind of the monomer or a content thereof, when the alkylene-modified polyvinyl alcohols have no difference in at least one of the polymerization degree, the saponification degree, the degree of alkylene modification, and the kind of alkylene unit, the alkylene-modified polyvinyl alcohols do not correspond to the two or more kinds of alkylene-modified polyvinyl alcohols in the third aspect of the present invention. On the other hand, when the alkylene-modified polyvinyl alcohols having difference in the kind of the other copolymerizable monomer or a content thereof, or the kind of the monomer or a content thereof have difference in at least one of the polymerization degree, the saponification degree, the degree of alkylene modification, and the kind of alkylene unit, it is possible to use the alkylene-modified polyvinyl alcohols as the two or more kinds of alkylene-modified polyvinyl alcohols in the third aspect of the present invention.

When the alkylene-modified polyvinyl alcohol according to the third aspect of the present invention includes another copolymerizable monomer, the other copolymerizable monomer is not particularly limited. However, examples thereof include propylene described above and exemplified in the first aspect of the present invention. One kind of the other copolymerizable monomers may be used alone, or a mixture of two or more kinds thereof may be used.

In the third aspect of the present invention, a content of the two or more kinds of alkylene-modified polyvinyl alcohols is preferably 10 to 50% by weight, more preferably 15 to 45% by weight as a total amount of the alkylene-modified polyvinyl alcohols (that is, as a whole of the two or more kinds of alkylene-modified polyvinyl alcohols having different chemical structures), with respect to the total solid content 100% by weight of the refractive index layer. When the total amount of the two or more kinds of alkylene-modified polyvinyl alcohols is 10% by weight or more, reduction in interlayer adhesion and the defect in external appearance after exposure to high humidity conditions tend to be suppressed or prevented more. On the other hand, when the content is 50% by weight or less, a relative content of the inorganic oxide particles is appropriate, and it is easy to increase the difference in the refractive index between the high refractive index layer and the low refractive index layer. Here, the alkylene-modified polyvinyl alcohol may be a commercially available product. The commercially available product is not particularly limited. However, examples thereof include EXCEVAL (registered trademark) RS-4104, RS-2117, RS-1117, RS-2817, RS-1717, RS-1113, RS-1713, and HR-3010 (manufactured by Kuraray Co. Ltd.).

In the alkylene-modified polyvinyl alcohol according to the third aspect of the present invention, an initiator which can be used for copolymerization of an olefin and a vinyl ester monomer can be a known initiator, and is not particularly limited. However, examples thereof include an azo-based initiator such as 2,2′-azobisisobutyronitrile, 2,2′-azobis(2,4-dimethylvaleronitrile), or 2,2′-azobis(4-methoxy-2,4-dimethylvaleronitrile); and a peroxide such as benzoyl peroxide, lauroyl peroxide, or acetyl peroxide. The temperature at the polymerization depends on an initiator to be used or the like, but is usually 50° C. to 90° C. The reaction time is not particularly limited, and may be appropriately adjusted according to a blending amount of each component, the reaction temperature, and the like.

[Polyvinyl Alcohol]

In the optical reflective film of the third aspect of the present invention, at least one of the low refractive index layer and the high refractive index layer is only required to include the two or more kinds of alkylene-modified polyvinyl alcohols according to the third aspect of the present invention. Therefore, as described above, the low refractive index layer and/or the high refractive index layer may include the two or more kinds of alkylene-modified polyvinyl alcohols according to the third aspect of the present invention and a polyvinyl alcohol (an unmodified polyvinyl alcohol or a modified polyvinyl alcohol other than the alkylene-modified polyvinyl alcohol) other than the alkylene-modified polyvinyl alcohol. One of the low refractive index layer and the high refractive index layer may include the two or more kinds of alkylene-modified polyvinyl alcohols according to the third aspect of the present invention, and the other one may include a polyvinyl alcohol other than the alkylene-modified polyvinyl alcohol without including the two or more kinds of alkylene-modified polyvinyl alcohols according to the third aspect of the present invention. The high refractive index layer preferably includes, as a binder, the two or more kinds of alkylene-modified polyvinyl alcohols according to the third aspect of the present invention, or the two or more kinds of alkylene-modified polyvinyl alcohols according to the third aspect of the present invention and one or more kinds of polyvinyl alcohols other than the alkylene-modified polyvinyl alcohol. The low refractive index layer preferably includes, as a binder, one or more kinds of polyvinyl alcohols other than the alkylene-modified polyvinyl alcohol. In the third aspect of the present invention, the term “polyvinyl alcohol” itself indicates a normal polyvinyl alcohol (unmodified polyvinyl alcohol) obtained by hydrolyzing polyvinyl acetate, and a polyvinyl alcohol other than the alkylene-modified polyvinyl alcohol.

The polyvinyl alcohol acts as a binder (binder resin). The polyvinyl alcohol is preferably a water-soluble polyvinyl alcohol (water-soluble binder resin). By using the water-soluble polyvinyl alcohol, a coating liquid of the refractive index layer has excellent liquid stability. As a result, coatability is excellent. Therefore, the water-soluble polyvinyl alcohol is preferable. When there are a plurality of refractive index layers, polyvinyl alcohols used in the respective refractive index layers may be the same as or different from each other.

Examples of the polyvinyl alcohol include KURARAYPOVAL PVA series (manufactured by Kuraray Co. Ltd.) and J-POVAL J series (manufactured by Japan VAM & POVAL Co., LTD.).

A modified polyvinyl alcohol which has been partially modified may be included. Examples of such a modified polyvinyl alcohol include a cation-modified polyvinyl alcohol, an anion-modified polyvinyl alcohol, and a nonion-modified polyvinyl alcohol.

Among these, the cation-modified polyvinyl alcohol is not particularly limited, but is obtained, for example, by the above-described method exemplified in the first aspect of the present invention.

Examples of the unsaturated alkylene monomer containing a cationic group include an unsaturated ethylene monomer such as trimethyl-(2-acrylamide-2,2-dimethylethyl) ammonium chloride, exemplified in the first aspect of the present invention. A ratio of the monomer containing a cationic modification group in the cation-modified polyvinyl alcohol is 0.1 to 10 mol %, preferably 0.2 to 5 mol % with respect to vinyl acetate.

The anion-modified polyvinyl alcohol is not particularly limited. However, examples thereof include anion-modified polyvinyl alcohols described in the above publications exemplified in the first aspect of the present invention.

The nonion-modified polyvinyl alcohol is not particularly limited. However, examples thereof include the above-described nonion-modified polyvinyl alcohols exemplified in the first aspect of the present invention.

The polymerization degree of the polyvinyl alcohol is not particularly limited, but is preferably 1000 to 5000, more preferably 2000 to 5000. Within this range, the coating film has excellent strength, and the coating liquid is stable. Particularly when the polymerization degree is 2000 or more, a crack is not generated in the coating film, and a haze thereof is excellent. Therefore, the polymerization degree of 2000 or more is preferable. In the third aspect of the present invention, the polymerization degree of the polyvinyl alcohol means a polymerization degree measured in conformity with Japanese Industrial Standard JIS K6726: 1994.

The saponification degree of the polyvinyl alcohol is not particularly limited, but is preferably 85 mol % or more, more preferably 90 mol % or more, still more preferably 95 mol % or more, most preferably 98 mol % or more (upper limit: 99.5 mol %). When the saponification degree is 85 mol % or more, the optical reflective film has excellent water resistance. In the third aspect of the present invention, the saponification degree of the alkylene-modified polyvinyl alcohol can be measured in conformity with a method described in Japanese Industrial Standard JIS K6726: 1994.

A content of the polyvinyl alcohol in the refractive index layer is preferably 3 to 70% by weight, more preferably 5 to 60% by weight, still more preferably 10 to 50% by weight, particularly preferably 15 to 45% by weight, with respect to the total solid content of the refractive index layer.

In the third aspect of the present invention, the refractive index layer may include, as the binder, only an alkylene-modified polyvinyl alcohol, or may include a polyvinyl alcohol other than the alkylene-modified polyvinyl alcohol in addition to the alkylene-modified polyvinyl alcohol. In the latter case, one layer includes the alkylene-modified polyvinyl alcohol preferably in an amount of 30% by weight or more, more preferably in an amount of 60% by weight or more with respect to the binder (total weight of the alkylene-modified polyvinyl alcohol and a polyvinyl alcohol other than the alkylene-modified polyvinyl alcohol). In this case, an upper limit of the alkylene-modified polyvinyl alcohol in the binder is not particularly limited, but is preferably 90% by weight or less, more preferably 80% by weight or less with respect to the binder (total weight of the alkylene-modified polyvinyl alcohol and a polyvinyl alcohol other than the alkylene-modified polyvinyl alcohol).

[Curing Agent]

In the third aspect of the present invention, the refractive index layer preferably uses a curing agent. When a polyvinyl alcohol is used as a binder resin, an effect thereof can be particularly exhibited.

The curing agent which can be used with the polyvinyl alcohol is not particularly limited as long as the curing agent causes a curing reaction with the polyvinyl alcohol, but is preferably boric acid or a salt thereof. In addition to boric acid and a salt thereof, a known curing agent can be used. In general, a compound containing a group which can react with the polyvinyl alcohol, or a compound which promotes a reaction between different groups contained in the polyvinyl alcohol is appropriately selected to be used. Specific examples of the curing agent include the above-described epoxy-based curing agent exemplified in the first aspect of the present invention.

Boric acid, a borate, and borax containing a boron atom as the curing agent may be each used alone as an aqueous solution, or two or more kinds thereof may be mixed to be used. An aqueous solution of boric acid or a mixed aqueous solution of boric acid and borax is preferable. An aqueous solution of boric acid and an aqueous solution of borax can be each added only as a relatively dilute aqueous solution. However, by mixing the two, a concentrated aqueous solution can be obtained, and the coating liquid can be concentrated. It is possible to relatively freely control the pH of the aqueous solution to be added.

In the third aspect of the present invention, in order to obtain the effect of the third aspect of the present invention, boric acid and a salt thereof and/or borax are preferably used. When boric acid and a salt thereof and/or borax are used, inorganic oxide particles and an OH group of a polyvinyl alcohol form a hydrogen bond network. As a result, it is considered that interlayer mixing between the high refractive index layer and the low refractive index layer is suppressed, and a preferable heat ray-shielding property is achieved. Particularly, when a set-type coating process is used, a more preferable effect can be exhibited. In the set-type coating process, a multilayer of the high refractive index layer and the low refractive index layer is coated with a coater, and then, the temperature on the surface of the coating film is temporarily lowered to about 15° C., and then, the film surface is dried.

A total use amount of the curing agent is preferably 10 to 600 mg, more preferably 20 to 500 mg per g of the polyvinyl alcohol (or the alkylene-modified polyvinyl alcohol, or a total amount of the polyvinyl alcohol and the alkylene-modified polyvinyl alcohol when the polyvinyl alcohol and the alkylene-modified polyvinyl alcohol are used together).

[Resin Binder (Other Water-Soluble Polymers)]

In the third aspect of the present invention, each refractive index layer may include, as a binder, another water-soluble polymer such as gelatin, a cellulose, a polysaccharide thickener, or a polymer containing a reactive functional group, described in the second aspect of the present invention.

[Other Additives]

The high refractive index layer of the optical reflective film of the third aspect of the present invention or the low refractive index layer described below may include known additives, for example, described in the above literatures exemplified in the first aspect of the present invention. Examples thereof include an ultraviolet absorber, an anti-fading agent, an anionic, cationic, or nonionic surfactant, a fluorescent whitening agent, a pH adjusting agent such as sulfuric acid, phosphoric acid, acetic acid, citric acid, sodium hydroxide, potassium hydroxide, or potassium carbonate, an antifoaming agent, a lubricant such as diethylene glycol, a preservative, an anti-static agent, and a matting agent.

[Inorganic Oxide Particles Used in High Refractive Index Layer]

In the third aspect of the present invention, in order to form a transparent high refractive index layer having a higher refractive index, the high refractive index layer includes inorganic oxide particles (high refractive index metal oxide fine particles) such as titanium oxide, zirconia, tin oxide, zinc oxide, alumina, colloidal alumina, niobium oxide, europium oxide, or zircon. Among these, the high refractive index layer preferably includes titanium oxide or zirconia, and more preferably includes titanium oxide. That is, the high refractive index layer preferably includes titanium oxide particles as inorganic oxide particles, and more preferably includes two or more kinds of alkylene-modified polyvinyl alcohols and the titanium oxide particles as inorganic oxide particles. The high refractive index layer particularly preferably includes rutile type (tetragonal) titanium oxide particles due to exhibition of a high refractive index. The size of the high refractive index metal oxide fine particle is not particularly limited. However, a volume average particle diameter thereof is preferably 1 to 100 nm or less, more preferably 3 to 50 nm. In order to adjust the refractive index, one kind of the high refractive index metal oxide fine particles may be used, or two or more kinds thereof may be used together.

Titanium oxide particles capable of being dispersed in an organic solvent or the like, obtained by modifying the surface of an aqueous titanium oxide sol, are preferably used.

As a method for preparing the aqueous titanium oxide sol, any method known in the related art can be used. For example, description in the above publications exemplified in the first aspect of the present invention can be referred to.

As for other methods for manufacturing the titanium oxide particles, for example, methods described in the above literatures exemplified in the first aspect of the present invention can be referred to.

Furthermore, as other methods for manufacturing inorganic oxide particles including the titanium oxide particles, the above description exemplified in the first aspect of the present invention can be referred to.

In addition, a form of core shell particles is preferable. In the form of core shell particles, the titanium oxide particles are coated with a silicon-containing hydrous oxide. Here, “coated” means a state in which the silicon-containing hydrous oxide adheres to at least a part of the surface of the titanium oxide particles. In the third aspect of the present invention, the coated titanium oxide is also referred to as “silica adhesion titanium dioxide” or “silica coated titanium oxide.” That is, the surface of the titanium oxide particles used as inorganic oxide particles (metal oxide particles) may be completely coated with the silicon-containing hydrous oxide, or a part of the surface of the titanium oxide particles may be coated with the silicon-containing hydrous oxide. Apart of the surface of the titanium oxide particles is preferably coated with the silicon-containing hydrous oxide from such a viewpoint that the refractive index of the coated titanium oxide particles is controlled by a coating amount of the silicon-containing hydrous oxide.

The titanium oxide of the titanium oxide particles coated with the silicon-containing hydrous oxide may be a rutile type or an anatase type. The titanium oxide particles coated with the silicon-containing hydrous oxide are preferably rutile type titanium oxide particles coated with the silicon-containing hydrous oxide. This is because the rutile type titanium oxide particles have a lower photocatalytic activity than the anatase type titanium oxide particles, and therefore, the high refractive index layer and the low refractive index layer adjacent thereto have higher weather resistance and higher refractive indices. In the third aspect of the present invention, “silicon-containing hydrous oxide” may be any one of a hydrate of an inorganic silicon compound and a hydrolyzate and/or a condensate of an organic silicon compound, but more preferably contains a silanol group in order to obtain the effect of the third aspect of the present invention. Therefore, in the third aspect of the present invention, the high refractive index metal oxide fine particles are preferably silica-modified (silanol-modified) titanium oxide particles in which the titanium oxide particles are silica modified.

A coating amount of the silicon-containing hydrous oxide is 3 to 30% by weight, preferably 3 to 20% by weight, more preferably 3 to 10% by weight with respect to titanium oxide as a core. The reasons are as follows. When the coating amount is 30% by weight or less, a desired refractive index of the high refractive index layer is obtained. When the coating amount is 3% by weight or more, particles can be formed stably.

As a method for coating the titanium oxide particles with the silicon-containing hydrous oxide, a method known in the related art can be used. For example, the above description exemplified in the first aspect of the present invention can be referred to.

In the core shell particles according to the third aspect of the present invention, the entire surface of the titanium oxide particles as a core may be coated with a silicon-containing hydrous oxide, or a part of the surface of the titanium oxide particles as a core may be coated with the silicon-containing hydrous oxide.

The inorganic oxide particles used in the high refractive index layer can be determined by a volume average particle diameter or a primary average particle diameter. The volume average particle diameter of the inorganic oxide particles used in the high refractive index layer is preferably 30 nm or less, more preferably 1 to 30 nm, still more preferably 5 to 15 nm. The primary average particle diameter of the inorganic oxide particles used for the inorganic oxide particles used in the high refractive index layer is preferably 30 nm or less, more preferably 1 to 30 nm, still more preferably 5 to 15 nm. Inorganic oxide particles having a primary average particle diameter of 1 nm or more and 30 nm or less are preferable in view of a low haze and an excellent visible light transmittance. Inorganic oxide particles having a volume average particle diameter or a primary average particle diameter of 30 nm or less are preferable in view of a low haze and an excellent visible light transmittance. By containing core shell particles as high refractive index metal oxide fine particles, interlayer mixing between the high refractive index layer and the low refractive index layer is suppressed due to an interaction between the silicon-containing hydrous oxide in the shell layer and the polyvinyl alcohol. Here, in a case of the titanium oxide particles coated with the silicon-containing hydrous oxide, the volume average particle diameter and the primary average particle diameter indicate a volume average particle diameter and a primary average particle diameter of titanium oxide particles (not coated with the silicon-containing hydrous oxide), respectively. A calculation method of the volume average particle diameter in the third aspect of the present invention is similar to that in the first aspect of the present invention.

Furthermore, the inorganic oxide particles used in the third aspect of the present invention are preferably monodispersed. Here, monodipersion means that a monodispersion degree is 40% or less. The monodispersion degree is determined by the above formula shown in the first aspect of the present invention. The monodispersion degree is more preferably 30% or less, particularly preferably 0.1 to 20%.

A content of the inorganic oxide particles in the high refractive index layer is not particularly limited, but is preferably 15 to 85% by weight, more preferably 20 to 80% by weight, still more preferably 30 to 75% by weight with respect to the total solid content of the high refractive index layer. By the content within the above-described range, an excellent optical reflection property can be obtained.

[Inorganic Oxide Particles Used in Low Refractive Index Layer]

In the low refractive index layer, silica (silicon dioxide) is preferably used as inorganic oxide particles. Specific examples thereof include synthetic amorphous silica, colloidal silica, zinc oxide, alumina, and colloidal alumina. Among these, a colloidal silica sol, particularly an acidic colloidal silica sol is more preferably used, and colloidal silica dispersed in an organic solvent is particularly preferably used. In order to further reduce the refractive index, hollow fine particles having pores inside the particles may be used as the inorganic oxide particles in the low refractive index layer. Hollow fine particles of silica (silicon dioxide) are particularly preferably used. Known inorganic oxide particles other than silica can be also used. In order to adjust the refractive index, one kind of the inorganic oxide particles may be used, or two or more kinds thereof may be used together for the low refractive index layer.

The inorganic oxide particles (preferably silicon dioxide) included in the low refractive index layer preferably have an average particle diameter (number average; diameter) of 3 to 100 nm. The average particle diameter of primary particles of silicon dioxide dispersed in a state of primary particles (particle diameter in a state of a dispersion liquid before coating) is more preferably 3 to 50 nm, still more preferably 1 to 40 nm, particularly preferably 3 to 20 nm, most preferably 4 to 10 nm. The average particle diameter of secondary particles is preferably 30 nm or less in view of a low haze and excellent visible light transmittance.

In the third aspect of the present invention, the primary average particle diameter can be measured from an electron micrograph by a transmission electron microscope (TEM) or the like. The primary average particle diameter may be measured by a particle size distribution analyzer or the like using a dynamic light scattering method, a static light scattering method, or the like.

When being determined using the transmission electron microscope, the primary average particle diameter of the particles is similar to that of the first aspect of the present invention.

The particle diameter of the inorganic oxide particles in the low refractive index layer can be determined by a volume average particle diameter in addition to the primary average particle diameter.

The colloidal silica used in the third aspect of the present invention is obtained by heat aging a silica sol obtained by methathesis with an acid of sodium silicate or the like, or transmission through an ion-exchange resin layer. For example, colloidal silica described in the above literatures exemplified in the first aspect of the present invention is used.

Such a colloidal silica may be a synthetic product or a commercially available product. Examples of the commercially available product include Snowtex series available from Nissan Chemical Industries, Ltd. (Snowtex OS, OXS, S, OS, 20, 30, 40, O, N, C, etc.).

The surface of the colloidal silica may be cation-modified, or may be treated with Al, Ca, Mg, Ba, or the like.

As the inorganic oxide particles in the low refractive index layer, hollow particles can be used. When hollow fine particles are used, description of the hollow particles in the first aspect of the present invention is referred to.

A content of the inorganic oxide particles in the low refractive index layer is preferably 20 to 90% by weight, more preferably 30 to 85% by weight, still more preferably 40 to 70% by weight with respect to the total solid content of the low refractive index layer. When the content is 20% by weight or more, a desired refractive index is obtained. When the content is 90% by weight or less, coatability is excellent. Therefore, the content of 20% by weight or more and 90% by weight or less is preferable.

The inorganic oxide particles in the low refractive index layer are only required to be included in at least one layer of the plurality of low refractive index layers.

[Method for Manufacturing Optical Reflective Film]

A method for manufacturing the optical reflective film of the third aspect of the present invention is not particularly limited. Any method can be used, as long as at least one unit including a high refractive index layer and a low refractive index layer can be formed on a substrate.

In the method for manufacturing the optical reflective film of the third aspect of the present invention, a unit including a high refractive index layer and a low refractive index layer is laminated on a substrate to form the optical reflective film.

Specifically, a high refractive index layer and a low refractive index layer are preferably alternately coated and dried to form a laminated body. Specific examples of the embodiment include: (1) a method for manufacturing an optical reflective film, in which a high refractive index layer coating liquid is coated on a substrate and dried to form a high refractive index layer, and then a low refractive index layer coating liquid is coated and dried to forma low refractive index layer; (2) a method for manufacturing an optical reflective film, in which a low refractive index layer coating liquid is coated on a substrate and dried to form a low refractive index layer, and then a high refractive index layer coating liquid is coated and dried to form a high refractive index layer; (3) a method for manufacturing an optical reflective film including a high refractive index layer and a low refractive index layer, in which a high refractive index layer coating liquid and a low refractive index layer coating liquid are alternately and sequentially coated on a substrate in a form of a multilayer and then dried; and (4) a method for manufacturing an optical reflective film including a high refractive index layer and a low refractive index layer, in which a high refractive index layer coating liquid and a low refractive index layer coating liquid are simultaneously coated on a substrate in a form of a multilayer and dried. Among these, the above method (4) which is a simpler manufacturing method, is preferable. That is, the method for manufacturing the optical reflective film of the third aspect of the present invention preferably includes laminating the high refractive index layer and the low refractive index layer by an aqueous simultaneous multilayer coating method.

In the third aspect of the present invention, one of the low refractive index layer and the high refractive index layer may include two or more kinds of alkylene-modified polyvinyl alcohols, or both the layers may include two or more kinds of alkylene-modified polyvinyl alcohols. However, at least, the high refractive index layer including particles having reactivity with a hydroxyl group, such as titanium oxide or zirconium, preferably includes two or more kinds of alkylene-modified polyvinyl alcohols.

Preferable examples of a coating method include the roll coating method described above and exemplified in the first aspect of the present invention.

A solvent for preparing the high refractive index layer coating liquid and the low refractive index layer coating liquid is not particularly limited. However, water, an organic solvent, or a mixture thereof is preferable. In the third aspect of the present invention, an aqueous solvent can be used because an alkylene-modified polyvinyl alcohol/polyvinyl alcohol is mainly used as a resin binder. The aqueous solvent does not require large-scaled manufacturing facilities unlike in a case of using an organic solvent. Therefore, the aqueous solvent is preferable in view of productivity and environmental protection.

Examples of the organic solvent include methanol described above and exemplified in the first aspect of the present invention. The organic solvents may be each used alone, or a mixture of two or more kinds thereof may be used. The aqueous solvent is preferable as a solvent of the coating liquid in view of environment, easiness of the operation, and the like. Water or a mixed solvent of water and methanol, water and ethanol, or water and ethyl acetate is more preferable. Water is particularly preferable.

When a mixed solvent of water and a small amount of organic solvent is used, a content of water in the mixed solvent is preferably 80 to 99.9% by weight, more preferably 90 to 99.5% by weight with respect to 100% by weight of the total content of the mixed solvent. Here, the content of 80% by weight or more makes it possible to reduce fluctuation in volume due to volatilization of the solvent, and improves handling. The content of 99.9% by weight or less increases homogeneity during liquid addition, and makes it possible to obtain stable liquid physical properties.

A concentration of the alkylene-modified polyvinyl alcohol/polyvinyl alcohol in the refractive index layer coating liquid (total concentration of the alkylene-modified polyvinyl alcohol and the polyvinyl alcohol in the coating liquid) is preferably 0.5 to 10% by weight. A concentration of the inorganic oxide particles in the high refractive index layer coating liquid is preferably 1 to 50% by weight.

A method for manufacturing the high refractive index layer coating liquid or the low refractive index layer coating liquid is not particularly limited. For example, inorganic oxide particles, a polyvinyl alcohol, a chelate compound having a higher refractive index than the polyvinyl alcohol, an acylate compound, a salt thereof, and another additive to be added if necessary, are added, stirred, and mixed. At this time, the order of adding the components is not particularly limited. The components may be sequentially added and mixed while being stirred, or may be simultaneously added and mixed while being stirred.

In the third aspect of the present invention, when the simultaneous multilayer coating is performed, the saponification degree of the polyvinyl alcohol in the high refractive index layer coating liquid is preferably different from that in the low refractive index layer coating liquid. The difference in the saponification degree makes it possible to suppress mixing of the layers in each step of coating and drying. This mechanism has not been elucidated yet, but is estimated to be as follows. That is, mixing is suppressed due to a difference in surface tension derived from the difference in the saponification degree. In the third aspect of the present invention, the difference in the saponification degree of the polyvinyl alcohol between the high refractive index layer coating liquid and the low refractive index layer coating liquid is preferably 3 mol % or more, more preferably 8 mol % or more. That is, the difference between the saponification degree of the high refractive index layer and that of the low refractive index layer is preferably 3 mol % or more, more preferably 8 mol % or more. An upper limit of the difference between the saponification degree of the high refractive index layer and that of the low refractive index layer is preferably higher in view of suppressing/preventing interlayer mixing between the high refractive index layer and the low refractive index layer, and is not particularly limited, but is preferably 20 mol % or less, more preferably 15 mol % or less.

In the third aspect of the present invention, when each refractive index layer includes a plurality of polyvinyl alcohols (having different saponification degrees and polymerization degrees), the polyvinyl alcohol for which the difference in the saponification degree is compared in each refractive index layer is a polyvinyl alcohol having the largest content in the refractive index layer. Here, when a polyvinyl alcohol is referred to as “a polyvinyl alcohol having the largest content in the refractive index layer”, it is assumed that polyvinyl alcohols having the difference in the saponification degree of less than 2 mol % are the same polyvinyl alcohol, and the polymerization degree is calculated. A specific method thereof is similar to the method described in the first embodiment of the present invention.

In the third aspect of the present invention, when one layer includes polyvinyl alcohols having the difference in the saponification degree of 2 mol % or more, these polyvinyl alcohols are assumed to be a mixture of different polyvinyl alcohols, and the polymerization degree and the saponification degree for each polyvinyl alcohol are calculated to compare a difference in the saponification degree in each refractive index layer.

When the simultaneous multilayer coating is performed using a slide bead coating method, the temperature of the high refractive index layer coating liquid or the low refractive index layer coating liquid is preferably 25 to 60° C., more preferably 30 to 45° C. When a curtain coating method is used, the temperature is preferably 25 to 60° C., more preferably 30 to 45° C.

When the simultaneous multilayer coating is performed, the viscosity of the high refractive index layer coating liquid or the low refractive index layer coating liquid is not particularly limited. However, when the slide bead coating method is used, the viscosity is preferably 5 to 160 mPa·s, more preferably 60 to 140 mPa·s in the above-described preferable temperature range of the coating liquid. When the curtain coating method is used, the viscosity is preferably 5 to 1200 mPa·s, more preferably 25 to 500 mPa·s in the above-described preferable temperature range of the coating liquid. Within such a range of the viscosity, it is possible to perform the simultaneous multilayer coating efficiently.

The viscosity of the coating liquid at 15° C. is preferably 100 mPa·s or more, more preferably 100 to 30000 mPa·s, still more preferably 2500 to 30000 mPa·s.

Conditions for coating and drying methods are not particularly limited. However, for example, in a sequential coating method, first, one of the high refractive index layer coating liquid and the low refractive index layer coating liquid heated to 30 to 60° C. is coated on a substrate and dried to form a layer. Thereafter, the other coating liquid is coated on the layer and dried to form a laminated film precursor (unit). Subsequently, the number of the units necessary for exhibiting desired shielding performance are sequentially coated, dried, and laminated by the above-described method to obtain a laminated film precursor. When being dried, the formed coating film is preferably dried at 30° C. or higher. For example, the coating film is preferably dried at a wet bulb temperature of 5 to 50° C. and at a film surface temperature of 5 to 100° C. (preferably 10 to 50° C.). For example, warm air at 40 to 60° C. is blown for 1 to 5 seconds for drying. As the drying method, warm air drying, infrared drying, or microwave drying is used. Drying in a multi stage process is more preferable than drying in a single process. The temperature of a constant rate drying section is preferably lower than that of a falling rate drying section. In this case, the temperature range of the constant rate drying section is preferably 30 to 60° C., and the temperature range of the falling rate drying section is preferably 50 to 100° C.

Conditions for coating and drying methods in the simultaneous multilayer coating are as follows. That is, the high refractive index layer coating liquid and the low refractive index layer coating liquid are heated to 30 to 60° C., and the simultaneous multilayer coating of the high refractive index layer coating liquid and the low refractive index layer coating liquid is performed on a substrate. Thereafter, the temperature of the formed coating film is temporarily lowered preferably to 1 to 15° C. (setting), and then the coating film is preferably dried at 10° C. or higher. More preferable conditions for drying are the wet bulb temperature of 5 to 50° C. and the film surface temperature of 10 to 50° C. For example, drying is performed by blowing warm air at 40 to 80° C. for 1 to 5 seconds. As a cooling method immediately after coating, a horizontal setting method is preferably used in view of improving the uniformity of the formed coating film. Here, the meaning of the setting and the definition of completion of the setting are similar to those in the first aspect of the present invention.

A period of time (setting time) from the time of coating to the time when setting is completed by blowing cool air, is preferably 5 minutes or less, more preferably 2 minutes or less. A lower limit of the time is not particularly limited, but is preferably 45 seconds or more. When the setting time is too short, mixing of the components in the layer may be insufficient. On the other hand, when the setting time is too long, interlayer diffusion of the inorganic oxide particles proceeds, and the difference in the refractive index between the high refractive index layer and the low refractive index layer may be insufficient. If elasticity of an intermediate layer between the high refractive index layer and the low refractive index layer becomes higher quickly, it is not necessary to provide the setting step.

The setting time can be adjusted by adjusting a concentration of the polyvinyl alcohol or the inorganic oxide particles, or by adding other components, for example, a known gelling agent such as gelatin, pectin, agar, carrageenan, or gellan gum.

The temperature of the cool air is preferably 0 to 25° C., more preferably 5 to 10° C. The time during which the coating film is exposed to the cool air depends on a conveying speed of the coating film, but is preferably 10 to 360 seconds, more preferably 10 to 300 seconds, still more preferably 10 to 120 seconds.

Coating should be performed such that the coating thickness of the high refractive index layer coating liquid or the low refractive index layer coating liquid is the above-described preferable thickness when being dried.

[Substrate]

As a substrate of the optical reflective film, various resin films can be used. Examples thereof include the resin films exemplified in the first embodiment of the present invention, such as a polyester film (polyethylene terephthalate (PET), polyethylene naphthalate, etc.). A preferable example thereof is a polyester film. The polyester film (hereinafter, referred to as a polyester) is not particularly limited, but is preferably a polyester including a dicarboxylic acid component and a diol component as main components and having a film-forming property.

Examples of the dicarboxylic acid component as a main component include terephthalic acid described above and exemplified in the first aspect of the present invention. Among the polyesters including these compounds as main components, a polyester mainly including terephthalic acid or 2,6-naphthalene dicarboxylic acid as the dicarboxylic acid component, and ethylene glycol or 1,4-cyclohexane dimethanol as the diol component, is preferable in view of transparency, mechanical strength, dimensional stability, or the like. Among these, a polyester including polyethylene terephthalate or polyethylene naphthalate as a main component, a copolyester including terephthalic acid, 2,6-naphthalene dicarboxylic acid, and ethylene glycol, and a polyester including a mixture of two or more kinds of these polyesters as a main component are preferable.

The thickness of the substrate used in the third aspect of the present invention is preferably 10 to 300 μm, particularly preferably 20 to 150 μm. Two sheets of the substrate may be laminated. In this case, the kinds thereof may be the same as or different from each other.

The transmittance of the substrate in a visible light region indicated by Japanese Industrial Standard JIS R3106-1998 is preferably 85% or more, particularly preferably 90% or more. The substrate having a transmittance of the above-described value or more is advantageous in view of obtaining a transmittance in a visible light region indicated by Japanese Industrial Standard JIS R3106-1998 of 50% or more (upper limit: 100%) when an infrared reflective film is formed, and is preferable.

The substrate using the above-described resin or the like may be an undrawn film or a drawn film. The drawn film is preferable in view of improving strength and suppressing thermal expansion.

The substrate can be manufactured by a general method known in the related art. For example, it is possible to manufacture an undrawn substrate which is substantially amorphous and is not oriented, by melting a resin as a material with an extruder, extruding the resin using a circular die or a T die, and cooling the resin rapidly. It is possible to manufacture a drawn substrate by drawing the undrawn substrate in a flow direction (longitudinal direction) of the substrate or a direction perpendicular to the flow direction of the substrate (transverse direction) by a known method such as uniaxial drawing, tenter-type sequential biaxial drawing, tenter-type simultaneous biaxial drawing, or tubular type simultaneous biaxial drawing. In this case, a draw ratio can be appropriately selected according to the resin as a raw material of the substrate, but is preferably 2 to 10 times in each of the longitudinal direction and the transverse direction.

The substrate may be subjected to a relaxation treatment or an off-line heat treatment in view of dimensional stability. The relaxation treatment is preferably performed after thermal fixation in a drawing and film-forming step of the polyester film, in a tenter of the transverse drawing or in a step after the polyester film leaves the tenter and before the polyester film is wound. The relaxation treatment is performed preferably at a treatment temperature of 80 to 200° C., more preferably at a treatment temperature of 100 to 180° C. The relaxation treatment is performed preferably at a relaxation ratio of 0.1 to 10%, more preferably at a relaxation ratio of 2 to 6% in each of the longitudinal direction and the transverse direction. The substrate subjected to the relaxation treatment has improved heat resistance and excellent dimensional stability by being subjected to the following off-line heat treatment.

An undercoating layer coating liquid is preferably coated on one surface or both surfaces of the substrate in-line in a film forming step. Undercoating in the film forming step is referred to as in-line undercoating. Examples of the resin used for the undercoating layer coating liquid include a polyester resin described above and exemplified in the first aspect of the present invention. Any of these resins can be preferably used. An additive known in the related art can be added to the undercoating layer. The undercoating layer can be coated by a known method such as roll coating, gravure coating, knife coating, dip coating, or spray coating. A coating amount of the undercoating layer is preferably about 0.01 to 2 g/m² (dry state).

[Film Design]

The optical reflective film of the third aspect of the present invention includes at least one unit in which a high refractive index layer and a low refractive index layer are laminated. The optical reflective film preferably includes a multilayer optical interference film formed by alternately laminating the high refractive index layer and the low refractive index layer on one surface or both surfaces of the substrate. In view of productivity, a preferable range of the total number of the high refractive index layers and the low refractive index layers per surface of the substrate is 100 or less, more preferably 45 or less. A lower limit of the preferable range of the total number of the high refractive index layers and the low refractive index layers per surface of the substrate is not particularly limited, but is preferably 5 or more. The preferable range of the total number of the high refractive index layer and the low refractive index layer is applicable when laminating is performed only on one surface of the substrate, and is applicable when laminating is performed simultaneously on both surfaces of the substrate. When laminating is performed on both surfaces of the substrate, the total number of the high refractive index layer and the low refractive index layer on one surface of the substrate may be the same as or different from that on the other surface. In the optical reflective film of the third aspect of the present invention, each of the bottom layer (layer in contact with the substrate) and the top surface layer may be the high refractive index layer or the low refractive index layer. However, the optical reflective film of the third aspect of the present invention preferably has a layer structure in which each of the bottom layer and the top surface layer is the low refractive index layer, in view of adhesion of the bottom layer to the substrate, blown resistance of the top surface layer, and excellent coatability and adhesion of a hard coat layer or the like to the top surface layer due to the layer structure in which the low refractive index layer is positioned in each of the bottom layer and the top surface layer.

In general, it is preferable to design an optical reflective film having a large difference in the refractive index between the high refractive index layer and the low refractive index layer in view of being able to increase a reflectivity with respect to a desired ray of light with a small number of layers. In the third aspect of the present invention, at least a difference in the refractive index between two adjacent layers (the high refractive index layer and the low refractive index layer) is preferably 0.3 or more, more preferably 0.35 or more, still more preferably 0.4 or more. An upper limit thereof is not particularly limited, but is usually 1.4 or less.

It is possible to calculate the difference in the refractive index and the necessary number of layers using a commercially available optical design software, as described in the first aspect of the present invention.

When the high refractive index layer and the low refractive index layer are alternately laminated in the optical reflective film, the difference in the refractive index between the high refractive index layer and the low refractive index layer is preferably within the above-described preferable range of the difference in the refractive index. However, for example, when the top surface layer is formed as a layer to protect the film, or when the bottom layer is formed as an adhesion improving layer to the substrate, the top surface layer or the bottom layer may have a structure having a difference in the refractive index outside the above-described preferable range.

In the third aspect of the present invention, the terms “high refractive index layer” and “low refractive index layer” are similar to those in the first aspect of the present invention. Therefore, the terms “high refractive index layer” and “low refractive index layer” include any form other than a form in which the refractive index layers have the same refractive index when attention is focused on two adjacent refractive index layers in the refractive index layers included in the optical reflective film.

The larger a ratio of the refractive index is, the higher the reflectivity is, because reflection on an interface between adjacent layers depends on the ratio of the refractive index between the layers. When the film is viewed in a single layer film, by a relation of an optical path difference between a ray of reflected light on the layer surface and a ray of reflected light on the layer bottom, represented by n·d=wavelength/4, control can be performed such that both rays of reflective light are enhanced to each other due to a phase difference, and the reflectivity can be increased. Here, n represents a refractive index, d represents a physical film thickness of a layer, and n·d represents an optical film thickness. By utilizing the optical path difference, reflection can be controlled. By utilizing the relation, the refractive index and the film thickness of each layer are controlled, and reflection of visible light or near infrared light is controlled. That is, the reflectivity in a specific wavelength region can be increased by the refractive index of each layer, the film thickness of each layer, and a method for laminating layers.

The optical reflective film of the third aspect of the present invention can be a visible light reflective film or a near infrared ray reflective film by changing the specific wavelength region to increase the reflectivity. That is, when the specific wavelength region to increase the reflectivity is set to a visible light region, the optical reflective film becomes a visible light reflective film. When the specific wavelength region to increase the reflectivity is set to a near infrared region, the optical reflective film becomes a near infrared ray reflective film. When the specific wavelength region to increase the reflectivity is set to an ultraviolet ray region, the optical reflective film becomes an ultraviolet ray reflective film. When the optical reflective film of the third aspect of the present invention is used for a heat shielding film, the optical reflective film is only required to be a (near) infrared reflective (shielding) film. In the case of the infrared reflective film, a multilayer film in which films having different reflective indices are laminated is formed on a polymer film. The transmittance at 550 nm in a visible light region indicated by Japanese Industrial Standard JIS R3106-1998 is preferably 50% or more, more preferably 70% or more, still more preferably 75% or more. The transmittance at 1200 nm is preferably 35% or less, more preferably 25% or less, still more preferably 20% or less. It is preferable to design the optical film thickness and the unit so as to have the transmittance within these preferable ranges. A region of the wavelength of 900 nm to 1400 nm preferably includes a region having a reflectivity of more than 50%.

Infrared region of incident spectra of light reaching directly from the sun has a relation to an increase in room temperature. By reflecting and shielding the light in the infrared region, it is possible to suppress the increase in room temperature. As for an accumulation energy ratio from the shortest wavelength (760 nm) to the longest wavelength of 3200 nm based on a weighting coefficient described in Japanese Industrial Standard JIS R 3106-1998, in the accumulation energy from 760 nm to each wavelength when the total energy in the whole infrared region from the wavelength of 760 nm to the longest wavelength of 3200 nm is assumed to be 100, the total energy from 760 to 1300 nm occupies about 75% of the total energy in the whole infrared region. Therefore, it is effective in saving energy by reflecting and shielding a heat ray to reflect and shield light in the wavelength region up to 1300 nm.

The low refractive index layer has a refractive index preferably of 1.10 to 1.60, more preferably of 1.30 to 1.50. The high refractive index layer has a refractive index preferably of 1.80 to 2.50, more preferably of 1.90 to 2.20.

The thickness (thickness after drying) per layer of the refractive index layer is preferably 20 to 1000 nm, more preferably 50 to 500 nm.

When the optical reflective film of the third aspect of the present invention is applied as an ultraviolet shielding film, the layer thickness of the high refractive index layer is preferably 10 to 500 nm, and the layer thickness of the low refractive index layer is preferably 10 to 500 nm.

The total thickness of the optical reflective film of the third aspect of the present invention is preferably 12 μm to 315 μm, more preferably 15 μm to 200 μm, still more preferably 20 μm to 100 μm.

[Layer Structure of Optical Reflective Film]

The optical reflective film includes at least one unit in which a high refractive index layer and a low refractive index layer are laminated on a substrate. The unit may be formed only on one surface of the substrate, or may be formed on both surfaces thereof. The unit is preferably formed on both surfaces of the substrate because the reflectivity of a specific wavelength is improved.

In order to add additional functions, the optical reflective film may include one or more functional layers under the substrate or on the top surface layer opposite to the substrate. Examples of the functional layer include a conductive layer, an antistatic layer, a gas barrier layer, an easily adhesive layer (adhesive layer), an antifouling layer, a deodorant layer, a drop-flowing layer, an easily slidable layer, a hard coat layer, an abrasion resistant layer, an antireflection layer, an electromagnetic wave shielding layer, an ultraviolet absorbing layer, an infrared absorbing layer, a printing layer, a fluorescent emitting layer, a hologram layer, a peeling layer, a pressure-sensitive adhesive layer, an adhesive layer, an infrared cut layer other than the high refractive index layer and the low refractive index layer (metal layer, liquid crystal layer), a colored layer (visible light absorbing layer), and an intermediate film layer to be used for laminated glass.

The order of laminating the above-described various functional layers in the optical reflective film is not particularly limited.

For example, when the optical reflective film is stuck to an interior side of window glass (inner sticking), a preferable example is as follows. That is, an optical reflective layer including at least one unit in which a high refractive index layer and a low refractive index layer are laminated, and a pressure-sensitive adhesive layer are laminated on a surface of a substrate in this order, and a hard coat layer is coated on the opposite surface of the substrate to the surface on which these layers are laminated. The order may be the pressure-sensitive adhesive layer, the substrate, the optical reflective layer, and the hard coat layer. Another functional layer, another substrate, an infrared absorber, or the like may be included. When the optical reflective film of the third aspect of the present invention is stuck to an exterior side of window glass (outer sticking), a preferable example is as follows. That is, the optical reflective layer and the pressure-sensitive adhesive layer are laminated on a surface of the substrate in this order, and the hard coat layer is coated on the opposite surface of the substrate to the surface on which these layers are laminated. As in the inner sticking, the order may be the pressure-sensitive adhesive layer, the substrate, the optical reflective layer, and the hard coat layer, and another functional layer substrate, an infrared absorber, or the like may be included.

[Application of Optical Reflective Film: Optical Reflector]

The optical reflective film of the third aspect of the present invention can be applied to a wide range of fields. That is, a preferable embodiment of the third aspect of the present invention is an optical reflector in which the optical reflective film is provided on at least one surface of a base. For example, the optical reflective film is used mainly in order to increase weather resistance as a film to be stuck to window, a film for an agricultural greenhouse, or the like. Examples of the film to be stuck to window include a heat ray reflecting film which is stuck to an apparatus (base) exposed to the sunlight for a long time, such as outdoor window of a building or car window, to impart a heat ray reflecting effect. Particularly, the optical reflective film is suitable for a member in which the optical reflective film according to the third aspect of the present invention is stuck to a base such as glass or a glass alternative resin directly or through an adhesive.

Specific examples of the base include glass described above and exemplified in the first aspect of the present invention. The kind of the resin may be any of a thermoplastic resin, a thermosetting resin, and an ionizing radiation curable resin. Two or more kinds thereof may be used in combination. The base can be manufactured by a known method such as extrusion molding, calender molding, injection molding, hollow molding, or compression molding. The thickness of the base is not particularly limited, but is usually 0.1 mm to 5 cm.

An adhesive layer or a pressure-sensitive adhesive layer to stick the optical reflective film and the base together is preferably disposed such that the optical reflective film is disposed on a side of an incident surface of the sunlight (heat ray). When the optical reflective film is sandwiched between window glass and the base, the optical reflective film can be sealed from surrounding gas such as moisture, has excellent durability, and is preferable. Even when the optical reflective film according to the third aspect of the present invention is disposed outdoors or outside a car (for outer sticking), the optical reflective film has environmental durability and is preferable.

An adhesive layer or a pressure-sensitive adhesive layer to stick the optical reflective film and the base together is preferably disposed such that the optical reflective film is disposed on a side of an incident surface of the sunlight (heat ray) when the optical reflective film is stuck to window glass or the like. When the optical reflective film is sandwiched between window glass and a substrate, the optical reflective film can be sealed from surrounding gas such as moisture and has preferable durability. Even when the optical reflective film of the third aspect of the present invention is disposed outdoors or outside a car (for outer sticking), the optical reflective film has environmental durability, and is preferable.

As the adhesive applicable to the third aspect of the present invention, an adhesive including a photocurable or thermosetting resin as a main component can be used.

An adhesive having durability to ultraviolet rays is preferable, and an acrylic pressure-sensitive adhesive or a silicone pressure-sensitive adhesive is preferable. The acrylic pressure-sensitive adhesive is more preferable in view of a pressure-sensitive adhesion property and cost. Of a solvent type and emulsion type acrylic pressure-sensitive adhesives, the solvent type acrylic pressure-sensitive adhesive is preferable because of particularly easy control of peel strength. When a solution polymerization polymer is used as the acrylic solvent pressure-sensitive adhesive, a known monomer can be used as the monomer for the polymer.

Furthermore, a polyvinyl butyral resin or an ethylene-vinyl acetate copolymer resin used as an intermediate layer of laminated glass may be used. Specific examples thereof are similar to those exemplified in the first aspect of the present invention. An ultraviolet absorber, an anti-oxidant, an antistatic agent, a heat stabilizer, a lubricant, a filler, a coloring, an adhesion control agent, or the like may be appropriately added and blended to the adhesive layer.

Thermal insulation performance or solar heat shielding performance of the optical reflective film or the infrared shield can be generally determined by a method in conformity with Japanese Industrial Standard JIS R 3209 (1998) (multi-layered glass), Japanese Industrial Standard JIS R 3106 (1998) (method for testing a transmittance, a reflectivity, an emissivity, and a solar heat gain coefficient of plate glass), or Japanese Industrial Standard JIS R 3107 (1998) (method for calculating thermal resistance of plate glass and a heat transmission coefficient in architecture).

Measurement of a solar transmittance, a solar reflectivity, an emissivity, and a visible light transmittance, calculation of the solar transmittance, the solar reflectivity, a solar absorbance, and a corrected emissivity, and calculation of a thermal insulation property and a solar heat shielding property are similar to those in the first aspect of the present invention.

### EXAMPLES

Hereinafter, the first to third aspects of the present invention will be described with Examples, but the present invention is not limited by Examples. In Examples, “part” and “%” indicate “part by weight” and “% by weight”, respectively, unless otherwise specified. Each operation is performed at room temperature (25° C.) unless otherwise specified.

### First Aspect of the Present Invention

### Synthesis Example 1-1

### Manufacture of Ethylene-Modified Polyvinyl Alcohol 1-1

Into a 100 L pressurized reaction vessel equipped with a stirrer, a nitrogen inlet, an ethylene inlet, and an initiator addition port, 29.0 kg of vinyl acetate and 31.0 kg of methanol were put. The temperature thereof was raised to 60° C. Thereafter, the inside of the system was replaced with nitrogen by bubbling with nitrogen for 30 minutes. Subsequently, ethylene was introduced such that the reaction vessel pressure was 0.5 kgf/cm². 2,2′-azobis(4-methoxy-2,4-dimethylvaleronitrile) (initiator) was dissolved in methanol to prepare an initiator solution having a concentration of 2.8 g/L. Bubbling with nitrogen gas was performed and replacement with nitrogen was performed. After the temperature inside the reaction vessel was set to 60° C., 170 mL of the above initiator solution was injected and a polymerization was started. During the polymerization, ethylene was introduced, the reaction vessel pressure was maintained at 4.1 kgf/cm², the polymerization temperature was maintained at 60° C., and the above initiator solution was continuously added at 610 mL/hr. After 10 hours, when the polymerization ratio became 70 mol %, cooling was performed and the polymerization was terminated. The reaction vessel was opened and ethylene was removed. Thereafter, ethylene was completely removed by bubbling with nitrogen gas. Subsequently, an unreacted vinyl acetate monomer was removed under reduced pressure to obtain a methanol solution of ethylene modified polyvinyl acetate (modified PVAc). Methanol was added to the solution, and a 10% methanol solution of NaOH was further added thereto to perform a saponification.

Subsequently, methyl acetate was added thereto to neutralize remaining NaOH. The resulting product was dissolved in d6-DMSO, and was analyzed at 80° C. using a proton NMR (JEOL GX-500) at 500 MHz. A content of an ethylene unit (degree of ethylene modification) was 0.5 mol %, a polymerization degree was 1700, and a saponification degree was 97 mol %. The resulting product is referred to as “ethylene-modified polyvinyl alcohol 1-1.”

### Synthesis Example 1-2

### Manufacture of Ethylene-Modified Polyvinyl Alcohol 1-2

Into a 100 L pressurized reaction vessel equipped with a stirrer, a nitrogen inlet, an ethylene inlet, and an initiator addition port, 29.0 kg of vinyl acetate and 31.0 kg of methanol were put. The temperature thereof was raised to 60° C. Thereafter, the inside of the system was replaced with nitrogen by bubbling with nitrogen for 30 minutes. Subsequently, ethylene was introduced such that the reaction vessel pressure was 0.25 kgf/cm². 2,2′-azobis(4-methoxy-2,4-dimethylvaleronitrile) (initiator) was dissolved in methanol to prepare an initiator solution having a concentration of 2.8 g/L. Bubbling with nitrogen gas was performed and replacement with nitrogen was performed. After the temperature inside the reaction vessel was set to 60° C., 170 mL of the above initiator solution was injected and a polymerization was started. During the polymerization, ethylene was introduced, the reaction vessel pressure was maintained at 4.1 kgf/cm², the polymerization temperature was maintained at 60° C., and the above initiator solution was continuously added at 610 mL/hr. After 10 hours, when the polymerization ratio became 70 mol %, cooling was performed and the polymerization was terminated. The reaction vessel was opened and ethylene was removed. Thereafter, ethylene was completely removed by bubbling with nitrogen gas. Subsequently, an unreacted vinyl acetate monomer was removed under reduced pressure to obtain a methanol solution of ethylene modified polyvinyl acetate (modified PVAc). Methanol was added to the solution, and a 10% methanol solution of NaOH was further added thereto to perform a saponification. Subsequently, methyl acetate was added thereto to neutralize remaining NaOH. The resulting product was dissolved in d6-DMSO, and was analyzed at 80° C. using a proton NMR (JEOL GX-500) at 500 MHz. A content of an ethylene unit (degree of ethylene modification) was 1 mol %, a polymerization degree was 1700, and a saponification degree was 97 mol %. The resulting product is referred to as “ethylene-modified polyvinyl alcohol 1-2.”

### Synthesis Example 1-3

### Manufacture of Ethylene-Modified Polyvinyl Alcohol 1-3

In the above Synthesis Example 1-1, the introduction pressure of ethylene was changed to manufacture ethylene-modified polyvinyl alcohol 1-3 having a content of an ethylene unit (degree of ethylene modification) of 3 mol %, a polymerization degree of 1700, and a saponification degree of 98.5 mol %.

### Synthesis Example 1-4

### Manufacture of Ethylene-Modified Polyvinyl Alcohol 1-4

In the above Synthesis Example 1-1, the introduction pressure of ethylene was changed to manufacture ethylene-modified polyvinyl alcohol 1-4 having a content of an ethylene unit (degree of ethylene modification) of 3 mol %, a polymerization degree of 1700, and a saponification degree of 92 mol %.

### Synthesis Example 1-5

### Manufacture of Ethylene-Modified Polyvinyl Alcohol 1-5

In the above Synthesis Example 1-1, the introduction pressure of ethylene was changed to manufacture ethylene-modified polyvinyl alcohol 1-5 having a content of an ethylene unit (degree of ethylene modification) of 4.5 mol %, a polymerization degree of 1000, and a saponification degree of 99.3 mol %.

### Synthesis Example 1-6

### Manufacture of Ethylene-Modified Polyvinyl Alcohol 1-6

In the above Synthesis Example 1-1, the introduction pressure of ethylene was changed to manufacture ethylene-modified polyvinyl alcohol 1-6 having a content of an ethylene unit (degree of ethylene modification) of 5.9 mol %, a polymerization degree of 400, and a saponification degree of 98.7 mol %.

### Synthesis Example 1-7

### Manufacture of Ethylene-Modified Polyvinyl Alcohol 1-7

In the above Synthesis Example 1-1, the introduction pressure of ethylene was changed to manufacture ethylene-modified polyvinyl alcohol 1-7 having a content of an ethylene unit (degree of ethylene modification) of 9.5 mol %, a polymerization degree of 1000, and a saponification degree of 98.5 mol %.

### Synthesis Example 1-8

### Manufacture of Ethylene-Modified Polyvinyl Alcohol 1-8

In the above Synthesis Example 1-1, the introduction pressure of ethylene was changed to manufacture ethylene-modified polyvinyl alcohol 1-8 having a content of an ethylene unit (degree of ethylene modification) of 10.5 mol %, a polymerization degree of 1700, and a saponification degree of 98.5 mol %.

### Synthesis Example 1-9

### Manufacture of Ethylene-Modified Polyvinyl Alcohol 1-9

In the above Synthesis Example 1-1, the introduction pressure of ethylene was changed to manufacture ethylene-modified polyvinyl alcohol 1-9 having a content of an ethylene unit (degree of ethylene modification) of 12 mol %, a polymerization degree of 1700, and a saponification degree of 96 mol %.

### Manufacture Example 1-1

### Manufacture of High Refractive Index Layer Coating Liquid 1-1

First, a titanium oxide sol dispersion liquid including rutile type titanium oxide was prepared.

(Preparation of Silica Adhesion Titanium Dioxide Sol)

To 0.5 parts by weight of a 15.0% by weight titanium oxide sol (SRD-W, volume average particle diameter: 5 nm, rutile type titanium dioxide particles, manufactured by Sakai Chemical Industry Co., Ltd.), 2 parts by weight of pure water was added, and then heated to 90° C. Subsequently, 0.5 parts by weight of a silicic acid aqueous solution (obtained by diluting sodium silicate No. 4 (manufactured by Nippon Chemical Industrial Co., Ltd.) with pure water such that a concentration of SiO₂ was 0.5% by weight) was gradually added. Subsequently, the resulting solution was heated in an autoclave at 175° C. for 18 hours. After being cooled, the resulting solution was concentrated using an ultrafiltration membrane. A titanium dioxide sol having a solid concentration of 6% by weight, to the surface of which SiO₂ adhered (hereinafter, silica adhesion titanium dioxide sol) (volume average particle diameter: 9 nm), was thereby obtained.

To 140 parts by weight of the resulting silica adhesion titanium dioxide sol (20% by weight), 48 parts by weight of a citric acid aqueous solution (1.92% by weight) was added, and 113 parts by weight of ethylene-modified polyvinyl alcohol 1-1 (8% by weight) was further added and stirred. Finally, 0.4 parts by weight of a 5% by weight aqueous solution of a surfactant (Softazoline LSB-R, manufactured by Kawaken Fine Chemicals Co., Ltd.) was added to manufacture high refractive index layer coating liquid 1-1.

### Manufacture Examples 1-2 to 1-26

### Manufacture of High Refractive Index Layer Coating Liquids 1-2 to 1-26

High refractive index layer coating liquids 1-2 to 1-26 were manufactured in a similar manner to Manufacture Example 1-1 except that ethylene-modified polyvinyl alcohols 1-2 to 1-9 and a polyvinyl alcohol (POVAL PVA 117 manufactured by Kuraray Co. Ltd., saponification degree: 99 mol %, polymerization degree: 1700) having compositions shown in the following Table 1-1 were used in place of ethylene-modified polyvinyl alcohol 1-1 in Manufacture Example 1-1.

### Manufacture Example 1-27

### Manufacture of High Refractive Index Layer Coating Liquids 1-27

A silica adhesion titanium dioxide sol was manufactured in a similar manner to Manufacture Example 1-1.

To 100 parts by weight of the resulting silica adhesion titanium dioxide sol (20% by weight), 48 parts by weight of a citric acid aqueous solution (1.92% by weight) was added, and 113 parts by weight of a polyvinyl alcohol (POVAL PVA 117 manufactured by Kuraray Co. Ltd., saponification degree: 99 mol %, polymerization degree: 1700) (8% by weight) was further added and stirred. Finally, 0.4 parts by weight of a 5% by weight aqueous solution of a surfactant (Softazoline LSB-R, manufactured by Kawaken Fine Chemicals Co., Ltd.) was added to manufacture high refractive index layer coating liquid 1-27.

### Manufacture Example 1-28

### Manufacture of High Refractive Index Layer Coating Liquid 1-28

High refractive index layer coating liquid 1-28 was manufactured in a similar manner to Manufacture Example 1-27 except that a polyvinyl alcohol (POVAL PVA 235 manufactured by Kuraray Co. Ltd., saponification degree: 87 mol %, polymerization degree: 3500) (8 by weight) was used in place of the polyvinyl alcohol (POVAL PVA 117) in Manufacture Example 1-27.

### Manufacture Example 1-29

### Manufacture of High Refractive Index Layer Coating Liquid 1-29

To 100 parts by weight of a titanium oxide sol (SRD-W, volume average particle diameter: 5 nm, rutile type titanium oxide, manufactured by Sakai Chemical Industry Co., Ltd.), 48 parts by weight of a citric acid aqueous solution (1.92%) was added, and 113 parts by weight of ethylene-modified polyvinyl alcohol 1-2 (8% by weight) was further added and stirred. Finally, 0.4 parts by weight of a 5% by weight aqueous solution of a surfactant (Softazoline LSB-R, manufactured by Kawaken Fine Chemicals Co., Ltd.) was added to manufacture high refractive index layer coating liquid 1-29.

The compositions of high refractive index layer coating liquids 1-1 to 1-26 and the compositions of high refractive index layer coating liquids 1-27 to 1-29 are shown in the following Tables 1-1 and 1-2, respectively.

TABLE 1-1

| | Ethylene-modified polyvinyl alcohol | | | | | Polyvinyl alcohol | |
|---|---|---|---|---|---|---|---|
| | | Degree of | | | | | Degree of |
| | | ethylene | | Saponification | | | ethylene |
| High refractive index | | modification | Polymerization | degree | Composition | | modification |
| layer | Name | (mol %) | degree | (mol %) | ratio | Name | (mol %) |
| Coating liquid 1-1 | Ethylene-modified | 0.5 | 1700 | 97 | 100 | PVA11.7 | 0 |
| Coating liquid 1-2 | polyvinyl alcohol 1-1 | | | | 60 | | |
| Coating liquid 1-3 | | | | | 30 | | |
| Coating liquid 1-4 | Ethylene-modified | 1 | 1700 | 97 | 100 | PVA11.7 | 0 |
| Coating liquid 1-5 | polyvinyl alcohol 1-2 | | | | 60 | | |
| Coating liquid 1-6 | | | | | 30 | | |
| Coating liquid 1-7 | Ethylene-modified | 3 | 1700 | 98.5 | 100 | PVA11.7 | 0 |
| Coating liquid 1-8 | polyvinyl alcohol 1-3 | | | | 60 | | |
| Coating liquid 1-9 | | | | | 30 | | |
| Coating liquid 1-10 | Ethylene-modified | 3 | 1700 | 92 | 100 | PVA11.7 | 0 |
| Coating liquid 1-11 | polyvinyl alcohol 1-4 | | | | 60 | | |
| Coating liquid 1-12 | Ethylene-modified | 4.5 | 1000 | 99.3 | 100 | PVA11.7 | 0 |
| Coating liquid 1-13 | polyvinyl alcohol 1-5 | | | | 60 | | |
| Coating liquid 1-14 | | | | | 30 | | |
| Coating liquid 1-15 | Ethylene-modified | 5.9 | 400 | 98.5 | 100 | PVA11.7 | 0 |
| Coating liquid 1-16 | polyvinyl alcohol 1-6 | | | | 60 | | |
| Coating liquid 1-17 | | | | | 30 | | |
| Coating liquid 1-18 | Ethylene-modified | 9.5 | 1000 | 98.5 | 100 | PVA11.7 | 0 |
| Coating liquid 1-19 | polyvinyl alcohol 1-7 | | | | 60 | | |
| Coating liquid 1-20 | | | | | 30 | | |
| Coating liquid 1-21 | Ethylene-modified | 10.5 | 1700 | 98.5 | 100 | PVA11.7 | 0 |
| Coating liquid 1-22 | polyvinyl alcohol 1-8 | | | | 60 | | |
| Coating liquid 1-23 | | | | | 30 | | |
| Coating liquid 1-24 | Ethylene-modified | 12 | 1700 | 9.6 | 100 | PVA11.7 | 0 |
| Coating liquid 1-25 | polyvinyl alcohol 1-9 | | | | 60 | | |
| Coating liquid 1-26 | | | | | 30 | | |

| | Polyvinyl alcohol | | | saponification degree of | |
|---|---|---|---|---|---|
| | | Saponification | | high refractive index | |
| High refractive index | Polymerization | degree | Composition | layer | |
| layer | degree | (mol %) | ratio | (mol %) | Fine particles |
| Coating liquid 1-1 | 1700 | 99 | 0 | 97 | Silica coated titanium oxide |
| Coating liquid 1-2 | | | 40 | 97.8 | Silica coated titanium oxide |
| Coating liquid 1-3 | | | 70 | 98.4 | Silica coated titanium oxide |
| Coating liquid 1-4 | 1700 | 99 | 0 | 97 | Silica coated titanium oxide |
| Coating liquid 1-5 | | | 40 | 97.8 | Silica coated titanium oxide |
| Coating liquid 1-6 | | | 70 | 98.4 | Silica coated titanium oxide |
| Coating liquid 1-7 | 1700 | 99 | 0 | 98.5 | Silica coated titanium oxide |
| Coating liquid 1-8 | | | 40 | 98.7 | Silica coated titanium oxide |
| Coating liquid 1-9 | | | 70 | 98.85 | Silica coated titanium oxide |
| Coating liquid 1-10 | 1700 | 99 | 0 | 92 | Silica coated titanium oxide |
| Coating liquid 1-11 | | | 40 | 94.8 | Silica coated titanium oxide |
| Coating liquid 1-12 | 1700 | 99 | 0 | 99.3 | Silica coated titanium oxide |
| Coating liquid 1-13 | | | 40 | 99.18 | Silica coated titanium oxide |
| Coating liquid 1-14 | | | 70 | 99.09 | Silica coated titanium oxide |
| Coating liquid 1-15 | 1700 | 99 | 0 | 98.5 | Silica coated titanium oxide |
| Coating liquid 1-16 | | | 40 | 98.7 | Silica coated titanium oxide |
| Coating liquid 1-17 | | | 70 | 98.85 | Silica coated titanium oxide |
| Coating liquid 1-18 | 1700 | 99 | 0 | 98.5 | Silica coated titanium oxide |
| Coating liquid 1-19 | | | 40 | 98.7 | Silica coated titanium oxide |
| Coating liquid 1-20 | | | 70 | 98.85 | Silica coated titanium oxide |
| Coating liquid 1-21 | 1700 | 99 | 0 | 98.5 | Silica coated titanium oxide |
| Coating liquid 1-22 | | | 40 | 98.7 | Silica coated titanium oxide |
| Coating liquid 1-23 | | | 70 | 98.85 | Silica coated titanium oxide |
| Coating liquid 1-24 | 1700 | 99 | 0 | 96 | Silica coated titanium oxide |
| Coating liquid 1-25 | | | 40 | 97.2 | Silica coated titanium oxide |
| Coating liquid 1-26 | | | 70 | 98.1 | Silica coated titanium oxide |

TABLE 1-2

| | Polyvinyl alcohol | | | |
|---|---|---|---|---|
| High | | | Saponification | |
| refractive | | Polymerization | degree | |
| index layer | Name | degree | (mol %) | Fine particles |
| Coating liquid | PVA117 | 1700 | 99 | Silica coated |
| 1-27 | | | | titanium oxide |
| Coating liquid | PVA235 | 3500 | 87 | Silica coated |
| 1-28 | | | | titanium oxide |
| Coating liquid | Ethylene-Modified | 1700 | 97 | Titanium oxide |
| 1-29 | Polyvinyl Alcohol 1-2 | | | |

### Manufacture Example 1-30

### Manufacture of Low Refractive Index Layer Coating Liquid 1-1

38 parts by weight of a 10% by weight aqueous solution of an acidic colloidal silica (Snowtex OXS, primary particle diameter: 5.4 nm, manufactured by Nissan Chemical Industries, Ltd.) was heated to 45° C., and 3 parts by weight of a 3% boric acid aqueous solution was added. 39 parts by weight of a 6% by weight aqueous solution of polyvinyl alcohol as a water-soluble polymer (JP-45, polymerization degree: 4500, saponification degree: 87 mol %, manufactured by Japan VAM & POVAL Co., LTD.) and 1 part by weight of a 5% by weight aqueous solution of a surfactant (Softazoline LSB-R, manufactured by Kawaken Fine Chemicals Co., Ltd.) were added at 45° C. in this order to manufacture low refractive index layer coating liquid 1-1.

### Manufacture Example 1-31

### Manufacture of Low Refractive Index Layer Coating Liquid 1-2

38 parts by weight of a 10% by weight aqueous solution of an acidic colloidal silica (Snowtex OXS, primary particle diameter: 5.4 nm, manufactured by Nissan Chemical Industries, Ltd.) was heated to 45° C., and 3 parts by weight of a 3% boric acid aqueous solution was added. 39 parts by weight of a 6% by weight aqueous solution of polyvinyl alcohol as a water-soluble polymer (PVA624, polymerization degree: 2400, saponification degree: 95 mol %, manufactured by Kuraray Co. Ltd.) and 1 part by weight of a 5% by weight aqueous solution of a surfactant (Softazoline LSB-R, manufactured by Kawaken Fine Chemicals Co., Ltd.) were added at 45° C. in this order to manufacture low refractive index layer coating liquid 1-2.

### Examples 1-1 to 1-19 and Comparative Examples 1-1 to 1-11

Simultaneous multilayer coating of each of the high refractive index layer coating liquids 1-1 to 1-29 shown in Table 1-1 or 1-2 and the low refractive index layer coating liquid 1-1 or 1-2 was performed on a polyethylene terephthalate film (A4300 manufactured by Toyobo Co., Ltd., double-sided easily adhesive layer) heated to 40° C. and having a width of 160 mm and a thickness of 50 μm using a slide hopper coating device capable of performing nine-layer multilayer coating. In the simultaneous multilayer coating, coating of nine layers in total was performed such that the bottom layer and the top layer were low refractive index layers, and the other layers were alternate low refractive index layers (each layer has a thickness of 150 nm when being dried) and high refractive index layers (each layer has a thickness of 130 nm when being dried). Immediately after coating, setting was performed by blowing cool air at 10° C. At this time, a period of time (setting time) until nothing was stuck to a finger when the surface was touched by the finger, was 10 seconds.

After completion of setting, drying was performed by blowing warm air at 60° C. to manufacture optical reflective films 1-1 to 1-19 and comparative optical reflective films 1-1 to 1-11 each including nine layers in total. The temperature of the high refractive index layer coating liquid or the low refractive index layer coating liquid was adjusted to 40° C.

### Example 1-20

High refractive index layer coating liquid 1-4 and low refractive index layer coating liquid 1-2 were sequentially laminated one by one on a polyethylene terephthalate film (A4300 manufactured by Toyobo Co., Ltd., double-sided easily adhesive layer) heated to 40° C. and having a width of 160 mm and a thickness of 50 μm using a slide hopper coating device. The sequential laminating was performed such that the bottom layer and the top layer were low refractive index layers, and the other layers were alternate low refractive index layers (each layer has a thickness of 150 nm when being dried) and high refractive index layers (each layer has a thickness of 130 nm when being dried). Thereafter, drying was performed by blowing warm air at 60° C. to manufacture optical reflective film 1-20 including nine layers.

Evaluation

The number of color bleeding (number/m), a haze (%), and a reflectivity (%) of each of optical reflective films 1-1 to 1-20 obtained in Examples 1-1 to 1-20 and comparative optical reflective films 1-1 to 1-11 obtained in Comparative Examples 1-1 to 1-11 were measured according to the following method. Results are shown in Table 1-3 below.

(Evaluation of the Number of Color Bleeding)

A coating sample 160 mm×3000 m was observed visually. The number of color bleeding was counted. The average number of color bleeding per 100 m was measured, and the number of color bleeding per m was calculated.

(Measurement of Maximum Near Infrared Reflectivity)

Using a spectrometer (U-4000 type using an integrating sphere, manufactured by Hitachi, Ltd.), a 45° reflectivity (%) of the sample in a region of 300 nm to 2000 nm was measured for each ray reflective film. The highest reflectivity (%) of the measurement results in a region of 900 to 1500 nm was used as the maximum reflectivity.

(Measurement of Haze)

A haze of each of optical reflective films 1-1 to 1-20 obtained in Examples 1-1 to 1-20 and comparative optical reflective films 1-1 to 1-11 obtained in Comparative Examples 1-1 to 1-11 was measured using a haze meter (NDH2000 manufactured by Denshoku Industries, Co., Ltd.). A halogen bulb of 5V9W was used as a light source of the haze meter. A silicone photocell (with a relative luminous sensitivity filter) was used for a light receiver. The haze was measured at 23° C. at 55% RH.

TABLE 1-3

| | | High refractive index layer | |
|---|---|---|---|
| | Manufacturing Method | coating liquid | Low refractive index layer coating liquid |
| Example 1-1 | Simultaneous multilayer coating | Coating liquid 1-4 | Low refractive index layer coating liquid 1-1 |
| Example 1-2 | Simultaneous multilayer coating | Coating liquid 1-5 | Low refractive index layer coating liquid 1-1 |
| Example 1-3 | Simultaneous multilayer coating | Coating liquid 1-6 | Low refractive index layer coating liquid 1-1 |
| Example 1-4 | Simultaneous multilayer coating | Coating liquid 1-7 | Low refractive index layer coating liquid 1-1 |
| Example 1-5 | Simultaneous multilayer coating | Coating liquid 1-8 | Low refractive index layer coating liquid 1-1 |
| Example 1-6 | Simultaneous multilayer coating | Coating liquid 1-9 | Low refractive index layer coating liquid 1-1 |
| Example 1-7 | Simultaneous multilayer coating | Coating liquid 1-10 | Low refractive index layer coating liquid 1-1 |
| Example 1-8 | Simultaneous multilayer coating | Coating liquid 1-11 | Low refractive index layer coating liquid 1-1 |
| Example 1-9 | Simultaneous multilayer coating | Coating liquid 1-12 | Low refractive index layer coating liquid 1-1 |
| Example 1-10 | Simultaneous multilayer coating | Coating liquid 1-13 | Low refractive index layer coating liquid 1-1 |
| Example 1-11 | Simultaneous multilayer coating | Coating liquid 1-14 | Low refractive index layer coating liquid 1-1 |
| Example 1-12 | Simultaneous multilayer coating | Coating liquid 1-15 | Low refractive index layer coating liquid 1-1 |
| Example 1-13 | Simultaneous multilayer coating | Coating liquid 1-16 | Low refractive index layer coating liquid 1-1 |
| Example 1-14 | Simultaneous multilayer coating | Coating liquid 1-17 | Low refractive index layer coating liquid 1-1 |
| Example 1-15 | Simultaneous multilayer coating | Coating liquid 1-18 | Low refractive index layer coating liquid 1-1 |
| Example 1-16 | Simultaneous multilayer coating | Coating liquid 1-19 | Low refractive index layer coating liquid 1-1 |
| Example 1-17 | Simultaneous multilayer coating | Coating liquid 1-20 | Low refractive index layer coating liquid 1-1 |
| Example 1-18 | Simultaneous multilayer coating | Coating liquid 1-4 | Low refractive index layer coating liquid 1-2 |
| Example 1-19 | Simultaneous multilayer coating | Coating liquid 1-29 | Low refractive index layer coating liquid 1-1 |
| Example 1-20 | Sequential multilayer | Coating liquid 1-4 | Low refractive index layer coating liquid 1-1 |
| Comparative Example 1-1 | Simultaneous multilayer coating | Coating liquid 1-1 | Low refractive index layer coating liquid 1-1 |
| Comparative Example 1-2 | Simultaneous multilayer coating | Coating liquid 1-2 | Low refractive index layer coating liquid 1-1 |
| Comparative Example 1-3 | Simultaneous multilayer coating | Coating liquid 1-3 | Low refractive index layer coating liquid 1-1 |
| Comparative Example 1-4 | Simultaneous multilayer coating | Coating liquid 1-21 | Low refractive index layer coating liquid 1-1 |
| Comparative Example 1-5 | Simultaneous multilayer coating | Coating liquid 1-22 | Low refractive index layer coating liquid 1-1 |
| Comparative Example 1-6 | Simultaneous multilayer coating | Coating liquid 1-23 | Low refractive index layer coating liquid 1-1 |
| Comparative Example 1-7 | Simultaneous multilayer coating | Coating liquid 1-24 | Low refractive index layer coating liquid 1-1 |
| Comparative Example 1-8 | Simultaneous multilayer coating | Coating liquid 1-25 | Low refractive index layer coating liquid 1-1 |
| Comparative Example 1-9 | Simultaneous multilayer coating | Coating liquid 1-26 | Low refractive index layer coating liquid 1-1 |
| Comparative Example 1-10 | Simultaneous multilayer coating | Coating liquid 1-27 | Low refractive index layer coating liquid 1-1 |
| Comparative Example 1-11 | Simultaneous multilayer coating | Coating liquid 1-28 | Low refractive index layer coating liquid 1-1 |

| | Difference in saponification | The number of color | | |
|---|---|---|---|---|
| | degree (mol %) | bleeding/m | Haze (%) | Reflectivity (%) |
| Example 1-1 | 10 | 0.018 | 1.2 | 45 |
| Example 1-2 | 10.8 | 0.028 | 1.5 | 44 |
| Example 1-3 | 11.4 | 0.036 | 1.7 | 43 |
| Example 1-4 | 11.5 | 0.012 | 0.85 | 54 |
| Example 1-5 | 11.7 | 0.021 | 1 | 53 |
| Example 1-6 | 11.85 | 0.03 | 1.1 | 52 |
| Example 1-7 | 5 | 0.011 | 2.3 | 43 |
| Example 1-8 | 7.8 | 0.03 | 2.5 | 41 |
| Example 1-9 | 12.3 | 0.013 | 0.95 | 51 |
| Example 1-10 | 12.18 | 0.023 | 1.12 | 49 |
| Example 1-11 | 12.09 | 0.029 | 1.5 | 47 |
| Example 1-12 | 11.5 | 0.04 | 1.6 | 44 |
| Example 1-13 | 11.7 | 0.048 | 1.9 | 43 |
| Example 1-14 | 11.85 | 0.06 | 2.1 | 42 |
| Example 1-15 | 11.5 | 0.021 | 1.8 | 47 |
| Example 1-16 | 1.7 | 0.026 | 2.5 | 46 |
| Example 1-17 | 11.85 | 0.037 | 2.8 | 45 |
| Example 1-18 | 2 | 0.026 | 2.1 | 39 |
| Example 1-19 | 10 | 0.032 | 2.2 | 43 |
| Example 1-20 | 10 | 0.04 | 2.4 | 36 |
| Comparative Example 1-1 | 10 | 1.1 | 3.2 | 27 |
| Comparative Example 1-2 | 10.8 | 3 | 3.5 | 26 |
| Comparative Example 1-3 | 11.4 | 5 | 3.9 | 24 |
| Comparative Example 1-4 | 9 | 5 | 2.9 | 26 |
| Comparative Example 1-5 | 10.2 | 6 | 3.2 | 25 |
| Comparative Example 1-6 | 11.1 | 8 | 3.4 | 23 |
| Comparative Example 1-7 | 9 | 6 | 3.3 | 25 |
| Comparative Example 1-8 | 10.2 | 7 | 3.6 | 23 |
| Comparative Example 1-9 | 11.1 | 10 | 3.9 | 21 |
| Comparative Example 1-10 | 12 | 1.5 | 1.5 | 49 |
| Comparative Example 1-11 | 0 | 12 | 7 | 11 |

The above Table 1-3 indicates that the number of color bleeding in optical reflective films 1-1 to 1-20 of the first aspect of the present invention is significantly less than that in comparative optical reflective films 1-1 to 1-11. In addition, it is indicated that optical reflective films 1-1 to 1-20 of the first aspect of the present invention have a significantly lower haze and a significantly higher reflectivity than comparative optical reflective films 1-1 to 1-11.

### Second Aspect of the Present Invention

In the second aspect of the present invention, specific gravities of components included in the high refractive index layer and the low refractive index layer are as follows. titanium oxide: 4 g/cm³, silica: 2 g/cm³, citric acid: 1.665 g/cm³, polyvinyl alcohol and ethylene-modified polyvinyl alcohol: 4 g/cm³, boric acid: 1.435 g/cm³, zirconium oxide: 6.05 g/cm³.

### Manufacture Example 2-1

### Manufacture of High Refractive Index Layer Coating Liquid 2-1

First, a silica adhesion titanium dioxide sol including rutile type titanium dioxide was prepared.

(Preparation of Silica Adhesion Titanium Dioxide Sol)

To 0.5 parts by weight of a 15.0% by weight titanium oxide sol (SRD-W, volume average particle diameter: 5 nm, rutile type titanium dioxide particles, manufactured by Sakai Chemical Industry Co., Ltd.), 2 parts by weight of pure water was added, and then heated to 90° C. Subsequently, 0.5 parts by weight of a silicic acid aqueous solution (obtained by diluting sodium silicate No. 4 (manufactured by Nippon Chemical Industrial Co., Ltd.) with pure water such that a concentration of SiO₂ was 0.5% by weight) was gradually added. Subsequently, the resulting solution was heated in an autoclave at 175° C. for 18 hours. After being cooled, the resulting solution was concentrated using an ultrafiltration membrane. A titanium dioxide sol having a solid concentration of 6% by weight, to the surface of which SiO₂ adhered (hereinafter, silica adhesion titanium dioxide sol) (volume average particle diameter: 9 nm), was thereby obtained.

To 113 parts by weight of the resulting silica adhesion titanium dioxide sol (20% by weight), 48 parts by weight of a citric acid aqueous solution (1.92% by weight) was added, and 113 parts by weight of ethylene-modified polyvinyl alcohol (EXCEVAL RS-2117 manufactured by Kuraray Co., Ltd., polymerization degree: 1700, saponification degree: 98.0 mol %, 8% by weight) was further added and stirred. Finally, 0.4 parts by weight of a 5% by weight aqueous solution of a surfactant (Softazoline LSB-R, manufactured by Kawaken Fine Chemicals Co., Ltd.) was added to manufacture high refractive index layer coating liquid 2-1.

### Manufacture Example 2-2

### Manufacture of High Refractive Index Layer Coating Liquid 2-2

High refractive index layer coating liquid 2-2 was manufactured in a similar manner to Manufacture Example 2-1 except that the addition amount of the silica adhesion titanium dioxide sol was changed to 140 parts by weight in Manufacture Example 2-1.

### Manufacture Example 2-3

### Manufacture of High Refractive Index Layer Coating Liquid 2-3

High refractive index layer coating liquid 2-3 was manufactured in a similar manner to Manufacture Example 2-1 except that the addition amount of the silica adhesion titanium dioxide sol was changed to 169 parts by weight in Manufacture Example 2-1.

### Manufacture Example 2-4

### Manufacture of High Refractive Index Layer Coating Liquid 2-4

High refractive index layer coating liquid 2-4 was manufactured in a similar manner to Manufacture Example 2-2 except that the ethylene-modified polyvinyl alcohol (RS-2117) was changed to EXCEVAL RS-1117 manufactured by Kuraray Co., Ltd., (ethylene-modified polyvinyl alcohol, polymerization degree: 1700, saponification degree: 98.0 mol %, 8% by weight) in Manufacture Example 2-2.

### Manufacture Example 2-5

### Manufacture of High Refractive Index Layer Coating Liquid 2-5

High refractive index layer coating liquid 2-5 was manufactured in a similar manner to Manufacture Example 2-2 except that the ethylene-modified polyvinyl alcohol (RS-2117) was changed to EXCEVAL RS-2817 manufactured by Kuraray Co., Ltd., (ethylene-modified polyvinyl alcohol, polymerization degree: 1700, saponification degree: 96.5 mol %, 8% by weight) in Manufacture Example 2-2.

### Manufacture Example 2-6

### Manufacture of High Refractive Index Layer Coating Liquid 2-6

High refractive index layer coating liquid 2-6 was manufactured in a similar manner to Manufacture Example 2-2 except that the ethylene-modified polyvinyl alcohol (RS-2117) was changed to EXCEVAL RS-1717 manufactured by Kuraray Co., Ltd., (ethylene-modified polyvinyl alcohol, polymerization degree: 1700, saponification degree: 93.0 mol %, 8% by weight) in Manufacture Example 2-2.

### Manufacture Example 2-7

### Manufacture of High Refractive Index Layer Coating Liquid 2-7

High refractive index layer coating liquid 2-7 was manufactured in a similar manner to Manufacture Example 2-2 except that the ethylene-modified polyvinyl alcohol (RS-2117) was changed to a polyvinyl alcohol (POVAL PVA-124 manufactured by Kuraray Co., Ltd., polymerization degree: 2400, saponification degree: 99.0 mol %, 8% by weight) in Manufacture Example 2-2.

### Manufacture Example 2-8

### Manufacture of High Refractive Index Layer Coating Liquid 2-8

High refractive index layer coating liquid 2-8 was manufactured in a similar manner to Manufacture Example 2-1 except that an addition amount of RS-2117 as an ethylene-modified polyvinyl alcohol was changed to 98 parts by weight in Manufacture Example 2-1.

### Manufacture Example 2-9

### Manufacture of High Refractive Index Layer Coating Liquid 2-9

High refractive index layer coating liquid 2-9 was manufactured in a similar manner to Manufacture Example 2-1 except that an addition amount of RS-2117 as an ethylene-modified polyvinyl alcohol was changed to 181 parts by weight in Manufacture Example 2-1.

### Manufacture Example 2-10

### Manufacture of High Refractive Index Layer Coating Liquid 2-10

High refractive index layer coating liquid 2-10 was manufactured in a similar manner to Manufacture Example 2-1 except that the ethylene-modified polyvinyl alcohol was changed to a polyvinyl alcohol (POVAL PVA-235 manufactured by Kuraray Co., Ltd., polymerization degree: 3500, saponification degree: 87.0 mol %, 8% by weight) in Manufacture Example 2-1.

### Manufacture Example 2-11

### Manufacture of High Refractive Index Layer Coating Liquid 2-11

High refractive index layer coating liquid 2-11 was manufactured in a similar manner to Manufacture Example 2-1 except that the silica adhesion titanium dioxide sol was changed to a zirconia sol (NANOUSE ZR-30AH manufactured by Nissan Chemical Industries, Ltd., concentration 20%) and an addition amount thereof was changed to 225 parts by weight in Manufacture Example 2-1.

### Manufacture Example 2-12

### Manufacture of Low Refractive Index Layer Coating Liquid 2-1

31 parts by weight of a 10% by weight aqueous solution of an acidic colloidal silica (Snowtex OXS, primary particle diameter: 5.4 nm, manufactured by Nissan Chemical Industries, Ltd.) was heated to 40° C., and 3 parts by weight of a 3% boric acid aqueous solution was added. 39 parts by weight of a 6% by weight aqueous solution of polyvinyl alcohol as a water-soluble polymer (PVA-235, polymerization degree: 3500, saponification degree: 87.0 mol %, manufactured by Kuraray Co. Ltd.) and 1 part by weight of a 5% by weight aqueous solution of a surfactant (Softazoline LSB-R, manufactured by Kawaken Fine Chemicals Co., Ltd.) were added at 40° C. in this order to manufacture low refractive index layer coating liquid 2-1.

### Manufacture Example 2-13

### Manufacture of Low Refractive Index Layer Coating Liquid 2-2

Low refractive index layer coating liquid 2-2 was manufactured in a similar manner to Manufacture Example 2-12 except that the polyvinyl alcohol was changed from PVA-235 to PVA-624 (manufactured by Kuraray Co., Ltd., polymerization degree: 2400, saponification degree: 95.0 mol %) in Manufacture Example 2-12.

### Manufacture Example 2-14

### Manufacture of Low Refractive Index Layer Coating Liquid 2-3

The addition amount of the acidic colloidal silica was changed to 39 parts by weight from Manufacture Example 2-1, and PVA-235 was changed to RS-2117 to manufacture low refractive index layer coating liquid 2-3.

### Examples 2-1 to 2-6 and Comparative Examples 2-1 to 2-6

Simultaneous multilayer coating of each of high refractive index layer coating liquids 2-1 to 2-11 shown in Table 2-1 and each of low refractive index layer coating liquid 2-1 to 2-3 was performed on a polyethylene terephthalate film (A4300 manufactured by Toyobo Co., Ltd., double-sided easily adhesive layer) heated to 40° C. and having a width of 160 mm and a thickness of 50 μm using a slide hopper coating device capable of performing nine-layer multilayer coating. In the simultaneous multilayer coating, coating of nine layers in total was performed such that the bottom layer and the top layer were low refractive index layers, and the other layers were alternate low refractive index layers (each layer has a thickness of 150 nm when being dried) and high refractive index layers (each layer has a thickness of 130 nm when being dried). Immediately after coating, setting (thickening) was performed by blowing cool air at 10° C.

After completion of the setting (thickening), drying was performed by blowing warm air at 60° C. to manufacture optical reflective films of Examples 2-1 to 2-6 and comparative optical reflective films of Comparative Examples 2-1 to 2-6 each including nine layers in total. The temperature of the high refractive index layer coating liquid or the low refractive index layer coating liquid was adjusted to 40° C.

### Example 2-7

High refractive index layer coating liquid 2-2 and low refractive index layer coating liquid 2-1 were sequentially laminated one by one on a polyethylene terephthalate film (A4300 manufactured by Toyobo Co., Ltd., double-sided easily adhesive layer) heated to 40° C. and having a width of 160 mm and a thickness of 50 μm using a slide hopper coating device. The sequential laminating was performed such that the bottom layer and the top layer were low refractive index layers, and the other layers were alternate low refractive index layers (each layer has a thickness of 150 nm when being dried) and high refractive index layers (each layer has a thickness of 130 nm when being dried). Thereafter, drying was performed by blowing warm air at 60° C. to manufacture an optical reflective film including nine layers of Example 2-7.

Evaluation

Curling of the optical reflective films obtained in Examples 2-1 to 2-7 and the comparative optical reflective films obtained in Comparative Examples 2-1 to 2-6 was evaluated, and bending tests thereof were measured according to the following method. Results are shown in Table 2-1 below.

(Evaluation of Curling)

An optical reflective film was cut out with 10 cm×10 cm. The cut out optical reflective film was put on a flat desk, and a degree of curling was evaluated visually.

4: Floating of curling is hardly observed.

3: Floating of curling is observed in some parts.

2: Floating of curling is large.

1: Floating of curling is tubular.

(Bending Test)

The bending test was performed by an IPC bending test in conformity with IPC standard TM-650. In this test, a laminated film is sandwiched between a fixed plate and a movable plate while the laminated film is bent such that the surface of the laminated film projects, and the movable plate is moved repeatedly. R of the film was set to 10 mm, a stroke was set to 60 mm, and the repeating number was 30.

4: No line, crack, or peeling is observed on the surface.

3: No crack or peeling is observed, but lines are observed in some parts on the surface.

2: Crack or peeling is observed on the surface.

1: Crack or peeling is clearly observed on the surface.

TABLE 2-1

| | | High refractive index layer | | | | |
|---|---|---|---|---|---|---|
| | | | | | Inorganic oxide | |
| | | | Binder | | particles | |
| | | | | Saponification | | Content |
| | | Coating | | degree | | (% by |
| | Manufacturing Method | liquid | Kind | (mol %) | Kind | volume) |
| Example 2-1 | Simultaneous multilayer | 2-1 | RS-2117 | 98.0 | Titanium | 40 |
| | coating | | | | oxide | |
| Example 2-2 | Simultaneous multilayer | 2-2 | RS-2117 | 98.0 | Titanium | 50 |
| | coating | | | | oxide | |
| Example 2-3 | Simultaneous multilayer | 2-3 | RS-2117 | 98.0 | Titanium | 60 |
| | coating | | | | oxide | |
| Example 2-4 | Simultaneous multilayer | 2-2 | RS-2117 | 98.0 | Titanium | 50 |
| | coating | | | | oxide | |
| Example 2-5 | Simultaneous multilayer | 2-4 | RS-1117 | 98.0 | Titanium | 50 |
| | coating | | | | oxide | |
| Example 2-6 | Simultaneous multilayer | 2-5 | RS-2817 | 96.5 | Titanium | 50 |
| | coating | | | | oxide | |
| Example 2-7 | Sequential multilayer | 2-2 | RS-2117 | 98.0 | Titanium | 50 |
| | coating | | | | oxide | |
| Comparative | Simultaneous multilayer | 2-6 | RS-1717 | 93.0 | Titanium | 50 |
| Example 2-1 | coating | | | | oxide | |
| Comparative | Simultaneous multilayer | 2-7 | PVA-124 | 99.0 | Titanium | 50 |
| Example 2-2 | coating | | | | oxide | |
| Comparative | Simultaneous multilayer | 2-8 | RS-2117 | 98.0 | Titanium | 35 |
| Example 2-3 | coating | | | | oxide | |
| Comparative | Simultaneous multilayer | 2-9 | RS-2117 | 98.0 | Titanium | 65 |
| Example 2-4 | coating | | | | oxide | |
| Comparative | Simultaneous multilayer | 2-10 | PVA-235 | 87.0 | Titanium | 40 |
| Example 2-5 | coating | | | | oxide | |
| Comparative | Simultaneous multilayer | 2-11 | RS-2117 | 98.0 | Zirconium | 50 |
| Example 2-6 | coating | | | | oxide | |

| | Low refractive index layer | | | | | | |
|---|---|---|---|---|---|---|---|
| | | | | Inorganic oxide | | | |
| | | Binder | | particles | | | |
| | | | Saponification | | Content | Evaluation | |
| | Coating | | degree | | (% by | Evaluation | Folding |
| | liquid | Kind | (mol %) | Kind | volume) | of curling | resistance |
| Example 2-1 | 2-1 | PVA-235 | 87.0 | Silica | 40 | 3 | 4 |
| Example 2-2 | 2-1 | PVA-235 | 87.0 | Silica | 40 | 4 | 4 |
| Example 2-3 | 2-1 | PVA-235 | 87.0 | Silica | 40 | 4 | 3 |
| Example 2-4 | 2-2 | PVA-624 | 95.0 | Silica | 40 | 3 | 3 |
| Example 2-5 | 2-1 | PVA-235 | 87.0 | Silica | 40 | 3 | 4 |
| Example 2-6 | 2-1 | PVA-235 | 87.0 | Silica | 40 | 3 | 4 |
| Example 2-7 | 2-1 | PVA-235 | 87.0 | Silica | 40 | 4 | 3 |
| Comparative | 2-1 | PVA-235 | 87.0 | Silica | 40 | 1 | 1 |
| Example 2-1 | | | | | | | |
| Comparative | 2-1 | PVA-235 | 87.0 | Silica | 40 | 2 | 2 |
| Example 2-2 | | | | | | | |
| Comparative | 2-1 | PVA-235 | 87.0 | Silica | 40 | 2 | 3 |
| Example 2-3 | | | | | | | |
| Comparative | 2-1 | PVA-235 | 87.0 | Silica | 40 | 3 | 2 |
| Example 2-4 | | | | | | | |
| Comparative | 2-3 | RS-2117 | 98.0 | Silica | 50 | 2 | 2 |
| Example 2-5 | | | | | | | |
| Comparative | 2-1 | PVA-235 | 87.0 | Silica | 40 | 2 | 2 |
| Example 2-6 | | | | | | | |

From the above Table 2-1, in the optical reflective films in Examples 2-1 to 2-7 of the second aspect of the present invention, occurrence of curling is suppressed more and the folding resistance is higher than the comparative optical reflective films in Comparative Examples 2-1 to 2-6. The reason is considered to be as follows. That is, curling and crack or peeling of the film when the film was folded were improved because the strength of the laminated film was improved and water absorption was suppressed due to an interaction between titanium oxide and an ethylene-modified polyvinyl alcohol. Comparison among Examples 2-1 to 2-3 makes it clear that there is such a tendency that, within a range of 40 to 60% by volume of the content of the titanium oxide particles in the high refractive index layer, the higher the content of the titanium oxide particles is, the more curling is improved and the more the folding resistance is improved.

### Third Aspect of the Present Invention

### 1. Manufacture of Alkylene-Modified Polyvinyl Alcohol

### Synthesis Example 3-1

### Manufacture of Alkylene-Modified Polyvinyl Alcohol 3-1

Into a 100 L pressurized reaction vessel equipped with a stirrer, a nitrogen inlet, an olefin gas inlet, and an initiator addition port, 29.0 kg of vinyl acetate and 31.0 kg of methanol were put. The temperature thereof was raised to 60° C. Thereafter, the inside of the system was replaced with nitrogen by bubbling with nitrogen for 30 minutes. Subsequently, ethylene was introduced such that the reaction vessel pressure was 2.5 kgf/cm². 2,2′-azobis(4-methoxy-2,4-dimethylvaleronitrile) as an initiator was dissolved in methanol to prepare an initiator solution having a concentration of 2.8 g/L. Bubbling with nitrogen gas was performed and replacement with nitrogen was performed. After the temperature inside the reaction vessel was set to 60° C., 170 mL of the above initiator solution was injected and a polymerization was started. During the polymerization, ethylene was introduced, the reaction vessel pressure was maintained at 4.1 kgf/cm², the polymerization temperature was maintained at 60° C., and the above initiator solution was continuously added at 610 mL/hr. After 10 hours, when the polymerization ratio became 70 mol %, cooling was performed and the polymerization was terminated. The remaining ethylene in the reaction vessel was opened. Thereafter, ethylene was completely removed by bubbling with nitrogen gas. Subsequently, an unreacted vinyl acetate monomer was removed under reduced pressure to obtain a methanol solution of ethylene modified polyvinyl acetate. Methanol was added to the solution, and a 10% methanol solution of sodium hydroxide was further added thereto. When a desired saponification degree was obtained, methyl acetate was added thereto to neutralize remaining sodium hydroxide.

The resulting product was dissolved in d6-DMSO (dimethyl sulfoxide), and was analyzed at 80° C. using a proton NMR (JEOL GX-500) at 500 MHz. A degree of alkylene modification (copolymerization amount of ethylene) was 5 mol %. When a relative viscosity was calculated from a viscosity of an aqueous solution of a product which had been completely saponified using sodium hydroxide, and an average polymerization degree was further calculated, the average polymerization degree was 1700. When the resulting product was dissolved in water, a carbonyloxy group was quantified using sodium hydroxide, and a saponification degree was determined by subtracting the above degree of alkylene modification (mol %) and the carbonyloxy group (mol %) from 100, the saponification degree was 98 mol %.

### Synthesis Example 3-2

### Synthesis of Alkylene-Modified Polyvinyl Alcohol 3-2

Alkylene-modified polyvinyl alcohol 3-2 was synthesized in a similar manner to the synthesis of alkylene-modified polyvinyl alcohol 3-1, except that the introduction pressure of ethylene used in the synthesis of alkylene-modified polyvinyl alcohol 3-1 was changed. The degree of alkylene modification (copolymerization amount of ethylene) was 12 mol %. The polymerization degree was 1700, and the saponification degree was 98 mol %.

### Synthesis Example 3-3

### Synthesis of Alkylene-Modified Polyvinyl Alcohol 3-3

Alkylene-modified polyvinyl alcohol 3-3 was synthesized in a similar manner to the synthesis of alkylene-modified polyvinyl alcohol 3-1, except that ethylene used in the synthesis of alkylene-modified polyvinyl alcohol 3-1 was changed to propylene and the introduction pressure was changed. The degree of alkylene modification (copolymerization amount of propylene) was 5 mol %. The polymerization degree was 1700, and the saponification degree was 98 mol %.

### Synthesis Example 3-4

### Synthesis of Alkylene-Modified Polyvinyl Alcohol 3-4

Alkylene-modified polyvinyl alcohol 3-4 was synthesized in a similar manner to the synthesis of alkylene-modified polyvinyl alcohol 3-3, except that the introduction pressure of propylene used in the synthesis of alkylene-modified polyvinyl alcohol 3-3 was changed. The degree of alkylene modification (copolymerization amount of propylene) was 12 mol %. The polymerization degree was 1700, and the saponification degree was 98 mol %.

### Synthesis Example 3-5

### Synthesis of Alkylene-Modified Polyvinyl Alcohol 3-5

Alkylene-modified polyvinyl alcohol 3-5 was synthesized in a similar manner to the synthesis of alkylene-modified polyvinyl alcohol 3-1, except that the introduction pressure of ethylene used in the synthesis of alkylene-modified polyvinyl alcohol 3-1 was changed. The degree of alkylene modification (copolymerization amount of ethylene) was 3 mol %. The polymerization degree was 1700, and the saponification degree was 98 mol %.

### Synthesis Example 3-6

### Synthesis of Alkylene-Modified Polyvinyl Alcohol 3-6

Alkylene-modified polyvinyl alcohol 3-6 was synthesized in a similar manner to the synthesis of alkylene-modified polyvinyl alcohol 3-1, except that the concentration of the initiator solution used in the synthesis of alkylene-modified polyvinyl alcohol 3-1 was changed to 3.6 g/L. The degree of alkylene modification (copolymerization amount of ethylene) was 5 mol %. The polymerization degree was 1300, and the saponification degree was 98 mol %.

### Synthesis Example 3-7

### Synthesis of Alkylene-Modified Polyvinyl Alcohol 3-7

Alkylene-modified polyvinyl alcohol 3-7 was synthesized in a similar manner to the synthesis of alkylene-modified polyvinyl alcohol 3-6, except that the introduction pressure of ethylene used in the synthesis of alkylene-modified polyvinyl alcohol 3-6 was changed. The degree of alkylene modification (copolymerization amount of ethylene) was 3 mol %. The polymerization degree was 1300, and the saponification degree was 97.5 mol %.

### Synthesis Example 3-8

### Synthesis of Alkylene-Modified Polyvinyl Alcohol 3-8

Alkylene-modified polyvinyl alcohol 3-8 was synthesized in a similar manner to the synthesis of alkylene-modified polyvinyl alcohol 3-5, except that the saponification reaction time was shorter than that used in the synthesis of alkylene-modified polyvinyl alcohol 3-5. The degree of alkylene modification (copolymerization amount of ethylene) was 3 mol %. The polymerization degree was 1700, and the saponification degree was 93 mol %.

### Synthesis Example 3-9

### Synthesis of Alkylene-Modified Polyvinyl Alcohol 3-9

Alkylene-modified polyvinyl alcohol 3-9 was synthesized in a similar manner to the synthesis of alkylene-modified polyvinyl alcohol 3-6, except that the saponification reaction time was shorter than that used in the synthesis of alkylene-modified polyvinyl alcohol 3-6. The degree of alkylene modification (copolymerization amount of ethylene) was 5 mol %. The polymerization degree was 1300, and the saponification degree was 93 mol %.

### Synthesis Example 3-10

### Synthesis of Alkylene-Modified Polyvinyl Alcohol 3-10

Alkylene-modified polyvinyl alcohol 3-10 was synthesized in a similar manner to the synthesis of alkylene-modified polyvinyl alcohol 3-9, except that the introduction pressure of ethylene used in the synthesis of alkylene-modified polyvinyl alcohol 3-9 was changed. The degree of alkylene modification (copolymerization amount of ethylene) was 3 mol %. The polymerization degree was 1300, and the saponification degree was 93 mol %.

### Synthesis Example 3-11

### Synthesis of Alkylene-Modified Polyvinyl Alcohol 3-11

Alkylene-modified polyvinyl alcohol 3-11 was synthesized in a similar manner to the synthesis of alkylene-modified polyvinyl alcohol 3-7, except that ethylene used in the synthesis of alkylene-modified polyvinyl alcohol 3-7 was changed to propylene. The degree of alkylene modification (copolymerization amount of propylene) was 3 mol %. The polymerization degree was 1300, and the saponification degree was 97.5 mol %.

### Synthesis Example 3-12

### Synthesis of Alkylene-Modified Polyvinyl Alcohol 3-12

Alkylene-modified polyvinyl alcohol 3-10 was synthesized in a similar manner to the synthesis of alkylene-modified polyvinyl alcohol 3-7, except that the introduction pressure of ethylene used in the synthesis of alkylene-modified polyvinyl alcohol 3-7 was changed. The degree of alkylene modification (copolymerization amount of ethylene) was 12 mol %. The polymerization degree was 1300, and the saponification degree was 97.5 mol %.

### Synthesis Example 3-13

### Synthesis of Alkylene-Modified Polyvinyl Alcohol 3-13

Alkylene-modified polyvinyl alcohol 3-13 was synthesized in a similar manner to the synthesis of alkylene-modified polyvinyl alcohol 3-11, except that the introduction pressure of propylene used in the synthesis of alkylene-modified polyvinyl alcohol 3-11 was changed. The degree of alkylene modification (copolymerization amount of propylene) was 12 mol %. The polymerization degree was 1300, and the saponification degree was 97.5 mol %.

### 2. Manufacture of High Refractive Index Layer Coating Liquid

### Manufacture Example 3-1

### Manufacture of High Refractive Index Layer Coating Liquid 3-1

To 0.5 parts by weight of a 15.0% by weight titanium oxide sol (SRD-W, volume average particle diameter: 5 nm, rutile type titanium dioxide particles, manufactured by Sakai Chemical Industry Co., Ltd.), 2 parts by weight of pure water was added, and then heated to 90° C. Subsequently, 0.5 parts by weight of a silicic acid aqueous solution (obtained by diluting sodium silicate No. 4 (manufactured by Nippon Chemical Industrial Co., Ltd.) with pure water such that a concentration of SiO₂ was 0.5% by weight) was gradually added. Subsequently, the resulting solution was heated in an autoclave at 175° C. for 18 hours. After being cooled, the resulting solution was concentrated using an ultrafiltration membrane. A titanium dioxide sol having a solid concentration of 6% by weight, to the surface of which SiO₂ adhered (hereinafter, silica adhesion titanium dioxide sol) (volume average particle diameter: 9 nm), was thereby obtained. To 140 parts by weight of the resulting silica adhesion titanium dioxide sol (20% by weight), 48 parts by weight of a citric acid aqueous solution (1.92% by weight) was added, and 85 parts by weight of alkylene-modified polyvinyl alcohol 3-1 (8% by weight) and 28 parts by weight of alkylene-modified polyvinyl alcohol 3-5 (8% by weight) were further added and stirred. Finally, 0.4 parts by weight of a 5% by weight aqueous solution of a surfactant (Softazoline LSB-R, manufactured by Kawaken Fine Chemicals Co., Ltd.) was added to manufacture high refractive index layer coating liquid 3-1.

### Manufacture Example 3-2

### Manufacture of High Refractive Index Layer Coating Liquid 3-2

High refractive index layer coating liquid 3-2 was manufactured in a similar manner to high refractive index layer coating liquid 3-1 except that alkylene-modified polyvinyl alcohol 3-5 used in the manufacture of high refractive index layer coating liquid 3-1 was changed to alkylene-modified polyvinyl alcohol 3-6.

### Manufacture Example 3-3

### Manufacture of High Refractive Index Layer Coating Liquid 3-3

High refractive index layer coating liquid 3-3 was manufactured in a similar manner to high refractive index layer coating liquid 3-1 except that alkylene-modified polyvinyl alcohol 3-5 used in the manufacture of high refractive index layer coating liquid 3-1 was changed to alkylene-modified polyvinyl alcohol 3-7.

### Manufacture Example 3-4

### Manufacture of High Refractive Index Layer Coating Liquid 3-4

High refractive index layer coating liquid 3-4 was manufactured in a similar manner to high refractive index layer coating liquid 3-1 except that alkylene-modified polyvinyl alcohol 3-5 used in the manufacture of high refractive index layer coating liquid 3-1 was changed to alkylene-modified polyvinyl alcohol 3-8.

### Manufacture Example 3-5

### Manufacture of High Refractive Index Layer Coating Liquid 3-5

High refractive index layer coating liquid 3-5 was manufactured in a similar manner to high refractive index layer coating liquid 3-1 except that alkylene-modified polyvinyl alcohol 3-5 used in the manufacture of high refractive index layer coating liquid 3-1 was changed to alkylene-modified polyvinyl alcohol 3-9.

### Manufacture Example 3-6

### Manufacture of High Refractive Index Layer Coating Liquid 3-6

High refractive index layer coating liquid 3-6 was manufactured in a similar manner to high refractive index layer coating liquid 3-1 except that alkylene-modified polyvinyl alcohol 3-5 used in the manufacture of high refractive index layer coating liquid 3-1 was changed to alkylene-modified polyvinyl alcohol 3-10.

### Manufacture Example 3-7

### Manufacture of High Refractive Index Layer Coating Liquid 3-7

High refractive index layer coating liquid 3-7 was manufactured in a similar manner to high refractive index layer coating liquid 3-1 except that alkylene-modified polyvinyl alcohol 3-5 used in the manufacture of high refractive index layer coating liquid 3-1 was changed to alkylene-modified polyvinyl alcohol 3-11.

### Manufacture Example 3-8

### Manufacture of High Refractive Index Layer Coating Liquid 3-8

High refractive index layer coating liquid 3-8 was manufactured in a similar manner to high refractive index layer coating liquid 3-1 except that alkylene-modified polyvinyl alcohol 3-1 used in the manufacture of high refractive index layer coating liquid 3-1 was changed to alkylene-modified polyvinyl alcohol 3-2 and alkylene-modified polyvinyl alcohol 3-5 was changed to alkylene-modified polyvinyl alcohol 3-12.

### Manufacture Example 3-9

### Manufacture of High Refractive Index Layer Coating Liquid 3-9

High refractive index layer coating liquid 3-9 was manufactured in a similar manner to high refractive index layer coating liquid 3-7 except that alkylene-modified polyvinyl alcohol 3-1 used in the manufacture of high refractive index layer coating liquid 3-7 was changed to alkylene-modified polyvinyl alcohol 3-3.

### Manufacture Example 3-10

### Manufacture of High Refractive Index Layer Coating Liquid 3-10

High refractive index layer coating liquid 3-10 was manufactured in a similar manner to high refractive index layer coating liquid 3-1 except that alkylene-modified polyvinyl alcohol 3-1 used in the manufacture of high refractive index layer coating liquid 3-1 was changed to alkylene-modified polyvinyl alcohol 3-4 and alkylene-modified polyvinyl alcohol 3-5 was changed to alkylene-modified polyvinyl alcohol 3-13.

### Manufacture Example 3-11

### Manufacture of High Refractive Index Layer Coating Liquid 3-11

High refractive index layer coating liquid 3-11 was manufactured in a similar manner to high refractive index layer coating liquid 3-1 except that 85 parts by weight of alkylene-modified polyvinyl alcohol 3-1 (8% by weight) and 28 parts by weight of alkylene-modified polyvinyl alcohol 3-5 (8% by weight) used in the manufacture of high refractive index layer coating liquid 3-1 were changed to 113 parts by weight of polyvinyl alcohol (POVAL PVA-235 manufactured by Kuraray Co., Ltd., polymerization degree: 3500, saponification degree: 87 mol %) (8% by weight).

### Manufacture Example 3-12

### Manufacture of High Refractive Index Layer Coating Liquid 3-12

High refractive index layer coating liquid 3-12 was manufactured in a similar manner to high refractive index layer coating liquid 3-1 except that alkylene-modified polyvinyl alcohol 3-1 used in the manufacture of high refractive index layer coating liquid 3-1 was changed to a polyvinyl alcohol (POVAL PVA-117 manufactured by Kuraray Co. Ltd., polymerization degree: 1700, saponification degree: 99 mol %).

### Manufacture Example 3-13

### Manufacture of High Refractive Index Layer Coating Liquid 3-13

High refractive index layer coating liquid 3-13 was manufactured in a similar manner to high refractive index layer coating liquid 3-3 except that alkylene-modified polyvinyl alcohol 3-1 used in the manufacture of high refractive index layer coating liquid 3-3 was changed to a polyvinyl alcohol (POVAL PVA-117 manufactured by Kuraray Co. Ltd., polymerization degree: 1700, saponification degree: 99 mol %).

### Manufacture Example 3-14

### Manufacture of High Refractive Index Layer Coating Liquid 3-14

High refractive index layer coating liquid 3-14 was manufactured in a similar manner to high refractive index layer coating liquid 3-4 except that alkylene-modified polyvinyl alcohol 3-1 used in the manufacture of high refractive index layer coating liquid 3-4 was changed to a polyvinyl alcohol (POVAL PVA-117 manufactured by Kuraray Co. Ltd., polymerization degree: 1700, saponification degree: 99 mol %).

### Manufacture Example 3-15

### Manufacture of High Refractive Index Layer Coating Liquid 3-15

High refractive index layer coating liquid 3-15 was manufactured in a similar manner to high refractive index layer coating liquid 3-6 except that alkylene-modified polyvinyl alcohol 3-1 used in the manufacture of high refractive index layer coating liquid 3-6 was changed to a polyvinyl alcohol (POVAL PVA-117 manufactured by Kuraray Co. Ltd., polymerization degree: 1700, saponification degree: 99 mol %).

### Manufacture Example 3-16

### Manufacture of High Refractive Index Layer Coating Liquid 3-16

High refractive index layer coating liquid 3-16 was manufactured in a similar manner to high refractive index layer coating liquid 3-11 except that the polyvinyl alcohol (POVAL PVA-235 manufactured by Kuraray Co., Ltd., polymerization degree: 3500, saponification degree: 87 mol %) (8% by weight) used in the manufacture of high refractive index layer coating liquid 3-11 was changed to a polyvinyl alcohol (POVAL PVA-117 manufactured by Kuraray Co. Ltd., polymerization degree: 1700, saponification degree: 99 mol %).

### 3. Manufacture of Low Refractive Index Layer Coating Liquid

### Manufacture Example 3-17

### Manufacture of Low Refractive Index Layer Coating Liquid 3-1

31 parts by weight of a 10% by weight aqueous solution of an acidic colloidal silica (Snowtex OXS, primary particle diameter: 5.4 nm, manufactured by Nissan Chemical Industries, Ltd.) was heated to 40° C., and 3 parts by weight of a 3% boric acid aqueous solution was added. 39 parts by weight of polyvinyl alcohol (PVA-235 manufactured by Kuraray Co. Ltd., polymerization degree: 3500, saponification degree: 87 mol %,) (6% by weight) as a water-soluble polymer and 1 part by weight of a 5% by weight aqueous solution of a surfactant (Softazoline LSB-R, manufactured by Kawaken Fine Chemicals Co., Ltd.) were added at 40° C. in this order to manufacture low refractive index layer coating liquid 3-1.

### Manufacture Example 3-18

### Manufacture of Low Refractive Index Layer Coating Liquid 3-2

Low refractive index layer coating liquid 3-2 was manufactured in a similar manner to low refractive index layer coating liquid 3-1 except that 39 parts by weight of polyvinyl alcohol used in the manufacture of low refractive index layer coating liquid 3-1 was changed to 29 parts by weight of alkylene-modified polyvinyl alcohol 3-1 (6% by weight) and 10 parts by weight of alkylene-modified polyvinyl alcohol 3-7 (6% by weight).

### Examples 3-1 to 3-11 and Comparative Examples 3-1 to 3-5

According to the combinations shown in Table 3-1 below, each of the high refractive index layer coating liquid and the low refractive index layer coating liquid was heated to 40° C. Thereafter, simultaneous multilayer coating of the high refractive index layer coating liquid and the low refractive index layer coating liquid was performed on a polyethylene terephthalate film (A4300 manufactured by Toyobo Co., Ltd., double-sided easily adhesive layer) heated to 40° C. and having a width of 160 mm and a thickness of 50 μm using a slide hopper coating device capable of performing nine-layer multilayer coating. In the simultaneous multilayer coating, coating of nine layers in total was performed such that the bottom layer and the top layer were low refractive index layers, and the other layers were alternate low refractive index layers (each layer has a thickness of 150 nm when being dried) and high refractive index layers (each layer has a thickness of 130 nm when being dried). Immediately after coating, thickening was performed by blowing cool air at 10° C. After completion of thickening, drying was performed by blowing warm air at 60° C. to manufacture optical reflective films of Examples 3-1 to 3-11, each including nine layers in total, and comparative optical reflective films of Comparative Examples 3-1 to 3-5, each including nine layers in total.

Evaluation

(Adhesion)

Using a cutter knife, six cuts reaching the polyethylene terephthalate film were made on the optical reflective film at 2 mm intervals, and 25 grids were made. Sellotape (registered trademark) was press-bonded strongly to these grids with a ball of a finger. An end of the tape was peeled off at an angle of 60° without stopping. Adhesion was evaluated by counting the number of the remaining grids.

5: 25 or 24 grids remained.

4: 23 to 21 grids remained.

3: 20 to 18 grids remained.

2: 17 to 15 grids remained.

1: Only 14 or less grids remained.

In the third aspect of the present invention, an evaluation of 3 or more is necessary, and an evaluation of 4 or more is preferable.

(Adhesion after being Allowed to Stand in High Humidity Conditions)

An optical reflective film was cut out with 10 cm×5 cm. The cut out optical reflective film was allowed to stand in an atmosphere of 60° C. and 90% RH for one week. Thereafter, evaluation was performed in a similar manner to the above adhesion test. In the third aspect of the present invention, an evaluation of 3 or more is necessary, and an evaluation of 4 or more is preferable.

(Color Difference after being Allowed to Stand in High Humidity Conditions)

Using a spectrophotometer, L* value, a* value, and b* value of reflected color of the optical reflective film were measured. Thereafter, the cut out optical reflective film was allowed to stand in an atmosphere of 60° C. and 90% RH for one week. Thereafter, L* value, a* value, and b* value were measured again using the spectrophotometer. A difference in the measured L* value was referred to as ΔL*, a difference in the a* value was referred to as Δa*, and a difference in the b* value was referred to as Δb*. ΔE was calculated by the following formula.

ΔE=\sqrt{(ΔL*)²+(Δa*)²+(Δb*)²} [Numerical formula 5]

5: ΔE is 0 to less than 0.8.

4: ΔE is 0.8 or more and less than 1.6.

3: ΔE is 1.6 or more and less than 3.0.

2: ΔE is 3.0 or more and less than 6.0.

1: ΔE is 6.0 or more.

In the third aspect of the present invention, an evaluation of 3 or more is necessary, and an evaluation of 4 or more is preferable.

TABLE 3-1

| | | | Degree of | | | |
|---|---|---|---|---|---|---|
| | | Alkylene-modified | alkylene | | | Saponification |
| | High refractive index layer | polyvinyl alcohol or | modification | Kind of alkylene unit, | Polymerization | degree |
| | coating liquid | polyviny alcohol | (mol %) | ethylene, propylene | degree | (mol %) |
| Example 3-1 | High refractive index layer | amPVA 3-1 | 5 | Ethylene | 1700 | 98 |
| | coating liquid 3-1 | amPVA 3-5 | 3 | Ethylene | 1700 | 98 |
| Example 3-2 | High refractive index layer | amPVA 3-1 | 5 | Ethylene | 1700 | 98 |
| | coating liquid 3-2 | amPVA 3-6 | 5 | Ethylene | 1300 | 98 |
| Example 3-3 | High refractive index layer | amPVA 3-1 | 5 | Ethylene | 1700 | 98 |
| | coating liquid 3-3 | amPVA 3-7 | 3 | Ethylene | 1300 | 97.5 |
| Example 3-4 | High refractive index layer | amPVA 3-1 | 5 | Ethylene | 1700 | 98 |
| | coating liquid 3-4 | amPVA 3-8 | 3 | Ethylene | 1700 | 93 |
| Example 3-5 | High refractive index layer | amPVA 3-1 | 5 | Ethylene | 1700 | 98 |
| | coating liquid 3-5 | amPVA 3-9 | 5 | Ethylene | 1300 | 93 |
| Example 3-6 | High refractive index layer | amPVA 3-1 | 5 | Ethylene | 1700 | 98 |
| | coating liquid 3-6 | amPVA 3-10 | 3 | Ethylene | 1300 | 93 |
| Example 3-7 | High refractive index layer | amPVA 3-1 | 5 | Ethylene | 1700 | 98 |
| | coating liquid 3-7 | amPVA 3-11 | 3 | Propylene | 1300 | 97.5 |
| Example 3-8 | High refractive index layer | amPVA 3-2 | 12 | Ethylene | 1700 | 98 |
| | coating liquid 3-8 | amPVA 3-12 | 12 | Ethylene | 1300 | 97.5 |
| Example 3-9 | High refractive index layer | amPVA 3-3 | 5 | Propylene | 1700 | 98 |
| | coating liquid 3-9 | amPVA 3-11 | 3 | Propylene | 1300 | 97.5 |
| Example 3-10 | High refractive index layer | amPVA 3-4 | 12 | Propylene | 1700 | 98 |
| | coating liquid 3-10 | amPVA 3-13 | 12 | Propylene | 1300 | 97.5 |
| Example 3-11 | High refractive index layer | PVA-235 | 0 | — | 3500 | 87 |
| | coating liquid 3-11 | | | | | |
| Comparative | High refractive index layer | PVA-117 | 0 | — | 1700 | 99 |
| Example 3-1 | coating liquid 3-12 | amPVA 3-5 | 3 | Ethylene | 1700 | 98 |
| Comparative | High refractive index layer | PVA-117 | 0 | — | 1700 | 99 |
| Example 3-2 | coating liquid 3-13 | amPVA 3-7 | 3 | Ethylene | 1300 | 97.5 |
| Comparative | High refractive index layer | PVA-117 | 0 | — | 1700 | 99 |
| Example 3-3 | coating liquid 3-14 | amPVA 3-8 | 3 | Ethylene | 1700 | 93 |
| Comparative | High refractive index layer | PVA-117 | 0 | — | 1700 | 99 |
| Example 3-4 | coating liquid 3-15 | amPVA 3-10 | 3 | Ethylene | 1300 | 93 |
| Comparative | High refractive index layer | PVA-117 | 0 | — | 1700 | 99 |
| Example 3-5 | coating liquid 3-16 | | | | | |
| | | | Degree of | | | |
| | | Alkylene-modified | alkylene | | | Saponification |
| | Low refractive index layer | polyvinyl alcohol or | modification | Kind of alkylene unit, | Polymerization | degree |
| | coating liquid | polyvinyl alcohol | (mol %) | ethylene, propylene | degree | (mol %) |
| Example 3-1 | Low refractive index layer | PVA-235 | 0 | — | 3500 | 87 |
| | coating liquid 3-1 | | | | | |
| Example 3-2 | Low refractive index layer | PVA-235 | 0 | — | 3500 | 87 |
| | coating liquid 3-1 | | | | | |
| Example 3-3 | Low refractive index layer | PVA-235 | 0 | — | 3500 | 87 |
| | coating liquid 3-1 | | | | | |
| Example 3-4 | Low refractive index layer | PVA-235 | 0 | — | 3500 | 87 |
| | coating liquid 3-1 | | | | | |
| Example 3-5 | Low refractive index layer | PVA-235 | 0 | — | 3500 | 87 |
| | coating liquid 3-1 | | | | | |
| Example 3-6 | Low refractive index layer | PVA-235 | 0 | — | 3500 | 87 |
| | coating liquid 3-1 | | | | | |
| Example 3-7 | Low refractive index layer | PVA-235 | 0 | — | 3500 | 87 |
| | coating liquid 3-1 | | | | | |
| Example 3-8 | Low refractive index layer | PVA-235 | 0 | — | 3500 | 87 |
| | coating liquid 3-1 | | | | | |
| Example 3-9 | Low refractive index layer | PVA-235 | 0 | — | 3500 | 87 |
| | coating liquid 3-1 | | | | | |
| Example 3-10 | Low refractive index layer | PVA-235 | 0 | — | 3500 | 87 |
| | coating liquid 3-1 | | | | | |
| Example 3-11 | Low refractive index layer | amPVA 3-1 | 5 | Ethylene | 1700 | 98 |
| | coating liquid 3-2 | amPVA 3-7 | 3 | Ethylene | 1300 | 97.5 |
| Comparative | Low refractive index layer | PVA-235 | 0 | — | 3500 | 87 |
| Example 3-1 | coating liquid 3-1 | | | | | |
| Comparative | Low refractive index layer | PVA-235 | 0 | — | 3500 | 87 |
| Example 3-2 | coating liquid 3-1 | | | | | |
| Comparative | Low refractive index layer | PVA-235 | 0 | — | 3500 | 87 |
| Example 3-3 | coating liquid 3-1 | | | | | |
| Comparative | Low refractive index layer | PVA-235 | 0 | — | 3500 | 87 |
| Example 3-4 | coating liquid 3-1 | | | | | |
| Comparative | Low refractive index layer | PVA-235 | 0 | — | 3500 | 87 |
| Example 3-5 | coating liquid 3-1 | | | | | |

| | Evaluation | | |
|---|---|---|---|
| | | Adhesion after being allowed | Color difference ΔE after |
| | | to stand in high humidity | being allowed to stand in high |
| | Adhesion | conditions | humidity conditions |
| Example 3-1 | 5 | 5 | 5 |
| Example 3-2 | 5 | 5 | 5 |
| Example 3-3 | 5 | 5 | 5 |
| Example 3-4 | 5 | 5 | 4 |
| Example 3-5 | 5 | 4 | 4 |
| Example 3-6 | 5 | 4 | 4 |
| Example 3-7 | 4 | 4 | 5 |
| Example 3-8 | 4 | 4 | 4 |
| Example 3-9 | 4 | 5 | 5 |
| Example 3-10 | 3 | 4 | 5 |
| Example 3-11 | 4 | 4 | 3 |
| Comparative | 4 | 2 | 2 |
| Example 3-1 | | | |
| Comparative | 4 | 3 | 2 |
| Example 3-2 | | | |
| Comparative | 4 | 1 | 1 |
| Example 3-3 | | | |
| Comparative | 4 | 2 | 1 |
| Example 3-4 | | | |
| Comparative | 3 | 1 | 1 |
| Example 3-5 | | | |

In Table 3-1 above, “amPVA” is an abbreviation of “alkylene-modified polyvinyl alcohol.” Table 3-1 makes it clear that optical reflective films 3-1 to 3-11 (Examples 3-1 to 3-11) of the third aspects of the present invention are less deteriorated in adhesion than comparative optical reflective films 3-1 to 3-5 (Comparative Examples 3-1 to 3-5) even after exposure to high humidity conditions. In addition, Table 3-1 indicates that fluctuation in color difference after exposure to high humidity conditions is also less.

As described above, an optical reflective film having excellent moisture resistance was obtained by satisfying the conditions of the third aspects of the present invention.

The present application is based on Japanese Patent Application No. 2013-86753 filed on Apr. 17, 2013, Japanese Patent Application No. 2013-86951 filed on Apr. 17, 2013, and Japanese Patent Application No. 2013-189858 filed on Sep. 12, 2013. Disclosed contents thereof are incorporated into the present disclosure by reference as a whole.

1. An optical reflective film comprising at least one unit in which a low refractive index layer and a high refractive index layer are laminated on a substrate, wherein
at least one of the low refractive index layer and the high refractive index layer includes an ethylene-modified polyvinyl alcohol having a degree of ethylene modification of 1 to 10 mol % and inorganic oxide particles.

2. The optical reflective film according to claim 1, wherein
the ethylene-modified polyvinyl alcohol has a polymerization degree of 1000 or more.

3. The optical reflective film according to claim 1, wherein
the high refractive index layer includes an ethylene-modified polyvinyl alcohol and titanium oxide particles as the inorganic oxide particles.

4. The optical reflective film according to claim 1, wherein
each of the high refractive index layer and the low refractive index layer includes a modified polyvinyl alcohol and/or a polyvinyl alcohol, and
a difference in a saponification degree between the high refractive index layer and the low refractive index layer is 3 mol % or more.

5. The optical reflective film according to claim 1, wherein
the ethylene-modified polyvinyl alcohol has a saponification degree of 85 mol % or more.

6. An optical reflective film comprising at least one unit in which a low refractive index layer and a high refractive index layer are laminated on a substrate, wherein
the high refractive index layer includes an ethylene-modified polyvinyl alcohol and titanium oxide particle as inorganic oxide particles,
the ethylene-modified polyvinyl alcohol has a saponification degree of 95.0 to 99.9 mol %, and
a content of the inorganic oxide particles in the high refractive index layer is 40 to 60% by volume.

7. The optical reflective film according to claim 6, wherein
the low refractive index layer includes a polyvinyl alcohol, and
the polyvinyl alcohol has a saponification degree of 90 mol % or less.

8. The optical reflective film according to claim 6, wherein
the ethylene-modified polyvinyl alcohol has a degree of ethylene modification of 1 to 10 mol %.

9. An optical reflective film comprising at least one unit in which a low refractive index layer and a high refractive index layer are laminated on a substrate, wherein
at least one of the low refractive index layer and the high refractive index layer includes two or more kinds of alkylene-modified polyvinyl alcohols and inorganic oxide particles.

10. The optical reflective film according to claim 9, wherein
the alkylene-modified polyvinyl alcohol has a degree of alkylene modification of 1 to 10 mol %.

11. The optical reflective film according to claim 9, wherein
at least one kind of the alkylene-modified polyvinyl alcohols is an ethylene-modified polyvinyl alcohol.

12. A method for manufacturing the optical reflective film according to claim 1, comprising laminating the high refractive index layer and the low refractive index layer by a simultaneous multilayer coating method.

13. An optical reflector, wherein
the optical reflective film according to claim 1 is provided on at least one surface of a base.

14. A method for manufacturing the optical reflective film according to claim 6, comprising laminating the high refractive index layer and the low refractive index layer by a simultaneous multilayer coating method.

15. An optical reflector, wherein
the optical reflective film according to claim 6 is provided on at least one surface of a base.

16. A method for manufacturing the optical reflective film according to claim 9, comprising laminating the high refractive index layer and the low refractive index layer by a simultaneous multilayer coating method.

17. An optical reflector, wherein
the optical reflective film according to claim 9 is provided on at least one surface of a base.

18. The optical reflective film according to claim 2, wherein
the high refractive index layer includes an ethylene-modified polyvinyl alcohol and titanium oxide particles as the inorganic oxide particles.

19. The optical reflective film according to claim 2, wherein
each of the high refractive index layer and the low refractive index layer includes a modified polyvinyl alcohol and/or a polyvinyl alcohol, and
a difference in a saponification degree between the high refractive index layer and the low refractive index layer is 3 mol % or more.

20. The optical reflective film according to claim 2, wherein
the ethylene-modified polyvinyl alcohol has a saponification degree of 85 mol % or more.
